(19) United States
(12) Patent Application Publication
(10) Pub. No.: US 2025/0299441 A1
(43) Pub. Date: Sep. 25, 2025

(54) Systems and methods for updating point clouds in LIDAR systems

(71) Applicant: Innoviz Technologies Ltd., Rosh HaAyin (IL)

(72) Inventors: Omer David Keilaf, Kfar Saba (IL); Nir Goren, Herut (IL); Avishay Moscovici, Tel Aviv (IL)

(21) Appl. No.: 19/105,055

(22) PCT Filed: Aug. 21, 2023
(86) PCT No.: PCT/IB2023/000501

§ 371 Date: Feb. 20, 2025

Related U.S. Application Data
(60) Provisional application No. 63/373,056, filed on Aug. 21, 2022.

(51) Int. Cl. G06T 17/00; G01S 17/89; G06T 19/20

(52) U.S. Cl. CPC G06T 17/00; G01S 17/89; G06T 19/20; G06T 2219/2021

(57) ABSTRACT

A LIDAR system includes at least one laser light source, at least one light-sensitive detector including a plurality of pixels, and at least one processor configured to cause the at least one laser light source to project laser light toward a field of view of the LIDAR system, generate a point cloud including distance information relative to objects in the field of view of the LIDAR system based on output signals generated by the at least one light-sensitive detector in response to received laser light return signals reflected from the objects in the field of view, and generate an image representative of at least a portion of the field of view of the LIDAR system based on output signals generated by the at least one light-sensitive detector in response to non-laser light incident upon the at least one-light sensitive detector. The processor is configured to compare the point cloud to the image to detect whether inconsistencies exist between representations in the point cloud and corresponding representations in the image of objects from the field of view, and, in response to detection of one or more inconsistencies between representations in the point cloud and corresponding representations in the image of objects from the field of view, adjust one or more aspects of the generated point cloud to provide an updated point cloud.

### I. CROSS-REFERENCE TO RELATED APPLICATION

This application claims the benefit of priority of U.S. Provisional Application No. 63/373,056, filed Aug. 21, 2022, the disclosure of which is expressly incorporated herein by reference in its entirety.

### TECHNICAL FIELD

The present disclosure relates generally to technology for scanning a surrounding environment and, for example, to systems and methods that use LIDAR technology to detect objects in the surrounding environment.

### III. BACKGROUND INFORMATION

With the advent of driver assist systems and autonomous vehicles, automobiles need to be equipped with systems capable of reliably sensing and interpreting their surroundings, including identifying obstacles, hazards, objects, and other physical parameters that might impact navigation of the vehicle. To this end, a number of differing technologies have been suggested including radar, LIDAR, camera-based systems, operating alone or in a redundant manner.

One consideration with driver assistance systems and autonomous vehicles is an ability of the system to determine surroundings across different conditions including, rain, fog, darkness, bright light, and snow. A light detection and ranging system, (LIDAR a/k/a LADAR) is an example of technology that can work well in differing conditions, by measuring distances to objects by illuminating objects with light and measuring the reflected pulses with a sensor. A laser is one example of a light source that can be used in a LIDAR system. An electro-optical system such as a LIDAR system may include a light deflector for projecting light emitted by a light source into the environment of the electro-optical system. The light deflector may be controlled to pivot around at least one axis for projecting the light into a desired location in the field of view of the electro-optical system. It may be desirable to design improved systems and methods for determining the position and/or orientation of the light deflector for controlling and/or monitoring the movement of the light deflector with precision.

The systems and methods of the present disclosure are directed towards improving performance of monitoring the position and/or orientation of a light deflector used in electro-optical systems.

### SUMMARY

One aspect of the present disclosure is directed to a LIDAR system. The LIDAR system may include at least one laser light source; at least one light-sensitive detector including a plurality of pixels; and at least one processor configured to perform operations. The processor may be configured to cause the at least one laser light source to project laser light toward a field of view of the LIDAR system; generate a point cloud including distance information relative to objects in the field of view of the LIDAR system based on output signals generated by the at least one light-sensitive detector in response to received laser light return signals reflected from the objects in the field of view; and generate an image representative of at least a portion of the field of view of the LIDAR system based on output signals generated by the at least one light-sensitive detector in response to non-laser light incident upon the at least one-light sensitive detector. The processor may further be configured to compare the point cloud to the image to detect whether inconsistencies exist between representations in the point cloud and corresponding representations in the image of objects from the field of view; and in response to detection of one or more inconsistencies between representations in the point cloud and corresponding representations in the image of objects from the field of view, adjust one or more aspects of the generated point cloud to provide an updated point cloud.

Another aspect of the present disclosure is directed to a method for detecting objects using a LIDAR system. The method may perform operations including causing at least one laser light source to project laser light toward a field of view of the LIDAR system; generating a point cloud including distance information relative to objects in the field of view of the LIDAR system based on output signals generated by at least one light-sensitive detector in response to received laser light return signals reflected from the objects in the field of view; generating an image representative of at least a portion of the field of view of the LIDAR system based on output signals generated by the at least one light-sensitive detector in response to non-laser light incident upon the at least one-light sensitive detector; comparing the point cloud to the image to determine whether inconsistencies exist between representations in the point cloud and corresponding representations in the image of objects from the field of view; and based on the detection of one or more inconsistencies between representations in the point cloud and corresponding representations in the image of objects from the field of view, adjusting one or more aspects of the generated point cloud to provide an updated point cloud.

Yet another aspect of the present disclosure is directed to a non-transitory computer-readable storage medium including stored instructions that, when executed by at least one processor, cause the at least one processor to perform a method for detecting objects using a LIDAR system. The method may include causing at least one laser light source to project laser light toward a field of view of the LIDAR system; generating a point cloud including distance information relative to objects in the field of view of the LIDAR system based on output signals generated by at least one light-sensitive detector in response to received laser light return signals reflected from the objects in the field of view; generating an image representative of at least a portion of the field of view of the LIDAR system based on output signals generated by the at least one light-sensitive detector in response to non-laser light incident upon the at least one-light sensitive detector; comparing the point cloud to the image to determine whether inconsistencies exist between representations in the point cloud and corresponding representations in the image of objects from the field of view; and based on the detection of one or more inconsistencies between representations in the point cloud and corresponding representations in the image of objects from the field of view, adjusting one or more aspects of the generated point cloud to provide an updated point cloud.

Yet another aspect is directed to a method for detecting objects. The method may include receiving a point cloud including distance information relative to objects in a field of view of based on output signals generated by at least one light-sensitive detector in response to received laser light return signals reflected from the objects in the field of view; receiving an image representative of at least a portion of the field of view based on output signals generated by the at least one light-sensitive detector in response to non-laser light incident upon the at least one light sensitive detector; comparing the point cloud to the image to detect whether inconsistencies exist between representations in the point cloud and corresponding representations in the image of objects from the field of view; and in response to detection of one or more inconsistencies between representations in the point cloud and corresponding representations in the image of objects from the field of view, adjust one or more aspects of the generated point cloud to provide an updated point cloud.

Yet another aspect is directed to a non-transitory computer-readable storage medium including stored instructions that, when executed by at least one processor, cause the at least one processor to perform a method. The method may include receiving a point cloud including distance information relative to objects in a field of view of based on output signals generated by at least one light-sensitive detector in response to received laser light return signals reflected from the objects in the field of view; receiving an image representative of at least a portion of the field of view based on output signals generated by the at least one light-sensitive detector in response to non-laser light incident upon the at least one light sensitive detector; comparing the point cloud to the image to detect whether inconsistencies exist between representations in the point cloud and corresponding representations in the image of objects from the field of view; and in response to detection of one or more inconsistencies between representations in the point cloud and corresponding representations in the image of objects from the field of view, adjust one or more aspects of the generated point cloud to provide an updated point cloud.

Yet another aspect is directed to a method for detecting objects. The method may include receiving a point cloud including distance information relative to objects in the field of view based on output signals generated by at least one light-sensitive detector in response to received laser light return signals reflected from the objects in the field of view; determining a first object in the point cloud by identifying a group of points associated with the first object in the field of view; receiving an image representative of at least a portion of the field of view based on output signals generated by the at least one light-sensitive detector in response to non-laser light incident upon the at least one-light sensitive detector; comparing the point cloud to the image to determine whether inconsistencies exist between representations in the point cloud and corresponding representations in the image of the first object from the field of view; and based on the detection of one or more inconsistencies between representations in the group of points associated with the first object and corresponding representations in the image of the first object from the field of view, adjusting one or more aspects of the first object to provide an updated object map.

Yet another aspect is directed to a non-transitory computer-readable storage medium including stored instructions that, when executed by at least one processor, cause the at least one processor to perform a method. The method may include receiving a point cloud including distance information relative to objects in the field of view based on output signals generated by at least one light-sensitive detector in response to received laser light return signals reflected from the objects in the field of view; determining a first object in the point cloud by identifying a group of points associated with the first object in the field of view; receiving an image representative of at least a portion of the field of view based on output signals generated by the at least one light-sensitive detector in response to non-laser light incident upon the at least one-light sensitive detector; comparing the point cloud to the image to determine whether inconsistencies exist between representations in the point cloud and corresponding representations in the image of the first object from the field of view; and based on the detection of one or more inconsistencies between representations in the group of points associated with the first object and corresponding representations in the image of the first object from the field of view, adjusting one or more aspects of the first object to provide an updated object map.

The foregoing general description and the following detailed description are exemplary and explanatory only and are not restrictive of the claims.

### BRIEF DESCRIPTION OF THE DRAWINGS

The accompanying drawings, which are incorporated in and constitute a part of this disclosure, illustrate various disclosed embodiments. In the drawings:

FIG. 1A is a diagram illustrating an exemplary LIDAR system consistent with disclosed embodiments.

FIG. 1B is an image showing an exemplary output of single scanning cycle of a LIDAR system mounted on a vehicle consistent with disclosed embodiments.

FIG. 1C is another image showing a representation of a point cloud model determined from output of a LIDAR system consistent with disclosed embodiments.

FIGS. 2A-2G are diagrams illustrating different configurations of projecting units in accordance with some embodiments of the present disclosure.

FIGS. 3A-3D are diagrams illustrating different configurations of scanning units in accordance with some embodiments of the present disclosure.

FIGS. 4A-4E are diagrams illustrating different configurations of sensing units in accordance with some embodiments of the present disclosure.

FIG. 5A includes four example diagrams illustrating emission patterns in a single frame-time for a single portion of the field of view.

FIG. 5B includes three example diagrams illustrating emission scheme in a single frame-time for the whole field of view.

FIG. 5C is a diagram illustrating the actual light emission projected towards and reflections received during a single frame-time for the whole field of view.

FIGS. 6A-6C are diagrams illustrating a first example implementation consistent with some embodiments of the present disclosure.

FIG. 6D is a diagram illustrating a second example implementation consistent with some embodiments of the present disclosure.

FIG. 7 is a flow chart of an example method for resolving object detection ambiguity consistent with some embodiments of the present disclosure.

FIGS. 8A and 8B are images showing representations of a point cloud and a camera image, respectively, generated from output of a LIDAR system consistent with disclosed embodiments.

FIGS. 9A and 9B are graphs illustrating the detection of signals consistent with some embodiments of the present disclosure.

FIGS. 10A and 10B are diagrams illustrating exemplary optical paths of signals consistent with some embodiments of the present disclosure.

FIG. 11 is a block diagram representation of the various components of a LIDAR system consistent with some embodiments of the present disclosure.

FIG. 12 shows tables illustrating object classification consistent with some embodiments of the present disclosure.

FIGS. 13A and 13B illustrate a point cloud with pixel saturation and an ambient light image, respectively, consistent with some embodiments of the present disclosure.

FIGS. 14A and 14B are example images having high and low resolution, respectively, consistent with some embodiments of the present disclosure.

FIG. 15 is a flow chart of another example method for resolving object detection ambiguity consistent with some embodiments of the present disclosure.

### DETAILED DESCRIPTION

The following detailed description refers to the accompanying drawings. Wherever possible, the same reference numbers are used in the drawings and the following description to refer to the same or similar parts. While several illustrative embodiments are described herein, modifications, adaptations and other implementations are possible. For example, substitutions, additions or modifications may be made to the components illustrated in the drawings, and the illustrative methods described herein may be modified by substituting, reordering, removing, or adding steps to the disclosed methods. Accordingly, the following detailed description is not limited to the disclosed embodiments and examples. Instead, the proper scope is defined by the appended claims.

### Terms Definitions

Disclosed embodiments may involve an optical system. As used herein, the term “optical system” broadly includes any system that is used for the generation, detection and/or manipulation of light. By way of example only, an optical system may include one or more optical components for generating, detecting and/or manipulating light. For example, light sources, lenses, mirrors, prisms, beam splitters, collimators, polarizing optics, optical modulators, optical switches, optical amplifiers, optical detectors, optical sensors, fiber optics, semiconductor optic components, while each not necessarily required, may each be part of an optical system. In addition to the one or more optical components, an optical system may also include other non-optical components such as electrical components, mechanical components, chemical reaction components, and semiconductor components. The non-optical components may cooperate with optical components of the optical system. For example, the optical system may include at least one processor for analyzing detected light.

Consistent with the present disclosure, the optical system may be a LIDAR system. As used herein, the term “LIDAR system” broadly includes any system which can determine values of parameters indicative of a distance between a pair of tangible objects based on reflected light. In one embodiment, the LIDAR system may determine a distance between a pair of tangible objects based on reflections of light emitted by the LIDAR system. As used herein, the term “determine distances” broadly includes generating outputs which are indicative of distances between pairs of tangible objects. The determined distance may represent the physical dimension between a pair of tangible objects. By way of example only, the determined distance may include a line of flight distance between the LIDAR system and another tangible object in a field of view of the LIDAR system. In another embodiment, the LIDAR system may determine the relative velocity between a pair of tangible objects based on reflections of light emitted by the LIDAR system. Examples of outputs indicative of the distance between a pair of tangible objects include: a number of standard length units between the tangible objects (e.g., number of meters, number of inches, number of kilometers, number of millimeters), a number of arbitrary length units (e.g., number of LIDAR system lengths), a ratio between the distance to another length (e.g., a ratio to a length of an object detected in a field of view of the LIDAR system), an amount of time (e.g., given as standard unit, arbitrary units or ratio, for example, the time it takes light to travel between the tangible objects), one or more locations (e.g., specified using an agreed coordinate system, specified in relation to a known location), and more.

The LIDAR system may determine the distance between a pair of tangible objects based on reflected light. In one embodiment, the LIDAR system may process detection results of a sensor which creates temporal information indicative of a period of time between the emission of a light signal and the time of its detection by the sensor. The period of time is occasionally referred to as “time of flight” of the light signal. In one example, the light signal may be a short pulse, whose rise and/or fall time may be detected in reception. Using known information about the speed of light in the relevant medium (usually air), the information regarding the time of flight of the light signal can be processed to provide the distance the light signal traveled between emission and detection. In another embodiment, the LIDAR system may determine the distance based on frequency phase-shift (or multiple frequency phase-shift). Specifically, the LIDAR system may process information indicative of one or more modulation phase shifts (e.g., by solving some simultaneous equations to give a final measure) of the light signal. For example, the emitted optical signal may be modulated with one or more constant frequencies. The at least one phase shift of the modulation between the emitted signal and the detected reflection may be indicative of the distance the light traveled between emission and detection. The modulation may be applied to a continuous wave light signal, to a quasi-continuous wave light signal, or to another type of emitted light signal. It is noted that additional information may be used by the LIDAR system for determining the distance, e.g., location information (e.g., relative positions) between the projection location, the detection location of the signal (especially if distanced from one another), and more.

In some embodiments, the LIDAR system may be used for detecting a plurality of objects in an environment of the LIDAR system. The term “detecting an object in an environment of the LIDAR system” broadly includes generating information which is indicative of an object that reflected light toward a detector associated with the LIDAR system. If more than one object is detected by the LIDAR system, the generated information pertaining to different objects may be interconnected, for example a car is driving on a road, a bird is sitting on the tree, a man touches a bicycle, a van moves towards a building. The dimensions of the environment in which the LIDAR system detects objects may vary with respect to implementation. For example, the LIDAR system may be used for detecting a plurality of objects in an environment of a vehicle on which the LIDAR system is installed, up to a horizontal distance of 100 m (or 200 m, 300 m, etc.), and up to a vertical distance of 10 m (or 25 m, 50 m, etc.). In another example, the LIDAR system may be used for detecting a plurality of objects in an environment of a vehicle or within a predefined horizontal range (e.g., 25°, 50°, 100°, 180°, etc.), and up to a predefined vertical elevation (e.g., ±10°, ±20°, ±40°−20°, ±90° or 0°−90°).

As used herein, the term “detecting an object” may broadly refer to determining an existence of the object (e.g., an object may exist in a certain direction with respect to the LIDAR system and/or to another reference location, or an object may exist in a certain spatial volume). Additionally or alternatively, the term “detecting an object” may refer to determining a distance between the object and another location (e.g., a location of the LIDAR system, a location on earth, or a location of another object). Additionally or alternatively, the term “detecting an object” may refer to identifying the object (e.g., classifying a type of object such as car, plant, tree, road; recognizing a specific object (e.g., the Washington Monument); determining a license plate number; determining a composition of an object (e.g., solid, liquid, transparent, semitransparent); determining a kinematic parameter of an object (e.g., whether it is moving, its velocity, its movement direction, expansion of the object). Additionally or alternatively, the term “detecting an object” may refer to generating a point cloud map in which every point of one or more points of the point cloud map correspond to a location in the object or a location on a face thereof. In one embodiment, the data resolution associated with the point cloud map representation of the field of view may be associated with 0.1°×0.1° or 0.3°×0.3° of the field of view.

Consistent with the present disclosure, the term “object” broadly includes a finite composition of matter that may reflect light from at least a portion thereof. For example, an object may be at least partially solid (e.g., cars, trees); at least partially liquid (e.g., puddles on the road, rain); at least partly gaseous (e.g., fumes, clouds); made from a multitude of distinct particles (e.g., sand storm, fog, spray); and may be of one or more scales of magnitude, such as ˜1 millimeter (mm), ˜5 mm, ˜10 mm. ˜ 50 mm, ˜100 mm, ˜500 mm, ˜1 meter (m), ˜5 m, ˜10 m, ˜50 m, ˜100 m, and so on. Smaller or larger objects, as well as any size in between those examples, may also be detected. It is noted that for various reasons, the LIDAR system may detect only part of the object. For example, in some cases, light may be reflected from only some sides of the object (e.g., only the side opposing the LIDAR system will be detected); in other cases, light may be projected on only part of the object (e.g., laser beam projected onto a road or a building); in other cases, the object may be partly blocked by another object between the LIDAR system and the detected object; in other cases, the LIDAR's sensor may only detects light reflected from a portion of the object, e.g., because ambient light or other interferences interfere with detection of some portions of the object.

Consistent with the present disclosure, a LIDAR system may be configured to detect objects by scanning the environment of LIDAR system. The term “scanning the environment of LIDAR system” broadly includes illuminating the field of view or a portion of the field of view of the LIDAR system. In one example, scanning the environment of LIDAR system may be achieved by moving or pivoting a light deflector to deflect light in differing directions toward different parts of the field of view. In another example, scanning the environment of LIDAR system may be achieved by changing a positioning (i.e., location and/or orientation) of a sensor with respect to the field of view. In another example, scanning the environment of LIDAR system may be achieved by changing a positioning (i.e., location and/or orientation) of a light source with respect to the field of view. In yet another example, scanning the environment of LIDAR system may be achieved by changing the positions of at least one light source and of at least one sensor to move rigidly respect to the field of view (i.e., the relative distance and orientation of the at least one sensor and of the at least one light source remains).

As used herein the term “field of view of the LIDAR system” may broadly include an extent of the observable environment of LIDAR system in which objects may be detected. It is noted that the field of view (FOV) of the LIDAR system may be affected by various conditions such as but not limited to: an orientation of the LIDAR system (e.g., is the direction of an optical axis of the LIDAR system); a position of the LIDAR system with respect to the environment (e.g., distance above ground and adjacent topography and obstacles); operational parameters of the LIDAR system (e.g., emission power, computational settings. defined angles of operation), etc. The field of view of LIDAR system may be defined, for example, by a solid angle (e.g., defined using ϕ, θ angles, in which ϕ and θ are angles defined in perpendicular planes, e.g., with respect to symmetry axes of the LIDAR system and/or its FOV). In one example, the field of view may also be defined within a certain range (e.g., up to 200 m).

Similarly, the term “instantaneous field of view” may broadly include an extent of the observable environment in which objects may be detected by the LIDAR system at any given moment. For example, for a scanning LIDAR system, the instantaneous field of view is narrower than the entire FOV of the LIDAR system, and it can be moved within the FOV of the LIDAR system in order to enable detection in other parts of the FOV of the LIDAR system. The movement of the instantaneous field of view within the FOV of the LIDAR system may be achieved by moving a light deflector of the LIDAR system (or external to the LIDAR system), so as to deflect beams of light to and/or from the LIDAR system in differing directions. In one embodiment, LIDAR system may be configured to scan scene in the environment in which the LIDAR system is operating. As used herein the term “scene” may broadly include some or all of the objects within the field of view of the LIDAR system, in their relative positions and in their current states, within an operational duration of the LIDAR system. For example, the scene may include ground elements (e.g., earth, roads, grass, sidewalks, road surface marking), sky, man-made objects (e.g., vehicles, buildings, signs), vegetation, people, animals, light projecting elements (e.g., flashlights, sun, other LIDAR systems), and so on.

Disclosed embodiments may involve obtaining information for use in generating reconstructed three-dimensional models. Examples of types of reconstructed three-dimensional models which may be used include point cloud models, and Polygon Mesh (e.g., a triangle mesh). The terms “point cloud” and “point cloud model” are widely known in the art, and should be construed to include a set of data points located spatially in some coordinate system (i.e., having an identifiable location in a space described by a respective coordinate system). The term “point cloud point” refer to a point in space (which may be dimensionless, or a miniature cellular space, e.g., 1 cm³), and whose location may be described by the point cloud model using a set of coordinates (e.g., (X, Y,Z), (r,φ,θ)). By way of example only, the point cloud model may store additional information for some or all of its points (e.g., color information for points generated from camera images). Likewise, any other type of reconstructed three-dimensional model may store additional information for some or all of its objects. Similarly, the terms “polygon mesh” and “triangle mesh” are widely known in the art, and are to be construed to include, among other things, a set of vertices, edges and faces that define the shape of one or more 3D objects (such as a polyhedral object). The faces may include one or more of the following: triangles (triangle mesh), quadrilaterals, or other simple convex polygons, since this may simplify rendering. The faces may also include more general concave polygons, or polygons with holes. Polygon meshes may be represented using differing techniques, such as: Vertex-vertex meshes, Face-vertex meshes, Winged-edge meshes and Render dynamic meshes. Different portions of the polygon mesh (e.g., vertex, face, edge) are located spatially in some coordinate system (i.e., having an identifiable location in a space described by the respective coordinate system), either directly and/or relative to one another. The generation of the reconstructed three-dimensional model may be implemented using any standard, dedicated and/or novel photogrammetry technique, many of which are known in the art. It is noted that other types of models of the environment may be generated by the LIDAR system.

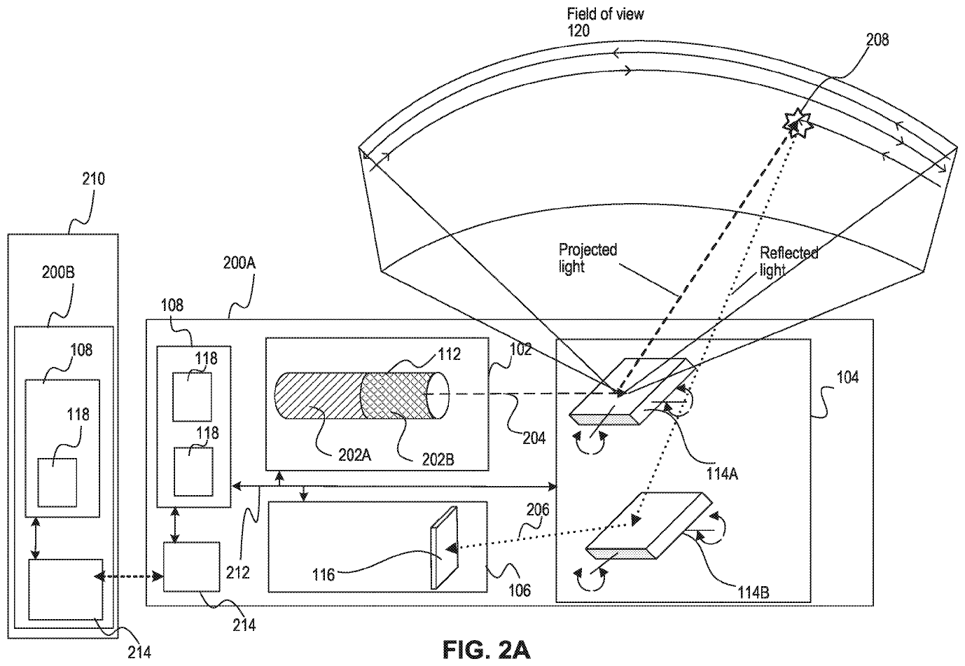

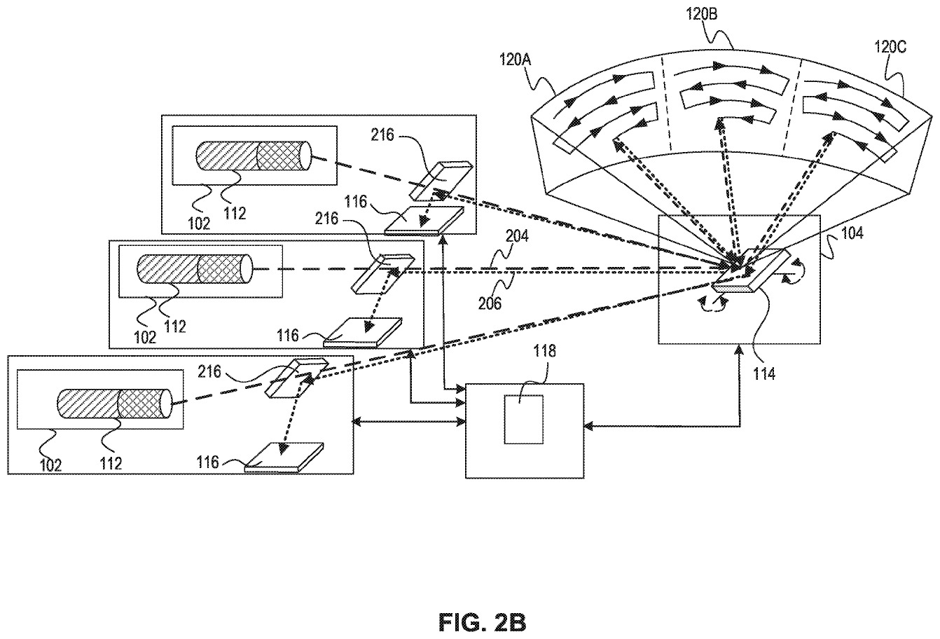

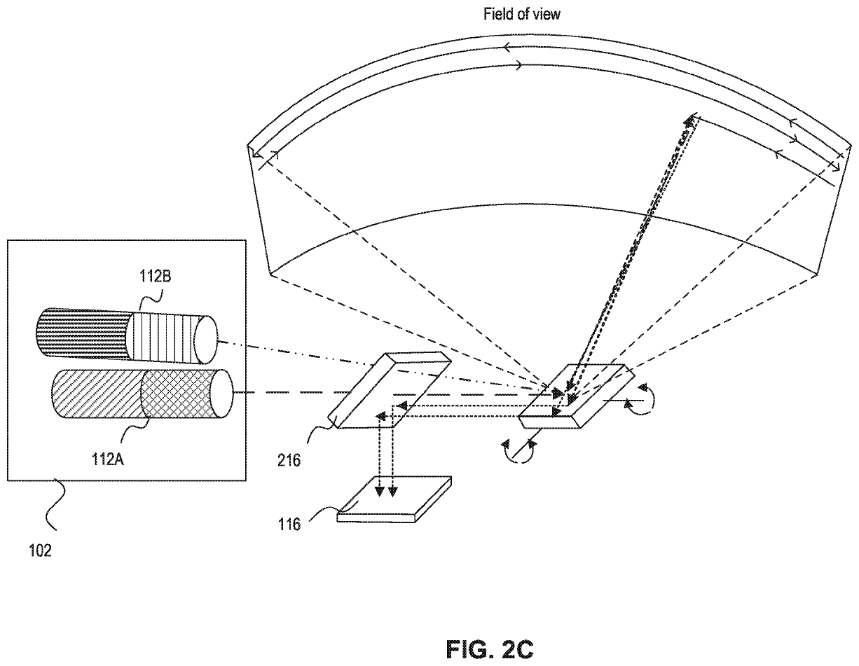

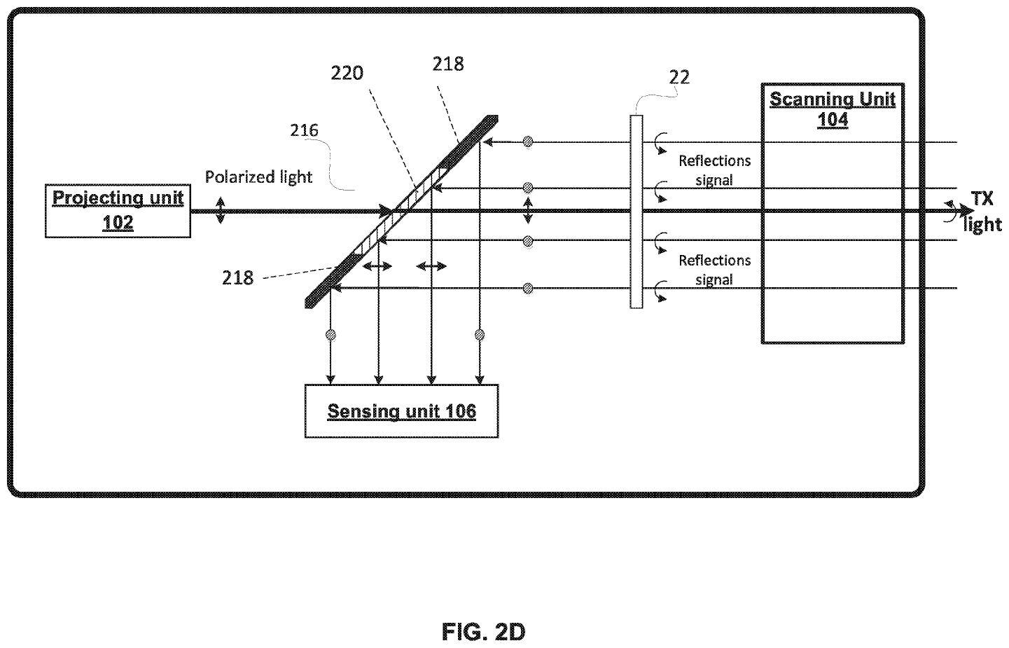

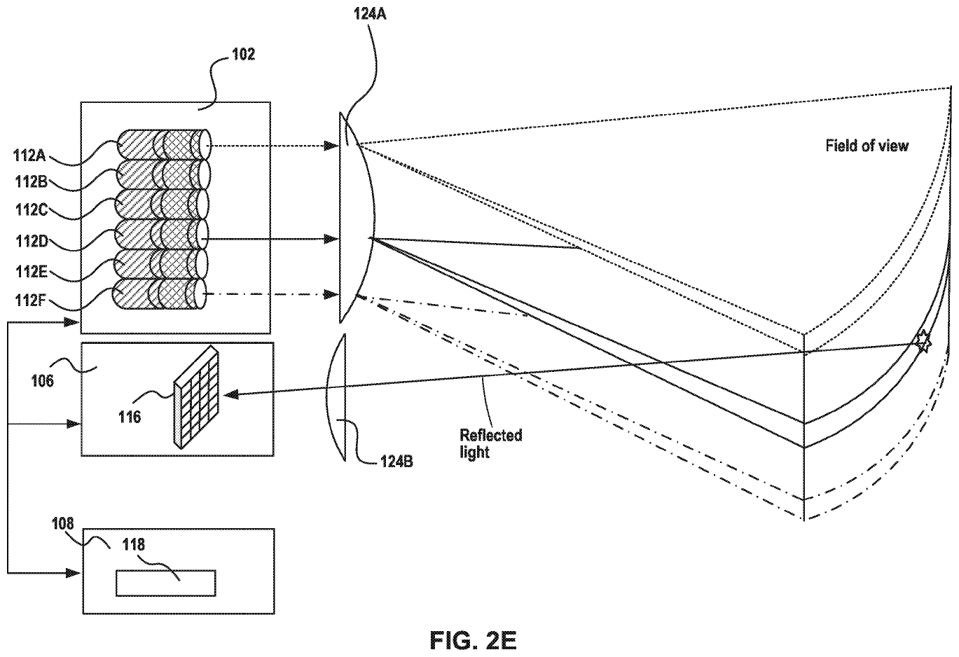

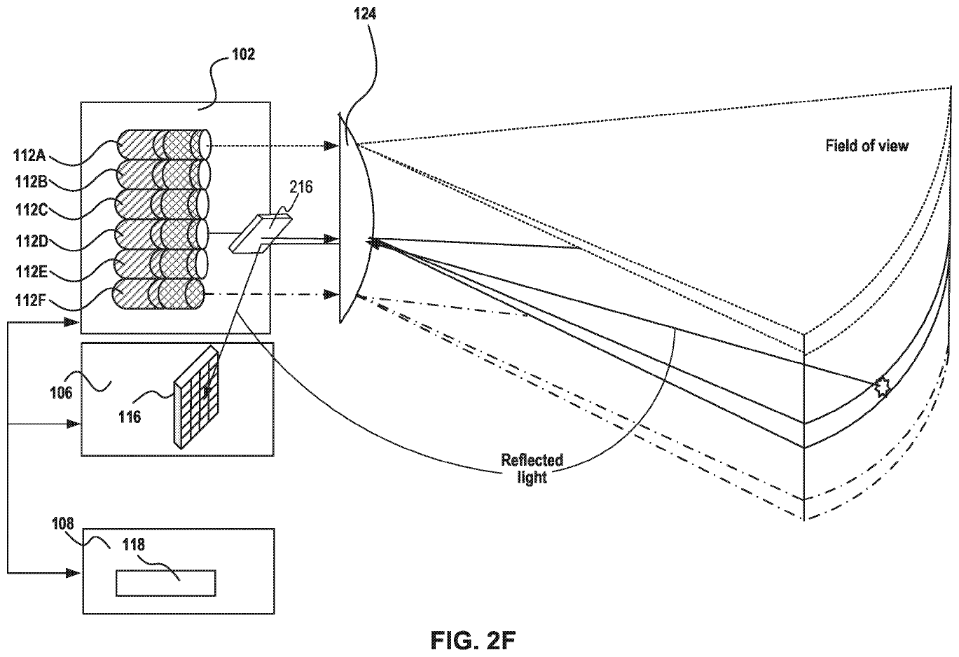

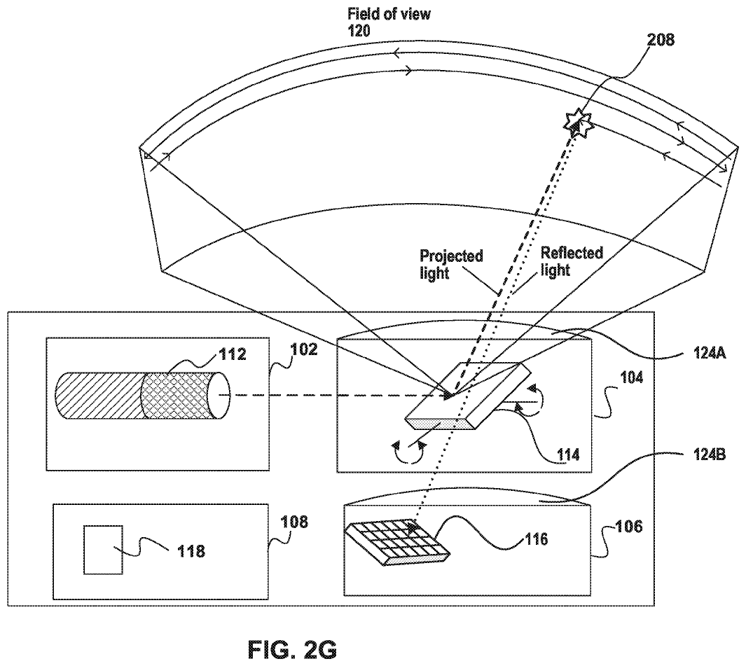

Consistent with disclosed embodiments, the LIDAR system may include at least one projecting unit with a light source configured to project light. As used herein the term “light source” broadly refers to any device configured to emit light. In one embodiment, the light source may be a laser such as a solid-state laser, laser diode, a high power laser, or an alternative light source such as, a light emitting diode (LED)-based light source. In addition, light source 112 as illustrated throughout the figures, may emit light in differing formats, such as light pulses, continuous wave (CW), quasi-CW, and so on. For example, one type of light source that may be used is a vertical-cavity surface-emitting laser (VCSEL). Another type of light source that may be used is an external cavity diode laser (ECDL). In some examples, the light source may include a laser diode configured to emit light at a wavelength between about 650 nm and 1150 nm. Alternatively, the light source may include a laser diode configured to emit light at a wavelength between about 800 nm and about 1000 nm, between about 850 nm and about 950 nm, or between about 1300 nm and about 1600 nm. Unless indicated otherwise, the term “about” with regards to a numeric value is defined as a variance of up to 5% with respect to the stated value. Additional details on the projecting unit and the at least one light source are described below with reference to FIGS. 2A-2C.

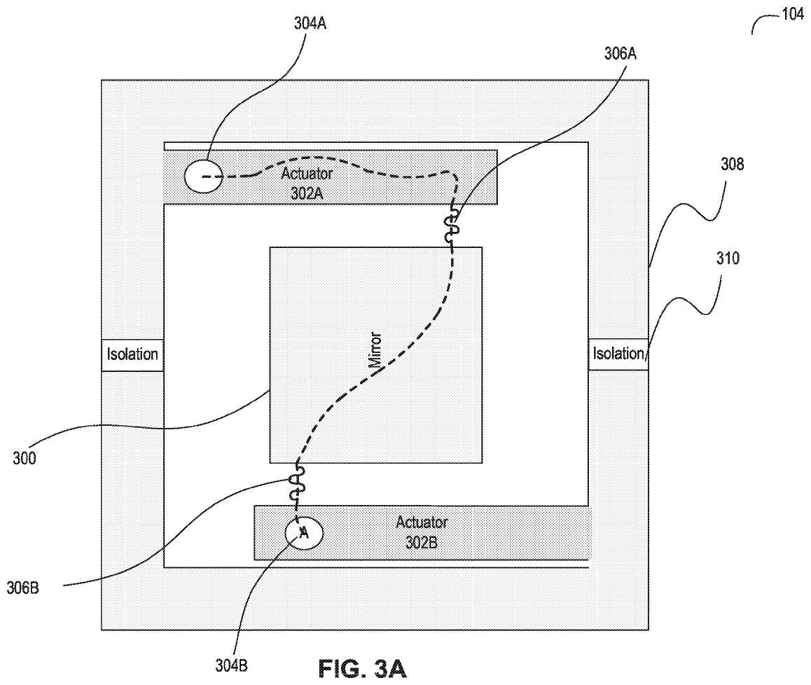

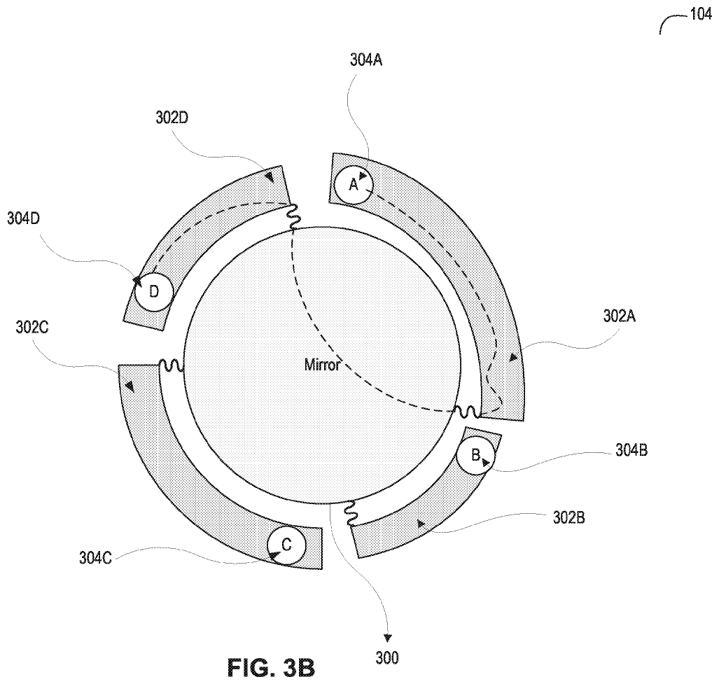

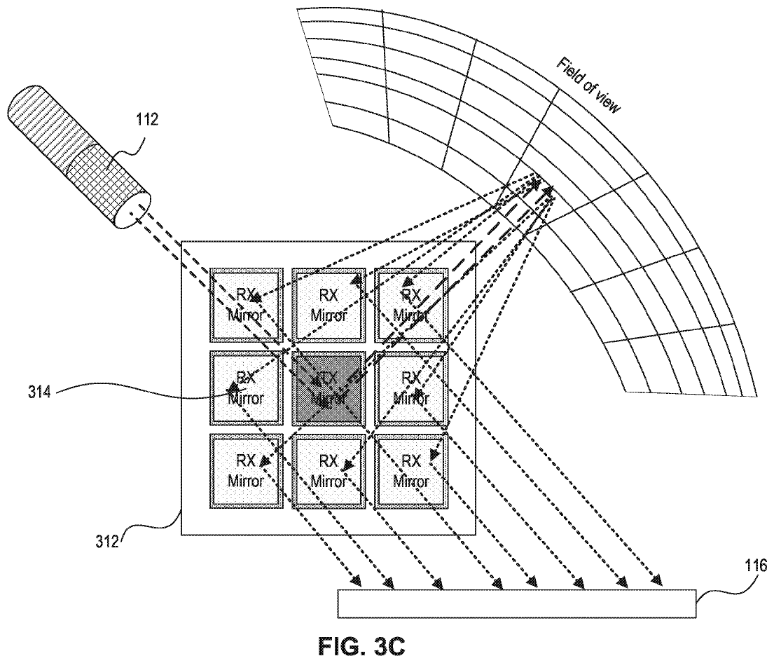

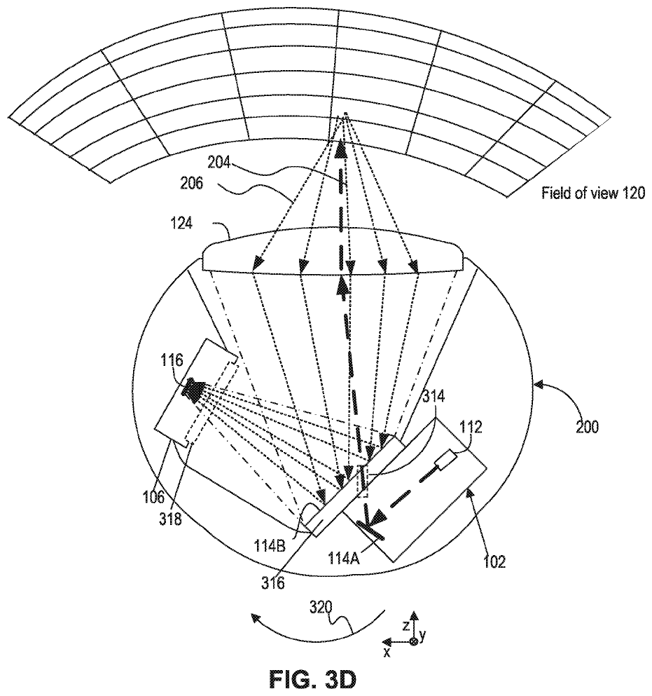

Consistent with disclosed embodiments, the LIDAR system may include at least one scanning unit with at least one light deflector configured to deflect light from the light source in order to scan the field of view. The term “light deflector” broadly includes any mechanism or module which is configured to make light deviate from its original path; for example, a mirror, a prism, controllable lens, a mechanical mirror, mechanical scanning polygons, active diffraction (e.g., controllable LCD), Risley prisms, non-mechanical-electro-optical beam steering (such as made by Vscent), polarization grating (such as offered by Boulder Non-Linear Systems), optical phased array (OPA), and more. In one embodiment, a light deflector may include a plurality of optical components, such as at least one reflecting element (e.g., a mirror), at least one refracting element (e.g., a prism, a lens), and so on. In one example, the light deflector may be movable, to cause light deviate to differing degrees (e.g., discrete degrees, or over a continuous span of degrees). The light deflector may optionally be controllable in different ways (e.g., deflect to a degree α, change deflection angle by Δα, move a component of the light deflector by M millimeters, change speed in which the deflection angle changes). In addition, the light deflector may optionally be operable to change an angle of deflection within a single plane (e.g., θ coordinate). The light deflector may optionally be operable to change an angle of deflection within two non-parallel planes (e.g., θ and φ coordinates). Alternatively or in addition, the light deflector may optionally be operable to change an angle of deflection between predetermined settings (e.g., along a predefined scanning route) or otherwise. With respect the use of light deflectors in LIDAR systems, it is noted that a light deflector may be used in the outbound direction (also referred to as transmission direction, or TX) to deflect light from the light source to at least a part of the field of view. However, a light deflector may also be used in the inbound direction (also referred to as reception direction, or RX) to deflect light from at least a part of the field of view to one or more light sensors. Additional details on the scanning unit and the at least one light deflector are described below with reference to FIGS. 3A-3C.

Disclosed embodiments may involve pivoting the light deflector in order to scan the field of view. As used herein the term “pivoting” broadly includes rotating of an object (especially a solid object) about one or more axis of rotation, while substantially maintaining a center of rotation fixed. In one embodiment, the pivoting of the light deflector may include rotation of the light deflector about a fixed axis (e.g., a shaft), but this is not necessarily so. For example, in some MEMS mirror implementation, the MEMS mirror may move by actuation of a plurality of benders connected to the mirror, the mirror may experience some spatial translation in addition to rotation. Nevertheless, such mirror may be designed to rotate about a substantially fixed axis, and therefore consistent with the present disclosure it considered to be pivoted. In other embodiments, some types of light deflectors (e.g., non-mechanical-electro-optical beam steering, OPA) do not require any moving components or internal movements in order to change the deflection angles of deflected light. It is noted that any discussion relating to moving or pivoting a light deflector is also mutatis mutandis applicable to controlling the light deflector such that it changes a deflection behavior of the light deflector. For example, controlling the light deflector may cause a change in a deflection angle of beams of light arriving from at least one direction.

Disclosed embodiments may involve receiving reflections associated with a portion of the field of view corresponding to a single instantaneous position of the light deflector. As used herein, the term “instantaneous position of the light deflector” (also referred to as “state of the light deflector”) broadly refers to the location or position in space where at least one controlled component of the light deflector is situated at an instantaneous point in time, or over a short span of time. In one embodiment, the instantaneous position of light deflector may be gauged with respect to a frame of reference. The frame of reference may pertain to at least one fixed point in the LIDAR system. Or, for example, the frame of reference may pertain to at least one fixed point in the scene. In some embodiments, the instantaneous position of the light deflector may include some movement of one or more components of the light deflector (e.g., mirror, prism), usually to a limited degree with respect to the maximal degree of change during a scanning of the field of view. For example, a scanning of the entire the field of view of the LIDAR system may include changing deflection of light over a span of 30°, and the instantaneous position of the at least one light deflector may include angular shifts of the light deflector within 0.05°. In other embodiments, the term “instantaneous position of the light deflector” may refer to the positions of the light deflector during acquisition of light which is processed to provide data for a single point of a point cloud (or another type of 3D model) generated by the LIDAR system. In some embodiments, an instantaneous position of the light deflector may correspond with a fixed position or orientation in which the deflector pauses for a short time during illumination of a particular sub-region of the LIDAR field of view. In other cases, an instantaneous position of the light deflector may correspond with a certain position/orientation along a scanned range of positions/orientations of the light deflector that the light deflector passes through as part of a continuous or semi-continuous scan of the LIDAR field of view. In some embodiments, the light deflector may be moved such that during a scanning cycle of the LIDAR FOV the light deflector is located at a plurality of different instantaneous positions. In other words, during the period of time in which a scanning cycle occurs, the deflector may be moved through a series of different instantaneous positions/orientations, and the deflector may reach each different instantaneous position/orientation at a different time during the scanning cycle.

Consistent with disclosed embodiments, the LIDAR system may include at least one sensing unit with at least one sensor configured to detect reflections from objects in the field of view. The term “sensor” broadly includes any device, element, or system capable of measuring properties (e.g., power, frequency, phase, pulse timing, pulse duration) of electromagnetic waves and to generate an output relating to the measured properties. In some embodiments, the at least one sensor may include a plurality of detectors constructed from a plurality of detecting elements. The at least one sensor may include light sensors of one or more types. It is noted that the at least one sensor may include multiple sensors of the same type which may differ in other characteristics (e.g., sensitivity, size). Other types of sensors may also be used. Combinations of several types of sensors can be used for different reasons, such as improving detection over a span of ranges (especially in close range); improving the dynamic range of the sensor; improving the temporal response of the sensor; and improving detection in varying environmental conditions (e.g., atmospheric temperature, rain, etc.).

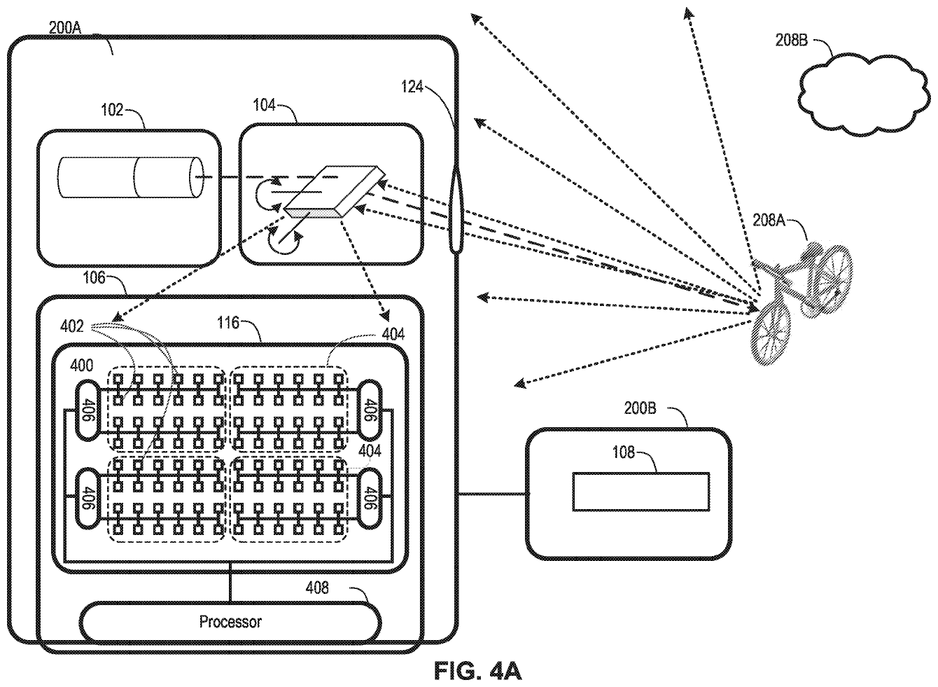

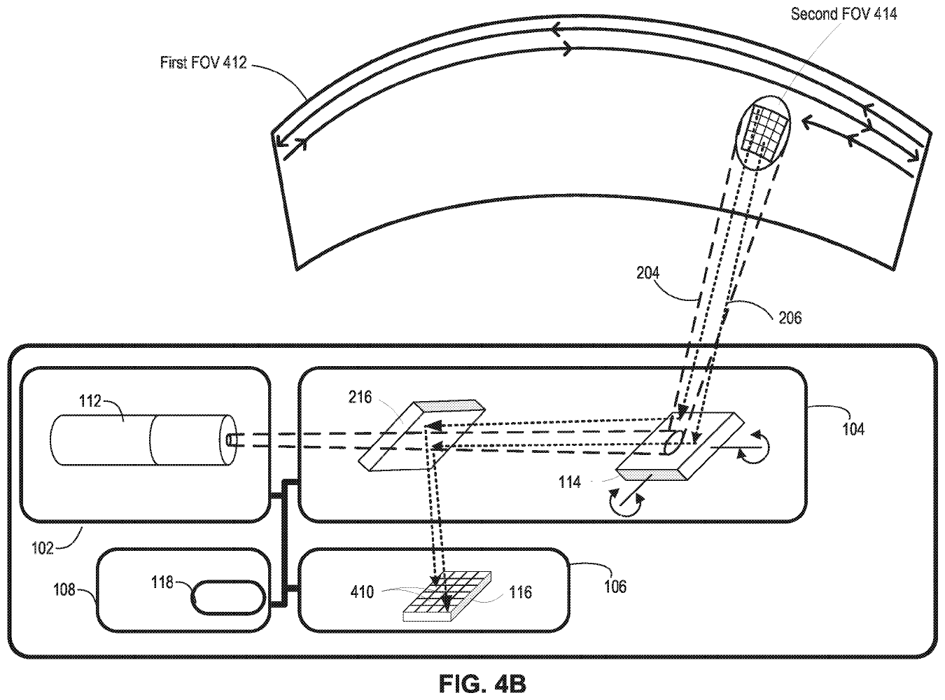

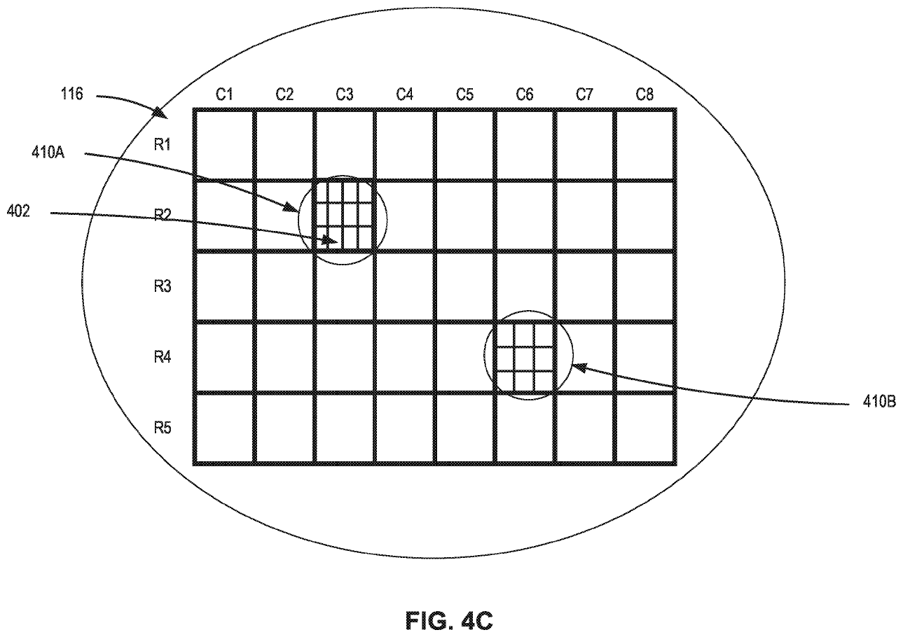

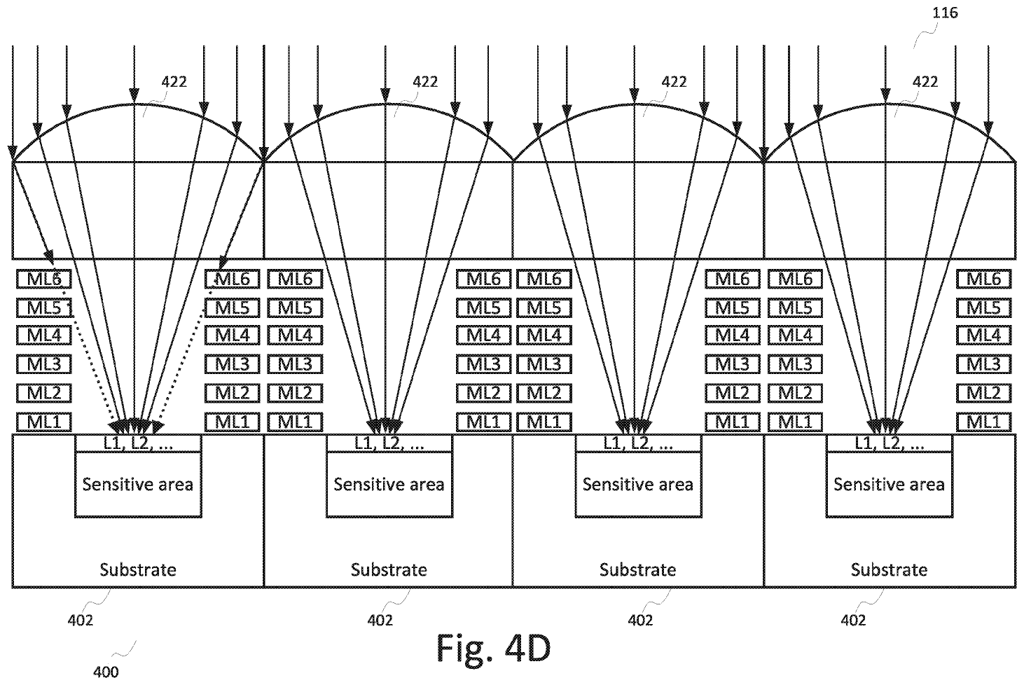

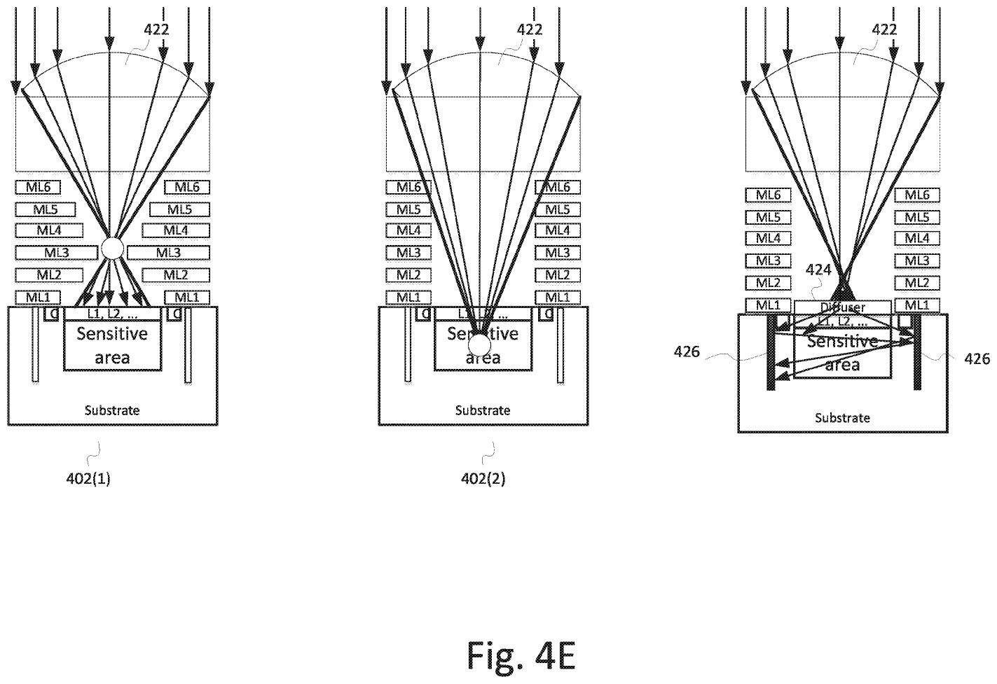

In one embodiment, the at least one sensor includes a SiPM (Silicon photomultipliers) which is a solid-state single-photon-sensitive device built from an array of avalanche photodiode (APD), single photon avalanche diode (SPAD), serving as detection elements on a common silicon substrate. In one example, a typical distance between SPADs may be between about 10 micrometers and about 50 micrometers, wherein each SPAD may have a recovery time of between about 20 ns and about 100 ns. Similar photomultipliers from other, non-silicon materials may also be used. Although a SiPM device works in digital/switching mode, the SiPM is an analog device because all the microcells may be read in parallel, making it possible to generate signals within a dynamic range from a single photon to hundreds and thousands of photons detected by the different SPADs. It is noted that outputs from different types of sensors (e.g., SPAD, APD, SiPM, PIN diode, Photodetector) may be combined together to a single output which may be processed by a processor of the LIDAR system. Additional details on the sensing unit and the at least one sensor are described below with reference to FIGS. 4A-4C.

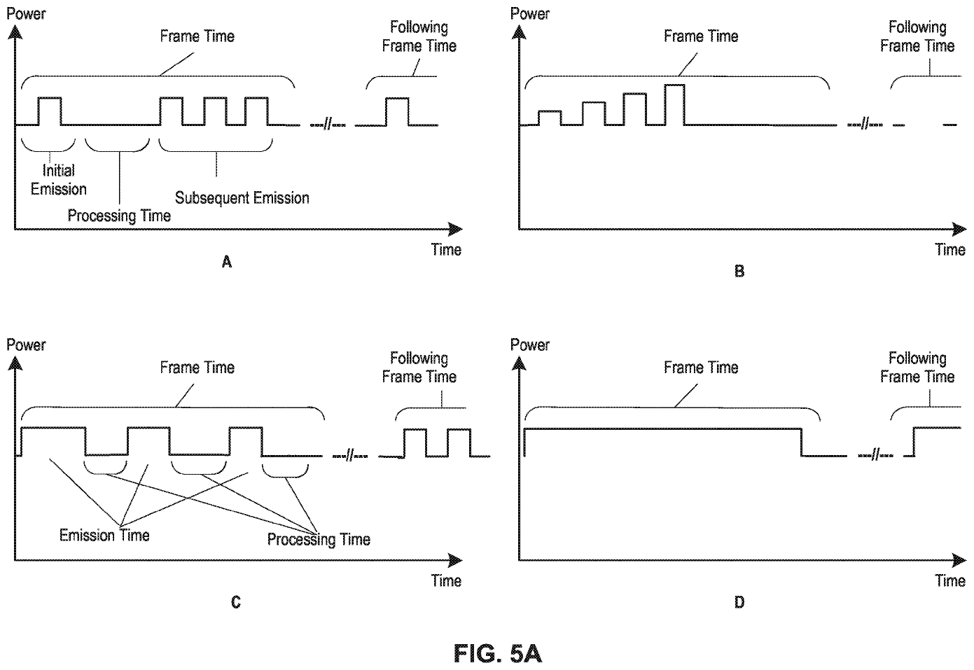

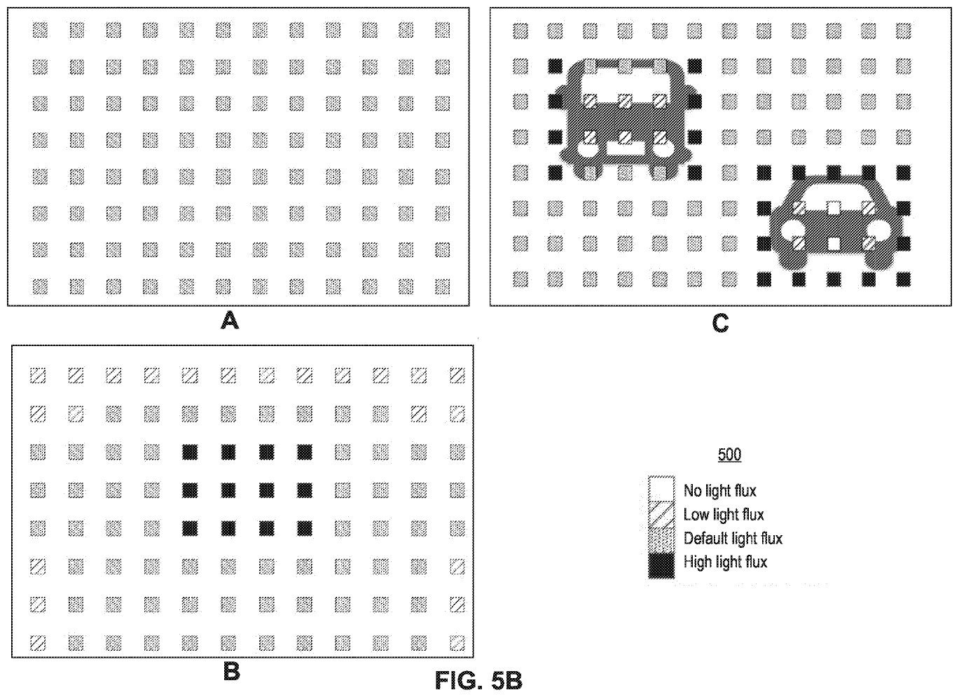

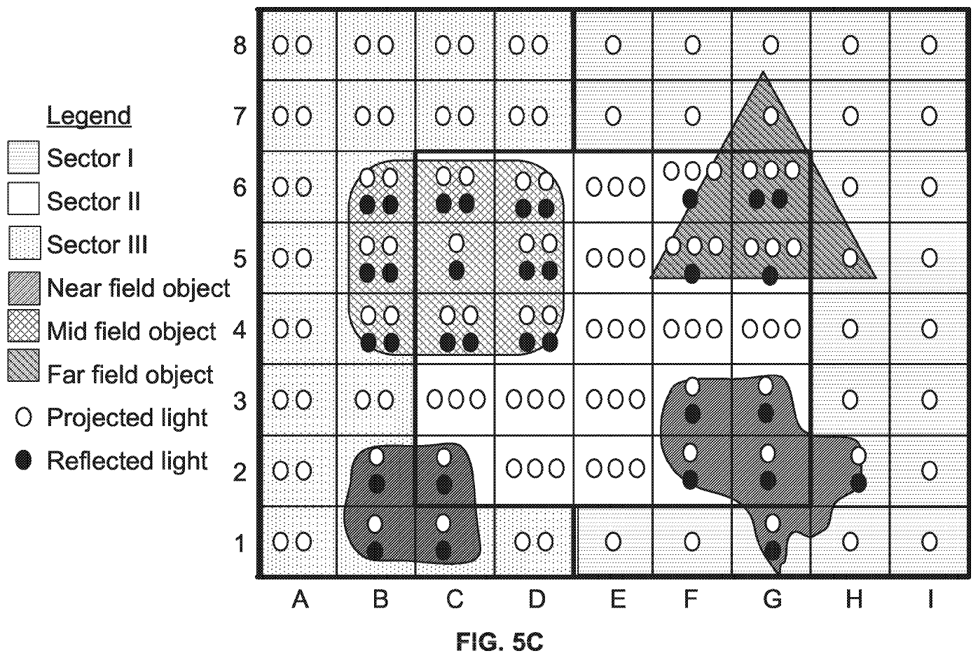

Consistent with disclosed embodiments, the LIDAR system may include or communicate with at least one processor configured to execute differing functions. The at least one processor may constitute any physical device having an electric circuit that performs a logic operation on input or inputs. For example, the at least one processor may include one or more integrated circuits (IC), including Application-specific integrated circuit (ASIC), microchips, microcontrollers, microprocessors, all or part of a central processing unit (CPU), graphics processing unit (GPU), digital signal processor (DSP), field-programmable gate array (FPGA), or other circuits suitable for executing instructions or performing logic operations. The instructions executed by at least one processor may, for example, be pre-loaded into a memory integrated with or embedded into the controller or may be stored in a separate memory. The memory may comprise a Random Access Memory (RAM), a Read-Only Memory (ROM), a hard disk, an optical disk, a magnetic medium, a flash memory, other permanent, fixed, or volatile memory, or any other mechanism capable of storing instructions. In some embodiments, the memory is configured to store information representative data about objects in the environment of the LIDAR system. In some embodiments, the at least one processor may include more than one processor. Each processor may have a similar construction, or the processors may be of differing constructions that are electrically connected or disconnected from each other. For example, the processors may be separate circuits or integrated in a single circuit. When more than one processor is used, the processors may be configured to operate independently or collaboratively. The processors may be coupled electrically, magnetically, optically, acoustically, mechanically or by other means that permit them to interact. Additional details on the processing unit and the at least one processor are described below with reference to FIGS. 5A-5C.

### System Overview

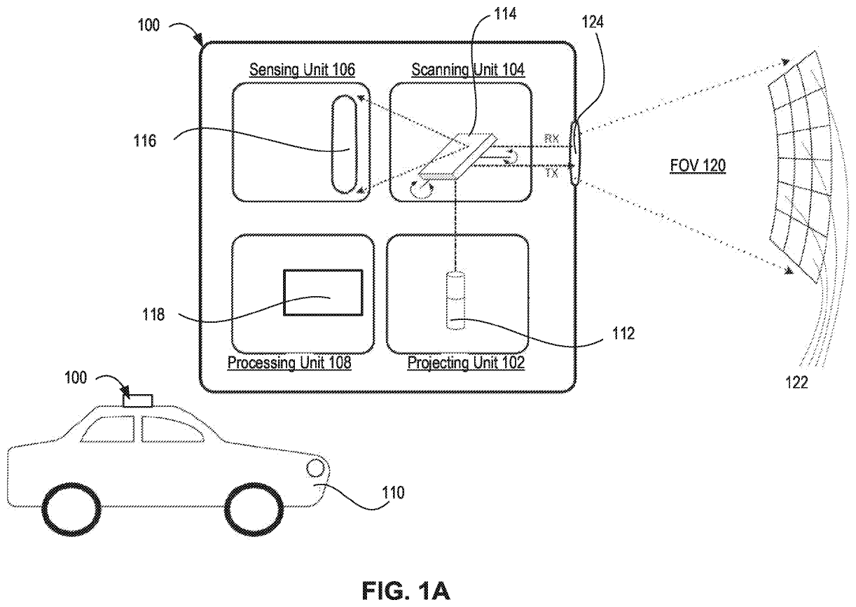

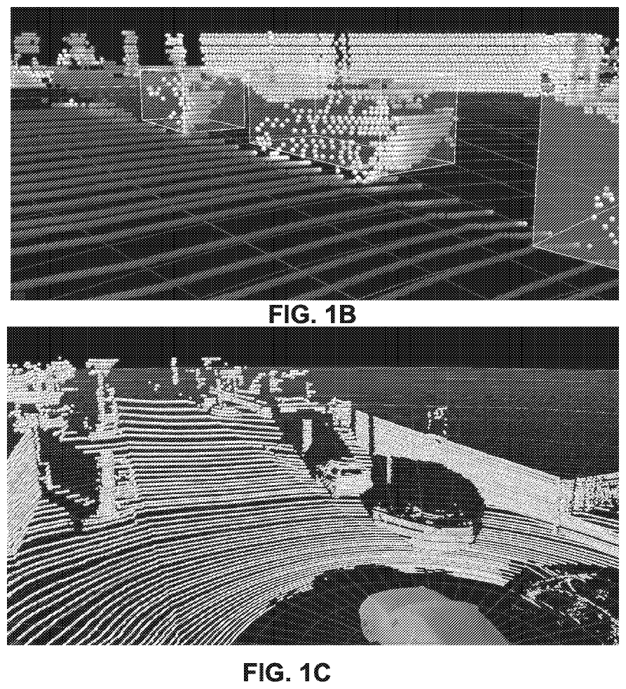

FIG. 1A illustrates a LIDAR system 100 including a projecting unit 102, a scanning unit 104, a sensing unit 106, and a processing unit 108. LIDAR system 100 may be mountable on a vehicle 110. Consistent with embodiments of the present disclosure, projecting unit 102 may include at least one light source 112, scanning unit 104 may include at least one light deflector 114, sensing unit 106 may include at least one sensor 116, and processing unit 108 may include at least one processor 118. In one embodiment, at least one processor 118 may be configured to coordinate operation of the at least one light source 112 with the movement of at least one light deflector 114 in order to scan a field of view 120. During a scanning cycle, each instantaneous position of at least one light deflector 114 may be associated with a particular portion 122 of field of view 120. In addition, LIDAR system 100 may include at least one optional optical window 124 for directing light projected towards field of view 120 and/or receiving light reflected from objects in field of view 120. Optional optical window 124 may serve different purposes, such as collimation of the projected light and focusing of the reflected light. In one embodiment, optional optical window 124 may be an opening, a flat window, a lens, or any other type of optical window.

Consistent with the present disclosure. LIDAR system 100 may be used in autonomous or semi-autonomous road-vehicles (for example, cars, buses, vans, trucks and any other terrestrial vehicle). Autonomous road-vehicles with LIDAR system 100 may scan their environment and drive to a destination vehicle without human input. Similarly, LIDAR system 100 may also be used in autonomous/semi-autonomous aerial-vehicles (for example, UAV, drones, quadcopters, and any other airborne vehicle or device); or in an autonomous or semi-autonomous water vessel (e.g., boat, ship, submarine, or any other watercraft). Autonomous aerial-vehicles and watercraft with LIDAR system 100 may scan their environment and navigate to a destination autonomously or using a remote human operator. According to one embodiment, vehicle 110 (either a road-vehicle, aerial-vehicle, or watercraft) may use LIDAR system 100 to aid in detecting and scanning the environment in which vehicle 110 is operating.

It should be noted that LIDAR system 100 or any of its components may be used together with any of the example embodiments and methods disclosed herein. Further, while some aspects of LIDAR system 100 are described relative to an exemplary vehicle-based LIDAR platform, LIDAR system 100, any of its components, or any of the processes described herein may be applicable to LIDAR systems of other platform types.

In some embodiments, LIDAR system 100 may include one or more scanning units 104 to scan the environment around vehicle 110. LIDAR system 100 may be attached or mounted to any part of vehicle 110. Sensing unit 106 may receive reflections from the surroundings of vehicle 110, and transfer reflections signals indicative of light reflected from objects in field of view 120 to processing unit 108. Consistent with the present disclosure, scanning units 104 may be mounted to or incorporated into a bumper, a fender, a side panel, a spoiler, a roof, a headlight assembly, a taillight assembly, a rear-view mirror assembly, a hood, a trunk or any other suitable part of vehicle 110 capable of housing at least a portion of the LIDAR system. In some cases, LIDAR system 100 may capture a complete surround view of the environment of vehicle 110. Thus, LIDAR system 100 may have a 360-degree horizontal field of view. In one example, as shown in FIG. 1A, LIDAR system 100 may include a single scanning unit 104 mounted on a roof vehicle 110. Alternatively, LIDAR system 100 may include multiple scanning units (e.g., two, three, four, or more scanning units 104) each with a field of few such that in the aggregate the horizontal field of view is covered by a 360-degree scan around vehicle 110. One skilled in the art will appreciate that LIDAR system 100 may include any number of scanning units 104 arranged in any manner, each with an 80° to 120° field of view or less, depending on the number of units employed. Moreover, a 360-degree horizontal field of view may be also obtained by mounting multiple LIDAR systems 100 on vehicle 110, each with a single scanning unit 104. It is nevertheless noted that the one or more LIDAR systems 100 do not have to provide a complete 360° field of view, and that narrower fields of view may be useful in some situations. For example, vehicle 110 may require a first LIDAR system 100 having an field of view of 75° looking ahead of the vehicle, and possibly a second LIDAR system 100 with a similar FOV looking backward (optionally with a lower detection range). It is also noted that different vertical field of view angles may also be implemented.

FIG. 1B is an image showing an exemplary output from a single scanning cycle of LIDAR system 100 mounted on vehicle 110 consistent with disclosed embodiments. In this example, scanning unit 104 is incorporated into a right headlight assembly of vehicle 110. Every gray dot in the image corresponds to a location in the environment around vehicle 110 determined from reflections detected by sensing unit 106. In addition to location, each gray dot may also be associated with different types of information, for example, intensity (e.g., how much light returns back from that location), reflectivity, proximity to other dots, and more. In one embodiment, LIDAR system 100 may generate a plurality of point-cloud data entries from detected reflections of multiple scanning cycles of the field of view to enable, for example, determining a point cloud model of the environment around vehicle 110.

FIG. 1C is an image showing a representation of the point cloud model determined from the output of LIDAR system 100. Consistent with disclosed embodiments, by processing the generated point-cloud data entries of the environment around vehicle 110, a surround-view image may be produced from the point cloud model. In one embodiment, the point cloud model may be provided to a feature extraction module, which processes the point cloud information to identify a plurality of features. Each feature may include data about different aspects of the point cloud and/or of objects in the environment around vehicle 110 (e.g., cars, trees, people, and roads). Features may have the same resolution of the point cloud model (i.e., having the same number of data points, optionally arranged into similar sized 2D arrays), or may have different resolutions. The features may be stored in any kind of data structure (e.g., raster, vector, 2D array, 1D array). In addition, virtual features, such as a representation of vehicle 110, border lines, or bounding boxes separating regions or objects in the image (e.g., as depicted in FIG. 1B), and icons representing one or more identified objects, may be overlaid on the representation of the point cloud model to form the final surround-view image. For example, a symbol of vehicle 110 may be overlaid at a center of the surround-view image.

### The Projecting Unit

FIGS. 2A-2G depict various configurations of projecting unit 102 and its role in LIDAR system 100. Specifically, FIG. 2A is a diagram illustrating projecting unit 102 with a single light source; FIG. 2B is a diagram illustrating a plurality of projecting units 102 with a plurality of light sources aimed at a common light deflector 114; FIG. 2C is a diagram illustrating projecting unit 102 with a primary and a secondary light sources 112; FIG. 2D is a diagram illustrating an asymmetrical deflector used in some configurations of projecting unit 102; FIG. 2E is a diagram illustrating a first configuration of a non-scanning LIDAR system; FIG. 2F is a diagram illustrating a second configuration of a non-scanning LIDAR system; and FIG. 2G is a diagram illustrating a LIDAR system that scans in the outbound direction and does not scan in the inbound direction. One skilled in the art will appreciate that the depicted configurations of projecting unit 102 may have numerous variations and modifications.

FIG. 2A illustrates an example of a bi-static configuration of LIDAR system 100 in which projecting unit 102 includes a single light source 112. The term “bi-static configuration” broadly refers to LIDAR systems configurations in which the projected light exiting the LIDAR system and the reflected light entering the LIDAR system pass through substantially different optical paths. In some embodiments, a bi-static configuration of LIDAR system 100 may include a separation of the optical paths by using completely different optical components, by using parallel but not fully separated optical components, or by using the same optical components for only part of the of the optical paths (optical components may include, for example, windows, lenses, mirrors, beam splitters, etc.). In the example depicted in FIG. 2A, the bi-static configuration includes a configuration where the outbound light and the inbound light pass through a single optical window 124 but scanning unit 104 includes two light deflectors, a first light deflector 114A for outbound light and a second light deflector 114B for inbound light (the inbound light in LIDAR system includes emitted light reflected from objects in the scene, and may also include ambient light arriving from other sources). In the examples depicted in FIGS. 2E and 2G, the bi-static configuration includes a configuration where the outbound light passes through a first optical window 124A, and the inbound light passes through a second optical window 124B. In all the example configurations above, the inbound and outbound optical paths differ from one another.

In this embodiment, all the components of LIDAR system 100 may be contained within a single housing 200, or may be divided among a plurality of housings. As shown, projecting unit 102 is associated with a single light source 112 that includes a laser diode 202A (or one or more laser diodes coupled together) configured to emit light (projected light 204). In one non-limiting example, the light projected by light source 112 may be at a wavelength between about 800 nm and 950 nm, have an average power between about 50 mW and about 500 mW, have a peak power between about 50 W and about 200 W, and a pulse width of between about 2 ns and about 100 ns. In addition, light source 112 may optionally be associated with optical assembly 202B used for manipulation of the light emitted by laser diode 202A (e.g., for collimation, focusing, etc.). It is noted that other types of light sources 112 may be used, and that the disclosure is not restricted to laser diodes. In addition, light source 112 may emit its light in different formats, such as light pulses, frequency modulated, continuous wave (CW), quasi-CW, or any other form corresponding to the particular light source employed. The projection format and other parameters may be changed by the light source from time to time based on different factors, such as instructions from processing unit 108. The projected light is projected towards an outbound deflector 114A that functions as a steering element for directing the projected light in field of view 120. In this example, scanning unit 104 also include a pivotable return deflector 114B that direct photons (reflected light 206) reflected back from an object 208 within field of view 120 toward sensor 116. The reflected light is detected by sensor 116 and information about the object (e.g., the distance to object 212) is determined by processing unit 108.

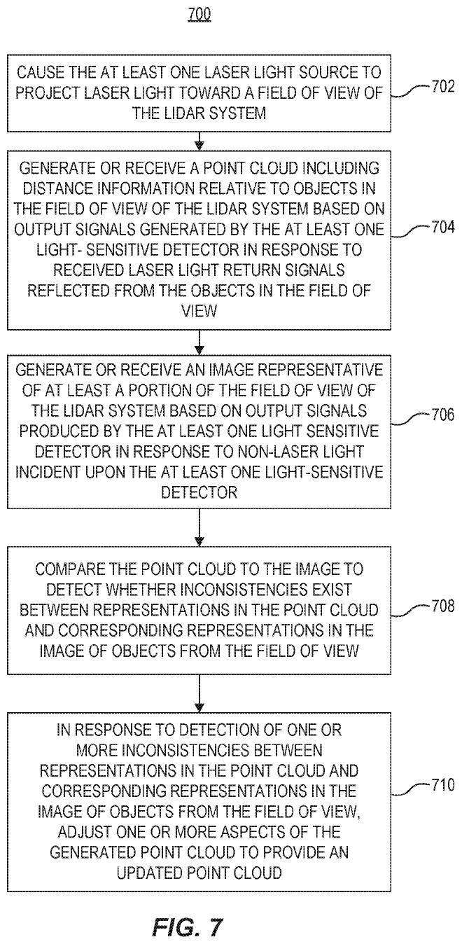

In this figure, LIDAR system 100 is connected to a host 210. Consistent with the present disclosure, the term “host” refers to any computing environment that may interface with LIDAR system 100, it may be a vehicle system (e.g., part of vehicle 110), a testing system, a security system, a surveillance system, a traffic control system, an urban modelling system, or any system that monitors its surroundings. Such computing environment may include at least one processor and/or may be connected LIDAR system 100 via the cloud. In some embodiments, host 210 may also include interfaces to external devices such as camera and sensors configured to measure different characteristics of host 210 (e.g., acceleration, steering wheel deflection, reverse drive, etc.). Consistent with the present disclosure, LIDAR system 100 may be fixed to a stationary object associated with host 210 (e.g., a building, a tripod) or to a portable system associated with host 210 (e.g., a portable computer, a movie camera). Consistent with the present disclosure, LIDAR system 100 may be connected to host 210, to provide outputs of LIDAR system 100 (e.g., a 3D model, a reflectivity image) to host 210. Specifically, host 210 may use LIDAR system 100 to aid in detecting and scanning the environment of host 210 or any other environment. In addition, host 210 may integrate, synchronize or otherwise use together the outputs of LIDAR system 100 with outputs of other sensing systems (e.g., cameras, microphones, radar systems). In one example, LIDAR system 100 may be used by a security system. This embodiment is described in greater detail below with reference to FIG. 7.

LIDAR system 100 may also include a bus 212 (or other communication mechanisms) that interconnect subsystems and components for transferring information within LIDAR system 100. Optionally, bus 212 (or another communication mechanism) may be used for interconnecting LIDAR system 100 with host 210. In the example of FIG. 2A, processing unit 108 includes two processors 118 to regulate the operation of projecting unit 102, scanning unit 104, and sensing unit 106 in a coordinated manner based, at least partially, on information received from internal feedback of LIDAR system 100. In other words, processing unit 108 may be configured to dynamically operate LIDAR system 100 in a closed loop. A closed loop system is characterized by having feedback from at least one of the elements and updating one or more parameters based on the received feedback. Moreover, a closed loop system may receive feedback and update its own operation, at least partially, based on that feedback. A dynamic system or element is one that may be updated during operation.

According to some embodiments, scanning the environment around LIDAR system 100 may include illuminating field of view 120 with light pulses. The light pulses may have parameters such as: pulse duration, pulse angular dispersion, wavelength, instantaneous power, photon density at different distances from light source 112, average power, pulse power intensity, pulse width, pulse repetition rate, pulse sequence, pulse duty cycle, wavelength, phase, polarization, and more. Scanning the environment around LIDAR system 100 may also include detecting and characterizing various aspects of the reflected light. Characteristics of the reflected light may include, for example: time-of-flight (i.e., time from emission until detection), instantaneous power (e.g., power signature), average power across entire return pulse, and photon distribution/signal over return pulse period. By comparing characteristics of a light pulse with characteristics of corresponding reflections, a distance and possibly a physical characteristic, such as reflected intensity of object 212 may be estimated. By repeating this process across multiple adjacent portions 122, in a predefined pattern (e.g., raster, Lissajous or other patterns) an entire scan of field of view 120 may be achieved. As discussed below in greater detail, in some situations LIDAR system 100 may direct light to only some of the portions 122 in field of view 120 at every scanning cycle. These portions may be adjacent to each other, but not necessarily so.

In another embodiment, LIDAR system 100 may include network interface 214 for communicating with host 210 (e.g., a vehicle controller). The communication between LIDAR system 100 and host 210 is represented by a dashed arrow. In one embodiment, network interface 214 may include an integrated services digital network (ISDN) card, cable modem, satellite modem, or a modem to provide a data communication connection to a corresponding type of telephone line. As another example, network interface 214 may include a local area network (LAN) card to provide a data communication connection to a compatible LAN. In another embodiment, network interface 214 may include an Ethernet port connected to radio frequency receivers and transmitters and/or optical (e.g., infrared) receivers and transmitters. The specific design and implementation of network interface 214 depends on the communications network(s) over which LIDAR system 100 and host 210 are intended to operate. For example, network interface 214 may be used, for example, to provide outputs of LIDAR system 100 to the external system, such as a 3D model, operational parameters of LIDAR system 100, and so on. In other embodiment, the communication unit may be used, for example, to receive instructions from the external system, to receive information regarding the inspected environment, to receive information from another sensor, etc.

FIG. 2B illustrates an example of a monostatic configuration of LIDAR system 100 including a plurality projecting units 102. The term “monostatic configuration” broadly refers to LIDAR system configurations in which the projected light exiting from the LIDAR system and the reflected light entering the LIDAR system pass through substantially similar optical paths. In one example, the outbound light beam and the inbound light beam may share at least one optical assembly through which both outbound and inbound light beams pass. In another example, the outbound light may pass through an optical window (not shown) and the inbound light radiation may pass through the same optical window. A monostatic configuration may include a configuration where the scanning unit 104 includes a single light deflector 114 that directs the projected light towards field of view 120 and directs the reflected light towards a sensor 116. As shown, both projected light 204 and reflected light 206 hits an asymmetrical deflector 216. The term “asymmetrical deflector” refers to any optical device having two sides capable of deflecting a beam of light hitting it from one side in a different direction than it deflects a beam of light hitting it from the second side. In one example, the asymmetrical deflector does not deflect projected light 204 and deflects reflected light 206 towards sensor 116. One example of an asymmetrical deflector may include a polarization beam splitter. In another example, asymmetrical 216 may include an optical isolator that allows the passage of light in only one direction. A diagrammatic representation of asymmetrical deflector 216 is illustrated in FIG. 2D. Consistent with the present disclosure, a monostatic configuration of LIDAR system 100 may include an asymmetrical deflector to prevent reflected light from hitting light source 112, and to direct all the reflected light toward sensor 116, thereby increasing detection sensitivity.

In the embodiment of FIG. 2B, LIDAR system 100 includes three projecting units 102 each with a single of light source 112 aimed at a common light deflector 114. In one embodiment, the plurality of light sources 112 (including two or more light sources) may project light with substantially the same wavelength and each light source 112 is generally associated with a differing area of the field of view (denoted in the figure as 120A, 120B, and 120C). This enables scanning of a broader field of view than can be achieved with a light source 112. In another embodiment, the plurality of light sources 102 may project light with differing wavelengths, and all the light sources 112 may be directed to the same portion (or overlapping portions) of field of view 120.

FIG. 2C illustrates an example of LIDAR system 100 in which projecting unit 102 includes a primary light source 112A and a secondary light source 112B. Primary light source 112A may project light with a longer wavelength than is sensitive to the human eye in order to optimize SNR and detection range. For example, primary light source 112A may project light with a wavelength between about 750 nm and 1100 nm. In contrast, secondary light source 112B may project light with a wavelength visible to the human eye. For example, secondary light source 112B may project light with a wavelength between about 400 nm and 700 nm. In one embodiment, secondary light source 112B may project light along substantially the same optical path the as light projected by primary light source 112A. Both light sources may be time-synchronized and may project light emission together or in interleaved pattern. An interleave pattern means that the light sources are not active at the same time which may mitigate mutual interference. A person who is of skill in the art would readily see that other combinations of wavelength ranges and activation schedules may also be implemented.

Consistent with some embodiments, secondary light source 112B may cause human eyes to blink when it is too close to the LIDAR optical output port. This may ensure an eye safety mechanism not feasible with typical laser sources that utilize the near-infrared light spectrum. In another embodiment, secondary light source 112B may be used for calibration and reliability at a point of service, in a manner somewhat similar to the calibration of headlights with a special reflector/pattern at a certain height from the ground with respect to vehicle 110. An operator at a point of service could examine the calibration of the LIDAR by simple visual inspection of the scanned pattern over a featured target such a test pattern board at a designated distance from LIDAR system 100. In addition, secondary light source 112B may provide means for operational confidence that the LIDAR is working for the end-user. For example, the system may be configured to permit a human to place a hand in front of light deflector 114 to test its operation.

Secondary light source 112B may also have a non-visible element that can double as a backup system in case primary light source 112A fails. This feature may be useful for fail-safe devices with elevated functional safety ratings. Given that secondary light source 112B may be visible and also due to reasons of cost and complexity, secondary light source 112B may be associated with a smaller power compared to primary light source 112A. Therefore, in case of a failure of primary light source 112A, the system functionality will fall back to secondary light source 112B set of functionalities and capabilities. While the capabilities of secondary light source 112B may be inferior to the capabilities of primary light source 112A, LIDAR system 100 system may be designed in such a fashion to enable vehicle 110 to safely arrive its destination.

FIG. 2D illustrates asymmetrical deflector 216 that may be part of LIDAR system 100. In the illustrated example, asymmetrical deflector 216 includes a reflective surface 218 (such as a mirror) and a one-way deflector 220. While not necessarily so, asymmetrical deflector 216 may optionally be a static deflector. Asymmetrical deflector 216 may be used in a monostatic configuration of LIDAR system 100, in order to allow a common optical path for transmission and for reception of light via the at least one deflector 114, e.g., as illustrated in FIGS. 2B and 2C. However, typical asymmetrical deflectors such as beam splitters are characterized by energy losses, especially in the reception path, which may be more sensitive to power loses than the transmission path.

As depicted in FIG. 2D, LIDAR system 100 may include asymmetrical deflector 216 positioned in the transmission path, which includes one-way deflector 220 for separating between the transmitted and received light signals. Optionally, one-way deflector 220 may be substantially transparent to the transmission light and substantially reflective to the received light. The transmitted light is generated by projecting unit 102 and may travel through one-way deflector 220 to scanning unit 104 which deflects it towards the optical outlet. The received light arrives through the optical inlet, to the at least one deflecting element 114, which deflects the reflections signal into a separate path away from the light source and towards sensing unit 106. Optionally, asymmetrical deflector 216 may be combined with a polarized light source 112 which is linearly polarized with the same polarization axis as one-way deflector 220. Notably, the cross-section of the outbound light beam is much smaller than that of the reflections signals. Accordingly, LIDAR system 100 may include one or more optical components (e.g., lens, collimator) for focusing or otherwise manipulating the emitted polarized light beam to the dimensions of the asymmetrical deflector 216. In one embodiment, one-way deflector 220 may be a polarizing beam splitter that is virtually transparent to the polarized light beam.

Consistent with some embodiments, LIDAR system 100 may further include optics 222 (e.g., a quarter wave plate retarder) for modifying a polarization of the emitted light. For example, optics 222 may modify a linear polarization of the emitted light beam to circular polarization. Light reflected back to system 100 from the field of view would arrive back through deflector 114 to optics 222, bearing a circular polarization with a reversed handedness with respect to the transmitted light. Optics 222 would then convert the received reversed handedness polarization light to a linear polarization that is not on the same axis as that of the polarized beam splitter 216. As noted above, the received light-patch is larger than the transmitted light-patch, due to optical dispersion of the beam traversing through the distance to the target.

Some of the received light will impinge on one-way deflector 220 that will reflect the light towards sensor 106 with some power loss. However, another part of the received patch of light will fall on a reflective surface 218 which surrounds one-way deflector 220 (e.g., polarizing beam splitter slit). Reflective surface 218 will reflect the light towards sensing unit 106 with substantially zero power loss. One-way deflector 220 would reflect light that is composed of various polarization axes and directions that will eventually arrive at the detector. Optionally, sensing unit 106 may include sensor 116 that is agnostic to the laser polarization, and is primarily sensitive to the amount of impinging photons at a certain wavelength range.

It is noted that the proposed asymmetrical deflector 216 provides far superior performances when compared to a simple mirror with a passage hole in it. In a mirror with a hole, all of the reflected light which reaches the hole is lost to the detector. However, in deflector 216, one-way deflector 220 deflects a significant portion of that light (e.g., about 50%) toward the respective sensor 116. In LIDAR systems, the number photons reaching the LIDAR from remote distances is very limited, and therefore the improvement in photon capture rate is important.

According to some embodiments, a device for beam splitting and steering is described. A polarized beam may be emitted from a light source having a first polarization. The emitted beam may be directed to pass through a polarized beam splitter assembly. The polarized beam splitter assembly includes on a first side a one-directional slit and on an opposing side a mirror. The one-directional slit enables the polarized emitted beam to travel toward a quarter-wave-plate/wave-retarder which changes the emitted signal from a polarized signal to a linear signal (or vice versa) so that subsequently reflected beams cannot travel through the one-directional slit.

FIG. 2E shows an example of a bi-static configuration of LIDAR system 100 without scanning unit 104. In order to illuminate an entire field of view (or substantially the entire field of view) without deflector 114, projecting unit 102 may optionally include an array of light sources (e.g., 112A-112F). In one embodiment, the array of light sources may include a linear array of light sources controlled by processor 118. For example, processor 118 may cause the linear array of light sources to sequentially project collimated laser beams towards first optional optical window 124A. First optional optical window 124A may include a diffuser lens for spreading the projected light and sequentially forming wide horizontal and narrow vertical beams. Optionally, some or all of the at least one light source 112 of system 100 may project light concurrently. For example, processor 118 may cause the array of light sources to simultaneously project light beams from a plurality of non-adjacent light sources 112. In the depicted example, light source 112A, light source 112D, and light source 112F simultaneously project laser beams towards first optional optical window 124A thereby illuminating the field of view with three narrow vertical beams. The light beam from fourth light source 112D may reach an object in the field of view. The light reflected from the object may be captured by second optical window 124B and may be redirected to sensor 116. The configuration depicted in FIG. 2E is considered to be a bi-static configuration because the optical paths of the projected light and the reflected light are substantially different. It is noted that projecting unit 102 may also include a plurality of light sources 112 arranged in non-linear configurations, such as a two dimensional array, in hexagonal tiling, or in any other way.

FIG. 2F illustrates an example of a monostatic configuration of LIDAR system 100 without scanning unit 104. Similar to the example embodiment represented in FIG. 2E, in order to illuminate an entire field of view without deflector 114, projecting unit 102 may include an array of light sources (e.g., 112A-112F). But, in contrast to FIG. 2E, this configuration of LIDAR system 100 may include a single optical window 124 for both the projected light and for the reflected light. Using asymmetrical deflector 216, the reflected light may be redirected to sensor 116. The configuration shown in FIG. 2E is considered to be a monostatic configuration because the optical paths of the projected light and the reflected light are substantially similar to one another. The term “substantially similar” in the context of the optical paths of the projected light and the reflected light means that the overlap between the two optical paths may be more than 80%, more than 85%, more than 90%, or more than 95%.

FIG. 2G illustrates an example of a bi-static configuration of LIDAR system 100. The configuration of LIDAR system 100 in this figure is similar to the configuration shown in FIG. 2A. For example, both configurations include a scanning unit 104 for directing projected light in the outbound direction toward the field of view. But, in contrast to the embodiment of FIG. 2A, in this configuration, scanning unit 104 does not redirect the reflected light in the inbound direction. Instead, the reflected light passes through second optical window 124B and enters sensor 116. The configuration depicted in FIG. 2G is considered to be a bi-static configuration because the optical paths of the projected light and the reflected light are substantially different from one another. The term “substantially different” in the context of the optical paths of the projected light and the reflected light means that the overlap between the two optical paths may be less than 10%, less than 5%, less than 1%, or less than 0.25%.

### The Scanning Unit

FIGS. 3A-3D depict various configurations of scanning unit 104 and its role in LIDAR system 100. Specifically, FIG. 3A is a diagram illustrating scanning unit 104 with a MEMS mirror (e.g., square shaped), FIG. 3B is a diagram illustrating another scanning unit 104 with a MEMS mirror (e.g., round shaped), FIG. 3C is a diagram illustrating scanning unit 104 with an array of reflectors used for monostatic scanning LIDAR system, and FIG. 3D is a diagram illustrating an example LIDAR system 100 that mechanically scans the environment around LIDAR system 100. One skilled in the art will appreciate that the depicted configurations of scanning unit 104 are exemplary only, and may have numerous variations and modifications within the scope of this disclosure.

FIG. 3A illustrates an example scanning unit 104 with a single axis square MEMS mirror 300. In this example MEMS mirror 300 functions as at least one deflector 114. As shown, scanning unit 104 may include one or more actuators 302 (specifically, 302A and 302B). In one embodiment, actuator 302 may be made of semiconductor (e.g., silicon) and includes a piezoelectric layer (e.g., PZT, Lead zirconate titanate, aluminum nitride), which changes its dimension in response to electric signals applied by an actuation controller, a semi conductive layer, and a base layer. In one embodiment, the physical properties of actuator 302 may determine the mechanical stresses that actuator 302 experiences when electrical current passes through it. When the piezoelectric material is activated, it exerts force on actuator 302 and causes it to bend. In one embodiment, the resistivity of one or more actuators 302 may be measured in an active state (Ractive) when mirror 300 is deflected at a certain angular position and compared to the resistivity at a resting state (Rrest). Feedback including Ractive may provide information to determine the actual mirror deflection angle compared to an expected angle, and, if needed, mirror 300 deflection may be corrected. The difference between Rrest and Ractive may be correlated by a mirror drive into an angular deflection value that may serve to close the loop. This embodiment may be used for dynamic tracking of the actual mirror position and may optimize response, amplitude, deflection efficiency, and frequency for both linear mode and resonant mode MEMS mirror schemes. This embodiment is described in greater detail below with reference to FIGS. 32-34.

During scanning, current (represented in the figure as the dashed line) may flow from contact 304A to contact 304B (through actuator 302A, spring 306A, mirror 300, spring 306B, and actuator 302B). Isolation gaps in semiconducting frame 308 such as isolation gap 310 may cause actuator 302A and 302B to be two separate islands connected electrically through springs 306 and frame 308. The current flow, or any associated electrical parameter (voltage, current frequency, capacitance, relative dielectric constant, etc.), may be monitored by an associated position feedback. In case of a mechanical failure—where one of the components is damaged—the current flow through the structure would alter and change from its functional calibrated values. At an extreme situation (for example, when a spring is broken), the current would stop completely due to a circuit break in the electrical chain by means of a faulty element.

FIG. 3B illustrates another example scanning unit 104 with a dual axis round MEMS mirror 300. In this example MEMS mirror 300 functions as at least one deflector 114. In one embodiment, MEMS mirror 300 may have a diameter of between about 1 mm to about 5 mm. As shown, scanning unit 104 may include four actuators 302 (302A, 302B, 302C, and 302D) each may be at a differing length. In the illustrated example, the current (represented in the figure as the dashed line) flows from contact 304A to contact 304D, but in other cases current may flow from contact 304A to contact 304B, from contact 304A to contact 304C, from contact 304B to contact 304C, from contact 304B to contact 304D, or from contact 304C to contact 304D. Consistent with some embodiments, a dual axis MEMS mirror may be configured to deflect light in a horizontal direction and in a vertical direction. For example, the angles of deflection of a dual axis MEMS mirror may be between about 0° to 30° in the vertical direction and between about 0° to 50° in the horizontal direction. One skilled in the art will appreciate that the depicted configuration of mirror 300 may have numerous variations and modifications. In one example, at least of deflector 114 may have a dual axis square-shaped mirror or single axis round-shaped mirror. Examples of round and square mirror are depicted in FIG. 3A and 3B as examples only. Any shape may be employed depending on system specifications. In one embodiment, actuators 302 may be incorporated as an integral part of at least of deflector 114, such that power to move MEMS mirror 300 is applied directly towards it. In addition, MEMS mirror 300 maybe connected to frame 308 by one or more rigid supporting elements. In another embodiment, at least of deflector 114 may include an electrostatic or electromagnetic MEMS mirror.

As described above, a monostatic scanning LIDAR system utilizes at least a portion of the same optical path for emitting projected light 204 and for receiving reflected light 206. The light beam in the outbound path may be collimated and focused into a narrow beam while the reflections in the return path spread into a larger patch of light, due to dispersion. In one embodiment, scanning unit 104 may have a large reflection area in the return path and asymmetrical deflector 216 that redirects the reflections (i.e., reflected light 206) to sensor 116. In one embodiment, scanning unit 104 may include a MEMS mirror with a large reflection area and negligible impact on the field of view and the frame rate performance. Additional details about the asymmetrical deflector 216 are provided below with reference to FIG. 2D.

In some embodiments (e.g., as exemplified in FIG. 3C), scanning unit 104 may include a deflector array (e.g., a reflector array) with small light deflectors (e.g., mirrors). In one embodiment, implementing light deflector 114 as a group of smaller individual light deflectors working in synchronization may allow light deflector 114 to perform at a high scan rate with larger angles of deflection. The deflector array may essentially act as a large light deflector (e.g., a large mirror) in terms of effective area. The deflector array may be operated using a shared steering assembly configuration that allows sensor 116 to collect reflected photons from substantially the same portion of field of view 120 being concurrently illuminated by light source 112. The term “concurrently” means that the two selected functions occur during coincident or overlapping time periods, either where one begins and ends during the duration of the other, or where a later one starts before the completion of the other.

FIG. 3C illustrates an example of scanning unit 104 with a reflector array 312 having small mirrors. In this embodiment, reflector array 312 functions as at least one deflector 114. Reflector array 312 may include a plurality of reflector units 314 configured to pivot (individually or together) and steer light pulses toward field of view 120. For example, reflector array 312 may be a part of an outbound path of light projected from light source 112. Specifically, reflector array 312 may direct projected light 204 towards a portion of field of view 120. Reflector array 312 may also be part of a return path for light reflected from a surface of an object located within an illumined portion of field of view 120. Specifically, reflector array 312 may direct reflected light 206 towards sensor 116 or towards asymmetrical deflector 216. In one example, the area of reflector array 312 may be between about 75 to about 150 mm², where each reflector units 314 may have a width of about 10 micrometers and the supporting structure may be lower than 100 micrometers.

According to some embodiments, reflector array 312 may include one or more sub-groups of steerable deflectors. Each sub-group of electrically steerable deflectors may include one or more deflector units, such as reflector unit 314. For example, each steerable deflector unit 314 may include at least one of a MEMS mirror, a reflective surface assembly, and an electromechanical actuator. In one embodiment, each reflector unit 314 may be individually controlled by an individual processor (not shown), such that it may tilt towards a specific angle along each of one or two separate axes. Alternatively, reflector array 312 may be associated with a common controller (e.g., processor 118) configured to synchronously manage the movement of reflector units 314 such that at least part of them will pivot concurrently and point in approximately the same direction.

In addition, at least one processor 118 may select at least one reflector unit 314 for the outbound path (referred to hereinafter as “TX Mirror”) and a group of reflector units 314 for the return path (referred to hereinafter as “RX Mirror”). Consistent with the present disclosure, increasing the number of TX Mirrors may increase a reflected photons beam spread. Additionally, decreasing the number of RX Mirrors may narrow the reception field and compensate for ambient light conditions (such as clouds, rain, fog, extreme heat, and other environmental conditions) and improve the signal to noise ratio. Also, as indicated above, the emitted light beam is typically narrower than the patch of reflected light, and therefore can be fully deflected by a small portion of the deflection array. Moreover, it is possible to block light reflected from the portion of the deflection array used for transmission (e.g., the TX mirror) from reaching sensor 116, thereby reducing an effect of internal reflections of the LIDAR system 100 on system operation. In addition, at least one processor 118 may pivot one or more reflector units 314 to overcome mechanical impairments and drifts due, for example, to thermal and gain effects. In an example, one or more reflector units 314 may move differently than intended (frequency, rate, speed etc.) and their movement may be compensated for by electrically controlling the deflectors appropriately.

FIG. 3D illustrates an exemplary LIDAR system 100 that mechanically scans the environment of LIDAR system 100. In this example, LIDAR system 100 may include a motor or other mechanisms for rotating housing 200 about the axis of the LIDAR system 100. Alternatively, the motor (or other mechanism) may mechanically rotate a rigid structure of LIDAR system 100 on which one or more light sources 112 and one or more sensors 116 are installed, thereby scanning the environment. As described above, projecting unit 102 may include at least one light source 112 configured to project light emission. The projected light emission may travel along an outbound path towards field of view 120. Specifically, the projected light emission may be reflected by deflector 114A through an exit aperture 314 when projected light 204 travel towards optional optical window 124. The reflected light emission may travel along a return path from object 208 towards sensing unit 106. For example, the reflected light 206 may be reflected by deflector 114B when reflected light 206 travels towards sensing unit 106. A person skilled in the art would appreciate that a LIDAR system with a rotation mechanism for synchronically rotating one or more light sources or one or more sensors, may use this synchronized rotation instead of (or in addition to) steering an internal light deflector.

In embodiments in which the scanning of field of view 120 is mechanical, the projected light emission may be directed to exit aperture 314 that is part of a wall 316 separating projecting unit 102 from other parts of LIDAR system 100. In some examples, wall 316 can be formed from a transparent material (e.g., glass) coated with a reflective material to form deflector 114B. In this example, exit aperture 314 may correspond to the portion of wall 316 that is not coated by the reflective material. Additionally, or alternatively, exit aperture 314 may include a hole or cut-away in the wall 316. Reflected light 206 may be reflected by deflector 114B and directed towards an entrance aperture 318 of sensing unit 106. In some examples, an entrance aperture 318 may include a filtering window configured to allow wavelengths in a certain wavelength range to enter sensing unit 106 and attenuate other wavelengths. The reflections of object 208 from field of view 120 may be reflected by deflector 114B and hit sensor 116. By comparing several properties of reflected light 206 with projected light 204, at least one aspect of object 208 may be determined. For example, by comparing a time when projected light 204 was emitted by light source 112 and a time when sensor 116 received reflected light 206, a distance between object 208 and LIDAR system 100 may be determined. In some examples, other aspects of object 208, such as shape, color, material, etc. may also be determined.

In some examples, the LIDAR system 100 (or part thereof, including at least one light source 112 and at least one sensor 116) may be rotated about at least one axis to determine a three-dimensional map of the surroundings of the LIDAR system 100. For example, the LIDAR system 100 may be rotated about a substantially vertical axis as illustrated by arrow 320 in order to scan field of 120. Although FIG. 3D illustrates that the LIDAR system 100 is rotated clock-wise about the axis as illustrated by the arrow 320, additionally or alternatively, the LIDAR system 100 may be rotated in a counter clockwise direction. In some examples, the LIDAR system 100 may be rotated 360 degrees about the vertical axis. In other examples, the LIDAR system 100 may be rotated back and forth along a sector smaller than 360-degree of the LIDAR system 100. For example, the LIDAR system 100 may be mounted on a platform that wobbles back and forth about the axis without making a complete rotation.

### The Sensing Unit

FIGS. 4A-4E depict various configurations of sensing unit 106 and its role in LIDAR system 100. Specifically, FIG. 4A is a diagram illustrating an example sensing unit 106 with a detector array, FIG. 4B is a diagram illustrating monostatic scanning using a two-dimensional sensor, FIG. 4C is a diagram illustrating an example of a two-dimensional sensor 116. FIG. 4D is a diagram illustrating a lens array associated with sensor 116, and FIG. 4E includes three diagram illustrating the lens structure. One skilled in the art will appreciate that the depicted configurations of sensing unit 106 are exemplary only and may have numerous alternative variations and modifications consistent with the principles of this disclosure.

FIG. 4A illustrates an example of sensing unit 106 with detector array 400. In this example, at least one sensor 116 includes detector array 400. LIDAR system 100 is configured to detect objects (e.g., bicycle 208A and cloud 208B) in field of view 120 located at different distances from LIDAR system 100 (could be meters or more). Objects 208 may be a solid object (e.g., a road, a tree, a car, a person), fluid object (e.g., fog, water, atmosphere particles), or object of another type (e.g., dust or a powdery illuminated object). When the photons emitted from light source 112 hit object 208 they either reflect, refract, or get absorbed. Typically, as shown in the figure, only a portion of the photons reflected from object 208A enters optional optical window 124. As each ˜15 cm change in distance results in a travel time difference of 1 ns (since the photons travel at the speed of light to and from object 208), the time differences between the travel times of different photons hitting the different objects may be detectable by a time-of-flight sensor with sufficiently quick response.

Sensor 116 includes a plurality of detection elements 402 for detecting photons of a photonic pulse reflected back from field of view 120. The detection elements may all be included in detector array 400, which may have a rectangular arrangement (e.g., as shown) or any other arrangement. Detection elements 402 may operate concurrently or partially concurrently with each other. Specifically, each detection element 402 may issue detection information for every sampling duration (e.g., every 1 nanosecond). In one example, detector array 400 may be a SiPM (Silicon photomultipliers) which is a solid-state single-photon-sensitive device built from an array of single photon avalanche diode (, SPAD, serving as detection elements 402) on a common silicon substrate. Similar photomultipliers from other, non-silicon materials may also be used. Although a SiPM device works in digital/switching mode, the SiPM is an analog device because all the microcells are read in parallel, making it possible to generate signals within a dynamic range from a single photon to hundreds and thousands of photons detected by the different SPADs. As mentioned above, more than one type of sensor may be implemented (e.g., SiPM and APD). Possibly, sensing unit 106 may include at least one APD integrated into an SiPM array and/or at least one APD detector located next to a SiPM on a separate or common silicon substrate.

In one embodiment, detection elements 402 may be grouped into a plurality of regions 404. The regions are geometrical locations or environments within sensor 116 (e.g., within detector array 400)—may be shaped in different shapes (e.g., rectangular as shown, squares, rings, and so on, or in any other shape). While not all of the individual detectors, which are included within the geometrical area of a region 404, necessarily belong to that region, in most cases they will not belong to other regions 404 covering other areas of the sensor 310—unless some overlap is desired in the seams between regions. As illustrated in FIG. 4A, the regions may be non-overlapping regions 404, but alternatively, they may overlap. Every region may be associated with a regional output circuitry 406 associated with that region. The regional output circuitry 406 may provide a region output signal of a corresponding group of detection elements 402. For example, the region of output circuitry 406 may be a summing circuit, but other forms of combined output of the individual detector into a unitary output (whether scalar, vector, or any other format) may be employed. Optionally, each region 404 is a single SiPM, but this is not necessarily so, and a region may be a sub-portion of a single SiPM, a group of several SiPMs, or even a combination of different types of detectors.

In the illustrated example, processing unit 108 is located at a separated housing 200B (within or outside) host 210 (e.g., within vehicle 110), and sensing unit 106 may include a dedicated processor 408 for analyzing the reflected light. Alternatively, processing unit 108 may be used for analyzing reflected light 206. It is noted that LIDAR system 100 may be implemented multiple housings in other ways than the illustrated example. For example, light deflector 114 may be located in a different housing than projecting unit 102 and/or sensing module 106. In one embodiment, LIDAR system 100 may include multiple housings connected to each other in different ways, such as: electric wire connection, wireless connection (e.g., RF connection), fiber optics cable, and any combination of the above.

In one embodiment, analyzing reflected light 206 may include determining a time of flight for reflected light 206, based on outputs of individual detectors of different regions. Optionally, processor 408 may be configured to determine the time of flight for reflected light 206 based on the plurality of regions of output signals. In addition to the time of flight, processing unit 108 may analyze reflected light 206 to determine the average power across an entire return pulse, and the photon distribution/signal may be determined over the return pulse period (“pulse shape”). In the illustrated example, the outputs of any detection elements 402 may not be transmitted directly to processor 408, but rather combined (e.g., summed) with signals of other detectors of the region 404 before being passed to processor 408. However, this is only an example and the circuitry of sensor 116 may transmit information from a detection element 402 to processor 408 via other routes (not via a region output circuitry 406).

FIG. 4B is a diagram illustrating LIDAR system 100 configured to scan the environment of LIDAR system 100 using a two-dimensional sensor 116. In the example of FIG. 4B, sensor 116 is a matrix of 4×6 detectors 410 (also referred to as “pixels”). In one embodiment, a pixel size may be about 1×1 mm. Sensor 116 is two-dimensional in the sense that it has more than one set (e.g., row, column) of detectors 410 in two non-parallel axes (e.g., orthogonal axes, as exemplified in the illustrated examples). The number of detectors 410 in sensor 116 may vary between differing implementations, e.g., depending on the desired resolution, signal to noise ratio (SNR), desired detection distance, and so on. For example, sensor 116 may have anywhere between 5 and 5,000 pixels. In another example (not shown in the figure) Also, sensor 116 may be a one-dimensional matrix (e.g., 1×8 pixels).

It is noted that each detector 410 may include a plurality of detection elements 402, such as Avalanche Photo Diodes (APD), Single Photon Avalanche Diodes (SPADs), combination of Avalanche Photo Diodes (APD) and Single Photon Avalanche Diodes (SPADs) or detecting elements that measure both the time of flight from a laser pulse transmission event to the reception event and the intensity of the received photons. For example, each detector 410 may include anywhere between 20 and 5,000 SPADs. The outputs of detection elements 402 in each detector 410 may be summed, averaged, or otherwise combined to provide a unified pixel output.

In the illustrated example, sensing unit 106 may include a two-dimensional sensor 116 (or a plurality of two-dimensional sensors 116), whose field of view is smaller than field of view 120 of LIDAR system 100. In this discussion, field of view 120 (the overall field of view which can be scanned by LIDAR system 100 without moving, rotating or rolling in any direction) is denoted “first FOV 412”, and the smaller FOV of sensor 116 is denoted “second FOV 412” (interchangeably “instantaneous FOV”). The coverage area of second FOV 414 relative to the first FOV 412 may differ, depending on the specific use of LIDAR system 100, and may be, for example, between 0.5% and 50%. In one example, second FOV 412 may be between about 0.05° and 1° elongated in the vertical dimension. Even if LIDAR system 100 includes more than one two-dimensional sensor 116, the combined field of view of the sensors array may still be smaller than the first FOV 412, e.g., by a factor of at least 5, by a factor of at least 10, by a factor of at least 20, or by a factor of at least 50, for example.

In order to cover first FOV 412, scanning unit 106 may direct photons arriving from different parts of the environment to sensor 116 at different times. In the illustrated monostatic configuration, together with directing projected light 204 towards field of view 120 and when least one light deflector 114 is located in an instantaneous position, scanning unit 106 may also direct reflected light 206 to sensor 116. Typically, at every moment during the scanning of first FOV 412, the light beam emitted by LIDAR system 100 covers part of the environment which is larger than the second FOV 414 (in angular opening) and includes the part of the environment from which light is collected by scanning unit 104 and sensor 116.

FIG. 4C is a diagram illustrating an example of a two-dimensional sensor 116. In this embodiment, sensor 116 is a matrix of 8×5 detectors 410 and each detector 410 includes a plurality of detection elements 402. In one example, detector 410A is located in the second row (denoted “R2”) and third column (denoted “C3”) of sensor 116, which includes a matrix of 4×3 detection elements 402. In another example, detector 410B located in the fourth row (denoted “R4”) and sixth column (denoted “C6”) of sensor 116 includes a matrix of 3×3 detection elements 402. Accordingly, the number of detection elements 402 in each detector 410 may be constant, or may vary, and differing detectors 410 in a common array may have a different number of detection elements 402. The outputs of all detection elements 402 in each detector 410 may be summed, averaged, or otherwise combined to provide a single pixel-output value. It is noted that while detectors 410 in the example of FIG. 4C are arranged in a rectangular matrix (straight rows and straight columns), other arrangements may also be used, e.g., a circular arrangement or a honeycomb arrangement.

According to some embodiments, measurements from each detector 410 may enable determination of the time of flight from a light pulse emission event to the reception event and the intensity of the received photons. The reception event may be the result of the light pulse being reflected from object 208. The time of flight may be a timestamp value that represents the distance of the reflecting object to optional optical window 124. Time of flight values may be realized by photon detection and counting methods, such as Time Correlated Single Photon Counters (TCSPC), analog methods for photon detection such as signal integration and qualification (via analog to digital converters or plain comparators) or otherwise.

In some embodiments and with reference to FIG. 4B, during a scanning cycle, each instantaneous position of at least one light deflector 114 may be associated with a particular portion 122 of field of view 120. The design of sensor 116 enables an association between the reflected light from a single portion of field of view 120 and multiple detectors 410. Therefore, the scanning resolution of LIDAR system may be represented by the number of instantaneous positions (per scanning cycle) times the number of detectors 410 in sensor 116. The information from each detector 410 (i.e., each pixel) represents the basic data element that from which the captured field of view in the three-dimensional space is built. This may include, for example, the basic element of a point cloud representation, with a spatial position and an associated reflected intensity value. In one embodiment, the reflections from a single portion of field of view 120 that are detected by multiple detectors 410 may be returning from different objects located in the single portion of field of view 120. For example, the single portion of field of view 120 may be greater than 50×50 cm at the far field, which can easily include two, three, or more objects partly covered by each other.

FIG. 4D is a cross cut diagram of a part of sensor 116, in accordance with examples of the presently disclosed subject matter. The illustrated part of sensor 116 includes a part of a detector array 400 which includes four detection elements 402 (e.g., four SPADs, four APDs). Detector array 400 may be a photodetector sensor realized in complementary metal-oxide-semiconductor (CMOS). Each of the detection elements 402 has a sensitive area, which is positioned within a substrate surrounding. While not necessarily so, sensor 116 may be used in a monostatic LiDAR system having a narrow field of view (e.g., because scanning unit 104 scans different parts of the field of view at different times). The narrow field of view for the incoming light beam—if implemented—eliminates the problem of out-of-focus imaging. As exemplified in FIG. 4D, sensor 116 may include a plurality of lenses 422 (e.g., microlenses), each lens 422 may direct incident light toward a different detection element 402 (e.g., toward an active area of detection element 402), which may be usable when out-of-focus imaging is not an issue. Lenses 422 may be used for increasing an optical fill factor and sensitivity of detector array 400, because most of the light that reaches sensor 116 may be deflected toward the active areas of detection elements 402

Detector array 400, as exemplified in FIG. 4D, may include several layers built into the silicon substrate by various methods (e.g., implant) resulting in a sensitive area, contact elements to the metal layers and isolation elements (e.g., shallow trench implant STI, guard rings, optical trenches, etc.). The sensitive area may be a volumetric element in the CMOS detector that enables the optical conversion of incoming photons into a current flow given an adequate voltage bias is applied to the device. In the case of a APD/SPAD, the sensitive area would be a combination of an electrical field that pulls electrons created by photon absorption towards a multiplication area where a photon induced electron is amplified creating a breakdown avalanche of multiplied electrons.

A front side illuminated detector (e.g., as illustrated in FIG. 4D) has the input optical port at the same side as the metal layers residing on top of the semiconductor (Silicon). The metal layers are required to realize the electrical connections of each individual photodetector element (e.g., anode and cathode) with various elements such as: bias voltage, quenching/ballast elements, and other photodetectors in a common array. The optical port through which the photons impinge upon the detector sensitive area is comprised of a passage through the metal layer. It is noted that passage of light from some directions through this passage may be blocked by one or more metal layers (e.g., metal layer ML6, as illustrated for the leftmost detector elements 402 in FIG. 4D). Such blockage reduces the total optical light absorbing efficiency of the detector.

FIG. 4E illustrates three detection elements 402, each with an associated lens 422, in accordance with examples of the presenting disclosed subject matter. Each of the three detection elements of FIG. 4E, denoted 402(1), 40(2), and 402(3), illustrates a lens configuration which may be implemented in associated with one or more of the detecting elements 402 of sensor 116. It is noted that combinations of these lens configurations may also be implemented.

In the lens configuration illustrated with regards to detection element 402(1), a focal point of the associated lens 422 may be located above the semiconductor surface. Optionally, openings in different metal layers of the detection element may have different sizes aligned with the cone of focusing light generated by the associated lens 422. Such a structure may improve the signal-to-noise and resolution of the array 400 as a whole device. Large metal layers may be important for delivery of power and ground shielding. This approach may be useful, e.g., with a monostatic LiDAR design with a narrow field of view where the incoming light beam is comprised of parallel rays and the imaging focus does not have any consequence to the detected signal.

In the lens configuration illustrated with regards to detection element 402(2), an efficiency of photon detection by the detection elements 402 may be improved by identifying a sweet spot. Specifically, a photodetector implemented in CMOS may have a sweet spot in the sensitive volume area where the probability of a photon creating an avalanche effect is the highest. Therefore, a focal point of lens 422 may be positioned inside the sensitive volume area at the sweet spot location, as demonstrated by detection elements 402(2). The lens shape and distance from the focal point may take into account the refractive indices of all the elements the laser beam is passing along the way from the lens to the sensitive sweet spot location buried in the semiconductor material.

In the lens configuration illustrated with regards to the detection element on the right of FIG. 4E, an efficiency of photon absorption in the semiconductor material may be improved using a diffuser and reflective elements. Specifically, a near IR wavelength requires a significantly long path of silicon material in order to achieve a high probability of absorbing a photon that travels through. In a typical lens configuration, a photon may traverse the sensitive area and may not be absorbed into a detectable electron. A long absorption path that improves the probability for a photon to create an electron renders the size of the sensitive area towards less practical dimensions (tens of um for example) for a CMOS device fabricated with typical foundry processes. The rightmost detector element in FIG. 4E demonstrates a technique for processing incoming photons. The associated lens 422 focuses the incoming light onto a diffuser element 424. In one embodiment, light sensor 116 may further include a diffuser located in the gap distant from the outer surface of at least some of the detectors. For example, diffuser 424 may steer the light beam sideways (e.g., as perpendicular as possible) towards the sensitive area and the reflective optical trenches 426. The diffuser is located at the focal point, above the focal point, or below the focal point. In this embodiment, the incoming light may be focused on a specific location where a diffuser element is located. Optionally, detector element 422 is designed to optically avoid the inactive areas where a photon induced electron may get lost and reduce the effective detection efficiency. Reflective optical trenches 426 (or other forms of optically reflective structures) cause the photons to bounce back and forth across the sensitive area, thus increasing the likelihood of detection. Ideally, the photons will get trapped in a cavity consisting of the sensitive area and the reflective trenches indefinitely until the photon is absorbed and creates an electron/hole pair.

Consistent with the present disclosure, a long path is created for the impinging photons to be absorbed and contribute to a higher probability of detection. Optical trenches may also be implemented in detecting element 422 for reducing cross talk effects of parasitic photons created during an avalanche that may leak to other detectors and cause false detection events. According to some embodiments, a photo detector array may be optimized so that a higher yield of the received signal is utilized, meaning, that as much of the received signal is received and less of the signal is lost to internal degradation of the signal. The photo detector array may be improved by: (a) moving the focal point at a location above the semiconductor surface, optionally by designing the metal layers above the substrate appropriately; (b) by steering the focal point to the most responsive/sensitive area (or “sweet spot”) of the substrate and (c) adding a diffuser above the substrate to steer the signal toward the “sweet spot” and/or adding reflective material to the trenches so that deflected signals are reflected back to the “sweet spot.”

While in some lens configurations, lens 422 may be positioned so that its focal point is above a center of the corresponding detection element 402, it is noted that this is not necessarily so. In other lens configuration, a position of the focal point of the lens 422 with respect to a center of the corresponding detection element 402 is shifted based on a distance of the respective detection element 402 from a center of the detection array 400. This may be useful in relatively larger detection arrays 400, in which detector elements further from the center receive light in angles which are increasingly off-axis. Shifting the location of the focal points (e.g., toward the center of detection array 400) allows correcting for the incidence angles. Specifically, shifting the location of the focal points (e.g., toward the center of detection array 400) allows correcting for the incidence angles while using substantially identical lenses 422 for all detection elements, which are positioned at the same angle with respect to a surface of the detector.

Adding an array of lenses 422 to an array of detection elements 402 may be useful when using a relatively small sensor 116 which covers only a small part of the field of view because in such a case, the reflection signals from the scene reach the detectors array 400 from substantially the same angle, and it is, therefore, easy to focus all the light onto individual detectors. It is also noted, that in one embodiment, lenses 422 may be used in LIDAR system 100 for favoring about increasing the overall probability of detection of the entire array 400 (preventing photons from being “wasted” in the dead area between detectors/sub-detectors) at the expense of spatial distinctiveness. This embodiment is in contrast to prior art implementations such as CMOS RGB camera, which prioritize spatial distinctiveness (i.e., light that propagates in the direction of detection element A is not allowed to be directed by the lens toward detection element B, that is, to “bleed” to another detection element of the array). Optionally, sensor 116 includes an array of lens 422, each being correlated to a corresponding detection element 402, while at least one of the lenses 422 deflects light which propagates to a first detection element 402 toward a second detection element 402 (thereby it may increase the overall probability of detection of the entire array).

Specifically, consistent with some embodiments of the present disclosure, light sensor 116 may include an array of light detectors (e.g., detector array 400), each light detector (e.g., detector 410) being configured to cause an electric current to flow when light passes through an outer surface of a respective detector. In addition, light sensor 116 may include at least one micro-lens configured to direct light toward the array of light detectors, the at least one micro-lens having a focal point. Light sensor 116 may further include at least one layer of conductive material interposed between the at least one micro-lens and the array of light detectors and having a gap therein to permit light to pass from the at least one micro-lens to the array, the at least one layer being sized to maintain a space between the at least one micro-lens and the array to cause the focal point (e.g., the focal point may be a plane) to be located in the gap, at a location spaced from the detecting surfaces of the array of light detectors.

In related embodiments, each detector may include a plurality of Single Photon Avalanche Diodes (SPADs) or a plurality of Avalanche Photo Diodes (APD). The conductive material may be a multi-layer metal constriction, and the at least one layer of conductive material may be electrically connected to detectors in the array. In one example, the at least one layer of conductive material includes a plurality of layers. In addition, the gap may be shaped to converge from the at least one micro-lens toward the focal point, and to diverge from a region of the focal point toward the array. In other embodiments, light sensor 116 may further include at least one reflector adjacent each photo detector. In one embodiment, a plurality of micro-lenses may be arranged in a lens array and the plurality of detectors may be arranged in a detector array. In another embodiment, the plurality of micro-lenses may include a single lens configured to project light to a plurality of detectors in the array.

Referring by way of a nonlimiting example to FIGS. 2E, 2F and 2G, it is noted that the one or more sensors 116 of system 100 may receive light from a scanning deflector 114 or directly from the FOV without scanning. Even if light from the entire FOV arrives to the at least one sensor 116 at the same time, in some implementations the one or more sensors 116 may sample only parts of the FOV for detection output at any given time. For example, if the illumination of projection unit 102 illuminates different parts of the FOV at different times (whether using a deflector 114 and/or by activating different light sources 112 at different times), light may arrive at all of the pixels or sensors 116 of sensing unit 106, and only pixels/sensors which are expected to detect the LIDAR illumination may be actively collecting data for detection outputs. This way, the rest of the pixels/sensors do not unnecessarily collect ambient noise. Referring to the scanning—in the outbound or in the inbound directions—it is noted that substantially different scales of scanning may be implemented. For example, in some implementations the scanned area may cover 1% or 0.1% of the FOV, while in other implementations the scanned area may cover 10% or 25% of the FOV. All other relative portions of the FOV values may also be implemented, of course.

### The Processing Unit

FIGS. 5A-5C depict different functionalities of processing units 108 in accordance with some embodiments of the present disclosure. Specifically, FIG. 5A is a diagram illustrating emission patterns in a single frame-time for a single portion of the field of view, FIG. 5B is a diagram illustrating emission scheme in a single frame-time for the whole field of view, and, FIG. 5C is a diagram illustrating the actual light emission projected towards field of view during a single scanning cycle.

FIG. 5A illustrates four examples of emission patterns in a single frame-time for a single portion 122 of field of view 120 associated with an instantaneous position of at least one light deflector 114. Consistent with embodiments of the present disclosure, processing unit 108 may control at least one light source 112 and light deflector 114 (or coordinate the operation of at least one light source 112 and at least one light deflector 114) in a manner enabling light flux to vary over a scan of field of view 120. Consistent with other embodiments, processing unit 108 may control only at least one light source 112 and light deflector 114 may be moved or pivoted in a fixed predefined pattern.

Diagrams A-D in FIG. 5A depict the power of light emitted towards a single portion 122 of field of view 120 over time. In Diagram A, processor 118 may control the operation of light source 112 in a manner such that during scanning of field of view 120 an initial light emission is projected toward portion 122 of field of view 120. When projecting unit 102 includes a pulsed-light light source, the initial light emission may include one or more initial pulses (also referred to as “pilot pulses”). Processing unit 108 may receive from sensor 116 pilot information about reflections associated with the_initial light emission. In one embodiment, the pilot information may be represented as a single signal based on the outputs of one or more detectors (e.g., one or more SPADs, one or more APDs, one or more SiPMs, etc.) or as a plurality of signals based on the outputs of multiple detectors. In one example, the pilot information may include analog and/or digital information. In another example, the pilot information may include a single value and/or a plurality of values (e.g., for different times and/or parts of the segment).

Based on information about reflections associated with the initial light emission, processing unit 108 may be configured to determine the type of subsequent light emission to be projected towards portion 122 of field of view 120. The determined subsequent light emission for the particular portion of field of view 120 may be made during the same scanning cycle (i.e., in the same frame) or in a subsequent scanning cycle (i.e., in a subsequent frame). This embodiment is described in greater detail below with reference to FIGS. 23-25.

In Diagram B, processor 118 may control the operation of light source 112 in a manner such that during scanning of field of view 120 light pulses in different intensities are projected towards a single portion 122 of field of view 120. In one embodiment, LIDAR system 100 may be operable to generate depth maps of one or more different types, such as any one or more of the following types: point cloud model, polygon mesh, depth image (holding depth information for each pixel of an image or of a 2D array), or any other type of 3D model of a scene. The sequence of depth maps may be a temporal sequence, in which different depth maps are generated at a different time. Each depth map of the sequence associated with a scanning cycle (interchangeably “frame”) may be generated within the duration of a corresponding subsequent frame-time. In one example, a typical frame-time may last less than a second. In some embodiments, LIDAR system 100 may have a fixed frame rate (e.g., 10 frames per second, 25 frames per second, 50 frames per second) or the frame rate may be dynamic. In other embodiments, the frame-times of different frames may not be identical across the sequence. For example, LIDAR system 100 may implement a 10 frames-per-second rate that includes generating a first depth map in 100 milliseconds (the average), a second frame in 92 milliseconds, a third frame at 142 milliseconds, and so on.

In Diagram C, processor 118 may control the operation of light source 112 in a manner such that during scanning of field of view 120 light pulses associated with different durations are projected towards a single portion 122 of field of view 120. In one embodiment, LIDAR system 100 may be operable to generate a different number of pulses in each frame. The number of pulses may vary between 0 to 32 pulses (e.g., 1, 5, 12, 28, or more pulses) and may be based on information derived from previous emissions. The time between light pulses may depend on desired detection range and can be between 500 ns and 5000 ns. In one example, processing unit 108 may receive from sensor 116 information about reflections associated with each light-pulse. Based on the information (or the lack of information), processing unit 108 may determine if additional light pulses are needed. It is noted that the durations of the processing times and the emission times in diagrams A-D are not in-scale. Specifically, the processing time may be substantially longer than the emission time. In diagram D, projecting unit 102 may include a continuous-wave light source. In one embodiment, the initial light emission may include a period of time where light is emitted and the subsequent emission may be a continuation of the initial emission, or there may be a discontinuity. In one embodiment, the intensity of the continuous emission may change over time.

Consistent with some embodiments of the present disclosure, the emission pattern may be determined per each portion of field of view 120. In other words, processor 118 may control the emission of light to allow differentiation in the illumination of different portions of field of view 120. In one example, processor 118 may determine the emission pattern for a single portion 122 of field of view 120, based on detection of reflected light from the same scanning cycle (e.g., the initial emission), which makes LIDAR system 100 extremely dynamic. In another example, processor 118 may determine the emission pattern for a single portion 122 of field of view 120, based on detection of reflected light from a previous scanning cycle. The differences in the patterns of the subsequent emissions may result from determining different values for light-source parameters for the subsequent emission, such as any one of the following.
a. Overall energy of the subsequent emission.
b. Energy profile of the subsequent emission.
c. A number of light-pulse-repetition per frame.
d. Light modulation characteristics such as duration, rate, peak, average power, and pulse shape.
e. Wave properties of the subsequent emission, such as polarization, wavelength, etc.

Consistent with the present disclosure, the differentiation in the subsequent emissions may be put to different uses. In one example, it is possible to limit emitted power levels in one portion of field of view 120 where safety is a consideration, while emitting higher power levels (thus improving signal-to-noise ratio and detection range) for other portions of field of view 120. This is relevant for eye safety, but may also be relevant for skin safety, safety of optical systems, safety of sensitive materials, and more. In another example, it is possible to direct more energy towards portions of field of view 120 where it will be of greater use (e.g., regions of interest, further distanced targets, low reflection targets, etc.) while limiting the lighting energy to other portions of field of view 120 based on detection results from the same frame or previous frame. It is noted that processing unit 108 may process detected signals from a single instantaneous field of view several times within a single scanning frame time; for example, subsequent emission may be determined upon after every pulse emitted, or after a number of pulses emitted.

FIG. 5B illustrates three examples of emission schemes in a single frame-time for field of view 120. Consistent with embodiments of the present disclosure, at least on processing unit 108 may use obtained information to dynamically adjust the operational mode of LIDAR system 100 and/or determine values of parameters of specific components of LIDAR system 100. The obtained information may be determined from processing data captured in field of view 120, or received (directly or indirectly) from host 210. Processing unit 108 may use the obtained information to determine a scanning scheme for scanning the different portions of field of view 120. The obtained information may include a current light condition, a current weather condition, a current driving environment of the host vehicle, a current location of the host vehicle, a current trajectory of the host vehicle, a current topography of road surrounding the host vehicle, or any other condition or object detectable through light reflection. In some embodiments, the determined scanning scheme may include at least one of the following: (a) a designation of portions within field of view 120 to be actively scanned as part of a scanning cycle, (b) a projecting plan for projecting unit 102 that defines the light emission profile at different portions of field of view 120; (c) a deflecting plan for scanning unit 104 that defines, for example, a deflection direction, frequency, and designating idle elements within a reflector array; and (d) a detection plan for sensing unit 106 that defines the detectors sensitivity or responsivity pattern.

In addition, processing unit 108 may determine the scanning scheme at least partially by obtaining an identification of at least one region of interest within the field of view 120 and at least one region of non-interest within the field of view 120. In some embodiments, processing unit 108 may determine the scanning scheme at least partially by obtaining an identification of at least one region of high interest within the field of view 120 and at least one region of lower-interest within the field of view 120. The identification of the at least one region of interest within the field of view 120 may be determined, for example, from processing data captured in field of view 120, based on data of another sensor (e.g., camera, GPS), received (directly or indirectly) from host 210, or any combination of the above. In some embodiments, the identification of at least one region of interest may include identification of portions, areas, sections, pixels, or objects within field of view 120 that are important to monitor. Examples of areas that may be identified as regions of interest may include, crosswalks, moving objects, people, nearby vehicles or any other environmental condition or object that may be helpful in vehicle navigation. Examples of areas that may be identified as regions of non-interest (or lower-interest) may be static (non-moving) far-away buildings, a skyline, an area above the horizon and objects in the field of view. Upon obtaining the identification of at least one region of interest within the field of view 120, processing unit 108 may determine the scanning scheme or change an existing scanning scheme. Further to determining or changing the light-source parameters (as described above), processing unit 108 may allocate detector resources based on the identification of the at least one region of interest. In one example, to reduce noise, processing unit 108 may activate detectors 410 where a region of interest is expected and disable detectors 410 where regions of non-interest are expected. In another example, processing unit 108 may change the detector sensitivity, e.g., increasing sensor sensitivity for long range detection where the reflected power is low.

Diagrams A-C in FIG. 5B depict examples of different scanning schemes for scanning field of view 120. Each square in field of view 120 represents a different portion 122 associated with an instantaneous position of at least one light deflector 114. Legend 500 details the level of light flux represented by the filling pattern of the squares. Diagram A depicts a first scanning scheme in which all of the portions have the same importance/priority and a default light flux is allocated to them. The first scanning scheme may be utilized in a start-up phase or periodically interleaved with another scanning scheme to monitor the whole field of view for unexpected/new objects. In one example, the light source parameters in the first scanning scheme may be configured to generate light pulses at constant amplitudes. Diagram B depicts a second scanning scheme in which a portion of field of view 120 is allocated with high light flux while the rest of field of view 120 is allocated with default light flux and low light flux. The portions of field of view 120 that are the least interesting may be allocated with low light flux. Diagram C depicts a third scanning scheme in which a compact vehicle and a bus (see silhouettes) are identified in field of view 120. In this scanning scheme, the edges of the vehicle and bus may be tracked with high power and the central mass of the vehicle and bus may be allocated with less light flux (or no light flux). Such light flux allocation enables concentration of more of the optical budget on the edges of the identified objects and less on their center which have less importance.

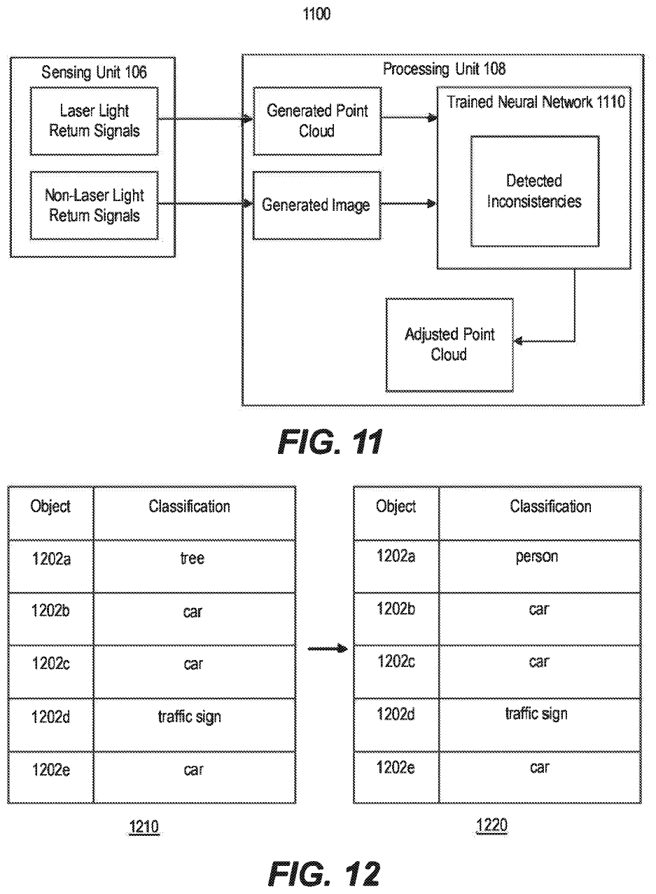

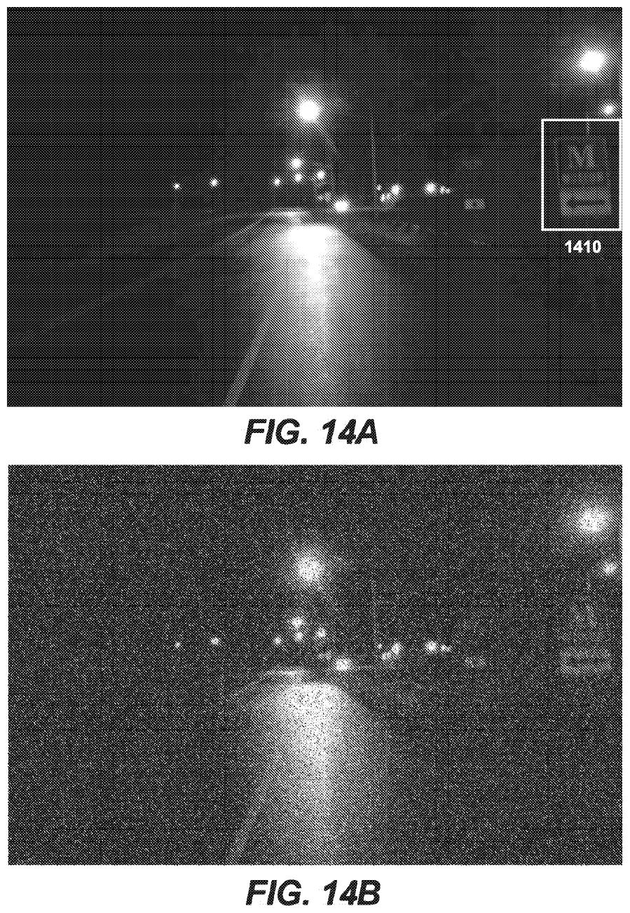

FIG. 5C illustrating the emission of light towards field of view 120 during a single scanning cycle. In the depicted example, field of view 120 is represented by an 8×9 matrix, where each of the 72 cells corresponds to a separate portion 122 associated with a different instantaneous position of at least one light deflector 114. In this exemplary scanning cycle, each portion includes one or more white dots that represent the number of light pulses projected toward that portion, and some portions include black dots that represent reflected light from that portion detected by sensor 116. As shown, field of view 120 is divided into three sectors: sector I on the right side of field of view 120, sector II in the middle of field of view 120, and sector III on the left side of field of view 120. In this exemplary scanning cycle, sector I was initially allocated with a single light pulse per portion; sector II, previously identified as a region of interest, was initially allocated with three light pulses per portion; and sector III was initially allocated with two light pulses per portion. Also as shown, scanning of field of view 120 reveals four objects 208: two free-form objects in the near field (e.g., between 5 and 50 meters), a rounded-square object in the mid field (e.g., between 50 and 150 meters), and a triangle object in the far field (e.g., between 150 and 500 meters). While the discussion of FIG. 5C uses number of pulses as an example of light flux allocation, it is noted that light flux allocation to different parts of the field of view may also be implemented in other ways such as: pulse duration, pulse angular dispersion, wavelength, instantaneous power, photon density at different distances from light source 112, average power, pulse power intensity, pulse width, pulse repetition rate, pulse sequence, pulse duty cycle, wavelength, phase, polarization, and more. The illustration of the light emission as a single scanning cycle in FIG. 5C demonstrates different capabilities of LIDAR system 100. In a first embodiment, processor 118 is configured to use two light pulses to detect a first object (e.g., the rounded-square object) at a first distance, and to use three light pulses to detect a second object (e.g., the triangle object) at a second distance greater than the first distance. This embodiment is described in greater detail below with reference to FIGS. 11-13. In a second embodiment, processor 118 is configured to allocate more light to portions of the field of view where a region of interest is identified. Specifically, in the present example, sector II was identified as a region of interest and accordingly it was allocated with three light pulses while the rest of field of view 120 was allocated with two or less light pulses. This embodiment is described in greater detail below with reference to FIGS. 20-22. In a third embodiment, processor 118 is configured to control light source 112 in a manner such that only a single light pulse is projected toward to portions B1, B2, and C1 in FIG. 5C, although they are part of sector III that was initially allocated with two light pulses per portion. This occurs because the processing unit 108 detected an object in the near field based on the first light pulse. This embodiment is described in greater detail below with reference to FIGS. 23-25. Allocation of less than maximal amount of pulses may also be a result of other considerations. For examples, in at least some regions, detection of object at a first distance (e.g., a near field object) may result in reducing an overall amount of light emitted to this portion of field of view 120. This embodiment is described in greater detail below with reference to FIGS. 14-16. Other reasons to for determining power allocation to different portions is discussed below with respect to FIGS. 29-31, FIGS. 53-55, and FIGS. 50-52.

Additional details and examples on different components of LIDAR system 100 and their associated functionalities are included in Applicant's U.S. patent application Ser. No. 15/391,916 filed Dec. 28, 2016; Applicant's U.S. patent application Ser. No. 15/393,749 filed Dec. 29, 2016; Applicant's U.S. patent application Ser. No. 15/393,285 filed Dec. 29, 2016; and Applicant's U.S. patent application Ser. No. 15/393,593 filed Dec. 29, 2016, which are incorporated herein by reference in their entirety.

### Example Implementation: Vehicle

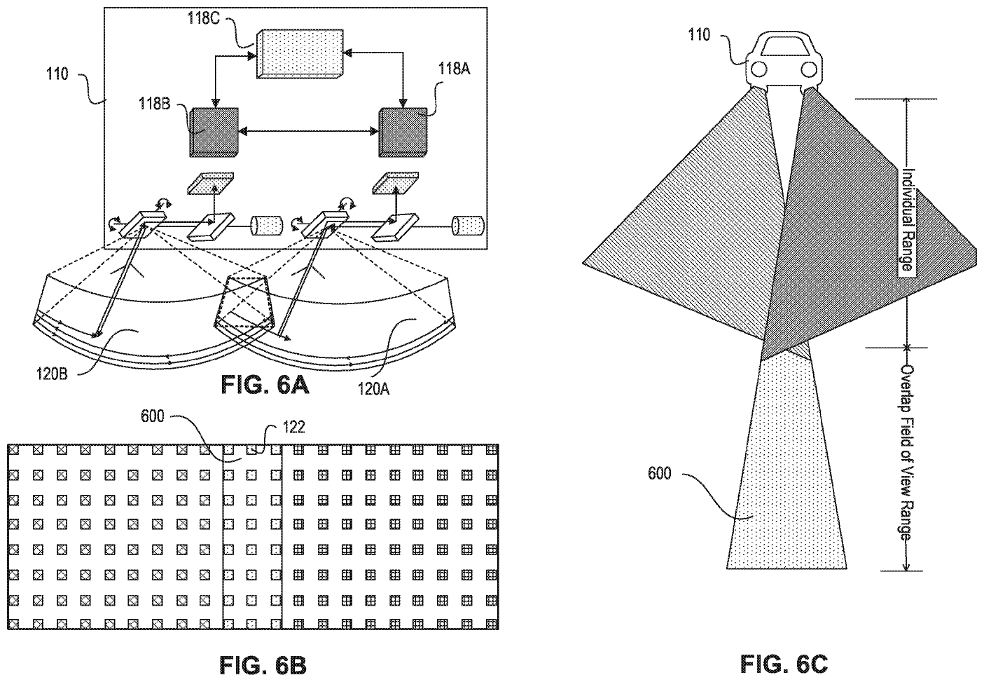

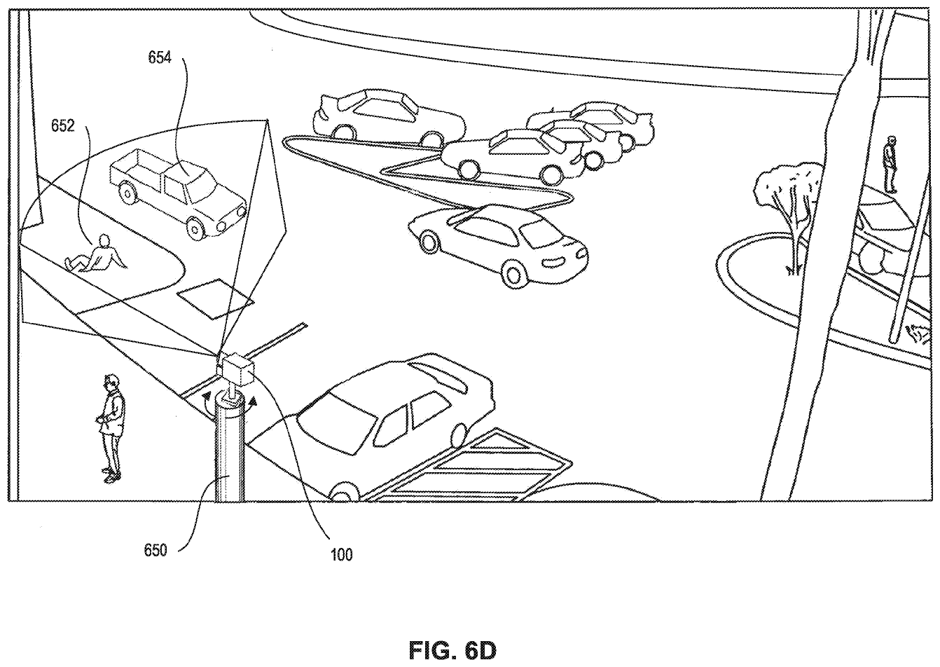

FIGS. 6A-6C illustrate the implementation of LIDAR system 100 in a vehicle (e.g., vehicle 110). Any of the aspects of LIDAR system 100 described above or below may be incorporated into vehicle 110 to provide a range-sensing vehicle. Specifically, in this example, LIDAR system 100 integrates multiple scanning units 104 and potentially multiple projecting units 102 in a single vehicle. In one embodiment, a vehicle may take advantage of such a LIDAR system to improve power, range and accuracy in the overlap zone and beyond it, as well as redundancy in sensitive parts of the FOV (e.g., the forward movement direction of the vehicle). As shown in FIG. 6A, vehicle 110 may include a first processor 118A for controlling the scanning of field of view 120A, a second processor 118B for controlling the scanning of field of view 120B, and a third processor 118C for controlling synchronization of scanning the two fields of view. In one example, processor 118C may be the vehicle controller and may have a shared interface between first processor 118A and second processor 118B. The shared interface may enable an exchanging of data at intermediate processing levels and a synchronization of scanning of the combined field of view in order to form an overlap in the temporal and/or spatial space. In one embodiment, the data exchanged using the shared interface may be: (a) time of flight of received signals associated with pixels in the overlapped field of view and/or in its vicinity; (b) laser steering position status; (c) detection status of objects in the field of view.

FIG. 6B illustrates overlap region 600 between field of view 120A and field of view 120B. In the depicted example, the overlap region is associated with 24 portions 122 from field of view 120A and 24 portions 122 from field of view 120B. Given that the overlap region is defined and known by processors 118A and 118B, each processor may be designed to limit the amount of light emitted in overlap region 600 in order to conform with an eye safety limit that spans multiple source lights, or for other reasons such as maintaining an optical budget. In addition, processors 118A and 118B may avoid interferences between the light emitted by the two light sources by loose synchronization between the scanning unit 104A and scanning unit 104B, and/or by control of the laser transmission timing, and/or the detection circuit enabling timing.

FIG. 6C illustrates how overlap region 600 between field of view 120A and field of view 120B may be used to increase the detection distance of vehicle 110. Consistent with the present disclosure, two or more light sources 112 projecting their nominal light emission into the overlap zone may be leveraged to increase the effective detection range. The term “detection range” may include an approximate distance from vehicle 110 at which LIDAR system 100 can clearly detect an object. In one embodiment, the maximum detection range of LIDAR system 100 is about 300 meters, about 400 meters, or about 500 meters. For example, for a detection range of 200 meters, LIDAR system 100 may detect an object located 200 meters (or less) from vehicle 110 at more than 95%, more than 99%, more than 99.5% of the times. Even when the object's reflectivity may be less than 50% (e.g., less than 20%, less than 10%, or less than 5%). In addition, LIDAR system 100 may have less than 1% false alarm rate. In one embodiment, light from projected from two light sources that are collocated in the temporal and spatial space can be utilized to improve SNR and therefore increase the range and/or quality of service for an object located in the overlap region. Processor 118C may extract high-level information from the reflected light in field of view 120A and 120B. The term “extracting information” may include any process by which information associated with objects, individuals, locations, events, etc., is identified in the captured image data by any means known to those of ordinary skill in the art. In addition, processors 118A and 118B may share the high-level information, such as objects (road delimiters, background, pedestrians, vehicles, etc.), and motion vectors, to enable each processor to become alert to the peripheral regions about to become regions of interest. For example, a moving object in field of view 120A may be determined to soon be entering field of view 120B.

### Example Implementation: Surveillance System

FIG. 6D illustrates the implementation of LIDAR system 100 in a surveillance system. As mentioned above, LIDAR system 100 may be fixed to a stationary object 650 that may include a motor or other mechanisms for rotating the housing of the LIDAR system 100 to obtain a wider field of view. Alternatively, the surveillance system may include a plurality of LIDAR units. In the example depicted in FIG. 6D, the surveillance system may use a single rotatable LIDAR system 100 to obtain 3D data representing field of view 120 and to process the 3D data to detect people 652, vehicles 654, changes in the environment, or any other form of security-significant data.

Consistent with some embodiment of the present disclosure, the 3D data may be analyzed to monitor retail business processes. In one embodiment, the 3D data may be used in retail business processes involving physical security (e.g., detection of: an intrusion within a retail facility, an act of vandalism within or around a retail facility, unauthorized access to a secure area, and suspicious behavior around cars in a parking lot). In another embodiment, the 3D data may be used in public safety (e.g., detection of: people slipping and falling on store property, a dangerous liquid spill or obstruction on a store floor, an assault or abduction in a store parking lot, an obstruction of a fire exit, and crowding in a store area or outside of the store). In another embodiment, the 3D data may be used for business intelligence data gathering (e.g., tracking of people through store areas to determine, for example, how many people go through, where they dwell, how long they dwell, how their shopping habits compare to their purchasing habits).

Consistent with other embodiments of the present disclosure, the 3D data may be analyzed and used for traffic enforcement. Specifically, the 3D data may be used to identify vehicles traveling over the legal speed limit or some other road legal requirement. In one example, LIDAR system 100 may be used to detect vehicles that cross a stop line or designated stopping place while a red traffic light is showing. In another example, LIDAR system 100 may be used to identify vehicles traveling in lanes reserved for public transportation. In yet another example. LIDAR system 100 may be used to identify vehicles turning in intersections where specific turns are prohibited on red.

It should be noted that while examples of various disclosed embodiments have been described above and below with respect to a control unit that controls scanning of a deflector, the various features of the disclosed embodiments are not limited to such systems. Rather, the techniques for allocating light to various portions of a LIDAR FOV may be applicable to type of light-based sensing system (LIDAR or otherwise) in which there may be a desire or need to direct different amounts of light to different portions of field of view. In some cases, such light allocation techniques may positively impact detection capabilities, as described herein, but other advantages may also result.

It should also be noted that various sections of the disclosure and the claims may refer to various components or portions of components (e.g., light sources, sensors, sensor pixels, field of view portions, field of view pixels, etc.) using such terms as “first,” “second,” “third,” etc. These terms are used only to facilitate the description of the various disclosed embodiments and are not intended to be limiting or to indicate any necessary correlation with similarly named elements or components in other embodiments. For example, characteristics described as associated with a “first sensor” in one described embodiment in one section of the disclosure may or may not be associated with a “first sensor” of a different embodiment described in a different section of the disclosure.

It is noted that LIDAR system 100, or any of its components, may be used together with any of the particular embodiments and methods disclosed below. Nevertheless, the particular embodiments and methods disclosed below are not necessarily limited to LIDAR system 100, and may possibly be implemented in or by other systems (such as but not limited to other LIDAR systems, other electrooptical systems, other optical systems, etc.—whichever is applicable). Also, while system 100 is described relative to an exemplary vehicle-based LIDAR platform, system 100, any of its components, and any of the processes described herein may be applicable to LIDAR systems disposed on other platform types. Likewise, the embodiments and processes disclosed below may be implemented on or by LIDAR systems (or other systems such as other elecrooptical systems, etc.) which are installed on systems disposed on platforms other than vehicles, or even regardless of any specific platform.

### Example Implementation: Using the LIDAR's Sensor as a Camera to Update a Point Cloud

For LIDAR systems and other systems related to driver assistance and autonomous vehicles, object detection ambiguity is a concern. An ability to accurately sense and interpret surroundings including identification of obstacles, hazards, objects, and other physical parameters that might impact the navigation of vehicles is important for safe operation of vehicle platforms. Challenges in object detection and identification in LIDAR systems may result from effects such as crosstalk, blooming, and others. For example, blooming may result from the reflection of high-intensity signals (e.g., from highly reflective and/or nearby objects). Such reflection signals can distort the apparent outline or boundary edge of a detected object (based on sensor output), which can lead to a determination that a detected object is larger than its actual size or of a shape different than its actual shape. Thus, there is a need in LIDAR systems for solutions that offer enhanced detection capabilities, especially in the presence of conditions leading to crosstalk, blooming, or other conditions that may adversely affect a LIDAR system's capability of accurately detecting and/or identifying/characterizing objects.

Various types of LIDAR systems may be used in conjunction with the presently disclosed embodiments. Details relating to at least some such LIDAR systems are provided in other sections of this disclosure. In one embodiment, a LIDAR system, such as LIDAR system 100 (FIG. 1A), includes projecting unit 102 to project laser light toward field of view 120 and at least one sensing unit 106 that receives laser light return signals reflected from objects in field of view 120. In response to output signals provided by sensing unit 106 in response to receiving the laser light return signals, processing unit 108 of LIDAR system 100 can generate a point cloud, where each point in the point cloud represents a data point associated with a particular spatial location of the LIDAR system field of view and a range (distance) value associated with that spatial location. However, in some cases, point clouds generated based on sensor output signals may include certain inaccuracies or distortions relative to detected objects. For example, a highly reflective object could saturate one or more detector pixels, and charge from saturated pixels that is transferred to surrounding pixels can make objects in the point cloud appear larger than they are.

To address such issues, among others, processing unit 108 may be configured to acquire at least one image representative of an environment of the LIDAR system. For example, the acquired image may constitute an image generated based on the acquisition of radiation other than laser light projected by the LIDAR system (e.g., an ambient light image). The acquired image may be generated by various sensors included in the LIDAR system. In some embodiments, a LIDAR time-of-flight (ToF) sensor within sensing unit 106 (i.e., the same sensor(s) used to detect laser reflections from objects in an environment of the LIDAR system) may be used not only to generate a LIDAR point cloud, but may also be used to generate images based on ambient light (or other radiation sources other than the LIDAR laser). Based on analysis of the acquired image, the processing unit may determine whether inaccuracies exist relative to one or more generated point clouds. Further, the processing unit may be configured to adjust or modify certain aspects of a generated point cloud, regions of a generated point cloud, etc. based on analysis of the acquired images.

Processing unit 108 may acquire images representative of an environment of the LIDAR system using one or more sensors associated with the LIDAR system. For example, in some embodiments, processing unit 108 may generate an image of at least a portion 122 of field of view 120 using non-laser light incident upon sensing unit 106. The non-laser light may include ambient light (e.g., from light sources in the environment and outside of LIDAR system 100, such as sunlight, headlights of a vehicle, street lighting, etc.) reflected from objects in the environment of LIDAR system 100. In some cases, the non-laser light may be emitted by a light source (e.g., an infrared light source, a flash light source, an infrared flash light source, etc.) included as a component of LIDAR system 100.

While sensing unit 106 may be configured primarily to detect reflected laser light signals of a certain wavelength, the sensing unit 106 may also include at least some sensitivity to other wavelengths of light. As a result, the sensing unit 106 may be used to generate images based on light acquired from an environment of the LIDAR system. Processing unit 108 (as noted above) can analyze at least one of those images relative to one or more generated point clouds to determine, for example, inconsistencies between object representations in the one or more point clouds and corresponding object representations in the at least one acquired image. Through this comparison, LIDAR system 100 may detect artifacts, distortions, or other types of inconsistencies in the point cloud information. Further, in response to a determination that a point cloud representation of a detected object may include at least one inconsistency, the generated point cloud can be corrected (based on information associated with the generated image(s)) to resolve inconsistencies or even ambiguities relating to representations of detected objects in the point cloud. In other cases, ghost objects or other object representations included in the point cloud that do not correspond to object actually present in the LIDAR system environment can be detected, and appropriate corrections to the point cloud(s) may be generated. Such corrections may increase the accuracy of the point clouds generated by the LIDAR system and, in turn, may improve the performance of systems that rely upon the generated point clouds for operation (e.g., autonomous driving systems, navigation systems, collision avoidance systems, advanced driver assist systems, etc.).

FIG. 7 depicts an example method 700 for resolving object detection ambiguity or defects/artifacts consistent with this disclosure. Method 700 may be executed by at least one processor, such as a processor of LIDAR system 100 (e.g., at least one processor 118 of processing unit 108 in the example of FIG. 1A, two processors 118 of processing unit 108 of FIG. 2A, or the like). It is noted that method 700 may be implemented by any type of LIDAR system, and not necessarily by LIDAR system 100.

At step 702, the at least one processor causes a laser light source to project laser light toward a field of view of the LIDAR system. For example, as depicted in FIG. 2E, processor 118 of processing unit 108 may be configured to cause projecting unit 102 to project light toward a field of view. Processing unit 108 may be configured to determine a projecting plan for projecting unit 102 that defines a light emission profile at different portions of the field of view. The light source may be a laser such as a solid-state laser, laser diode, a high-power laser, or an alternative light source such as, a light emitting diode (LED)-based light source. In some embodiments, the at least one laser light source may include a single laser source. For example, as depicted in FIG. 2A, the light source (e.g., projecting unit 102) may include a single light source 112. In other cases, the light source may generate a plurality of laser beams for projection toward a field of view of the LIDAR system. Multiple laser sources (e.g., a laser array) may be included in the LIDAR system for generating a plurality of laser beams.

FIG. 2E diagrammatically represents one such example in which the LIDAR system includes an array of laser sources. Specifically, as depicted in FIG. 2E, the light source (e.g., projecting unit 102) may include an array of light sources 112A-112F. In some embodiments, the array of light sources may include a linear array of light sources controlled by processor 118 to sequentially project collimated laser beams. In some embodiments, some or all of the at least one light source 112 may project light concurrently. For example, the processor 118 may cause the array of light sources to simultaneously project light beams from a plurality of light sources 112.

In some embodiments, the LIDAR system may further include at least one deflector configured to project the laser light toward the field of view of the LIDAR system. For example, as depicted in FIG. 2B, deflector 114 is configured to direct laser light 204 projected by light source 112 of projecting unit 102 toward field of view 120 for scanning. In some aspects, a scanning scheme may include at least one of a designation of portions within field of view 120 to be actively scanned as part of a scanning cycle and/or a deflecting plan for scanning unit 104 that defines for example, a deflection direction, frequency, and designating idle elements within a reflector array. A sensor, such as sensor 116, is configured to receive light reflected from objects in field of view 120 to generate outputs relating to the received light reflections. In some embodiments, as depicted in FIG. 2A, the at least one deflector may comprise a first light deflector 114A for outbound light and a second light deflector 114B for inbound light. The deflectors may be part of a bi-static configuration of the LIDAR system wherein projected light exiting the LIDAR system and the reflected light entering the LIDAR system pass through substantially different optical paths.

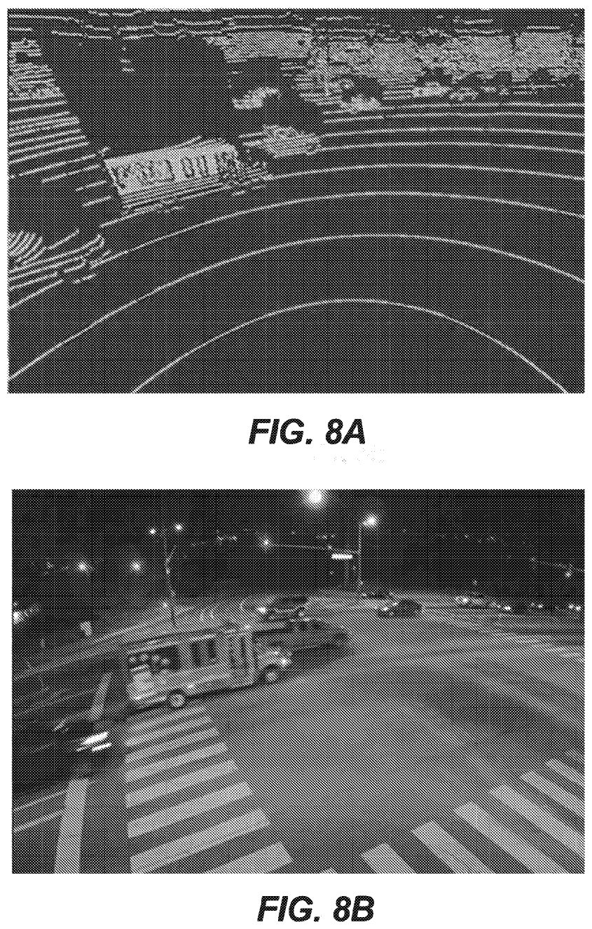

In some embodiments, the at least one deflector may also be configured to receive the laser light return signals reflected from the objects in the field of view. For example, as depicted in FIG. 2B, deflector 114 may be configured to direct the reflected light from objects in the field of view towards sensor 116. The deflector may be part of a monostatic configuration of the LIDAR system wherein projected light exiting from the LIDAR system and the reflected light entering the LIDAR system pass through substantially similar optical paths. At step 704, the at least one processor may receive or generate a point cloud including distance information relative to objects in the field of view of the LIDAR system based on output signals generated by at least one light-sensitive detector in response to received laser light return signals reflected from the objects in the field of view. The point-cloud may be associated with a plurality of data points, and each data point may include a spatial location relative to the LIDAR field of view along with a distance or range value to a surface at that spatial location from which at least one reflection signal was received. By way of example, FIG. 8A illustrates an exemplary representation of a point cloud for a scene determined from the output of LIDAR system 100. The point cloud is generated based on output signals generated by at least one light-sensitive detector, which may comprise sensing unit 106 including sensor 116 comprised of a plurality of detectors 410 (also referred to as “sensor pixels”) as, for example, depicted in FIG. 4B. Measurements from each detector 410 enable determination of the time of flight from a light pulse emission event to the reception event and determination of the intensity of the received photons. In addition, a spatial location of each point on the point cloud is determined based on the instantaneous position of scanning unit 104 at a time between the light pulse emission and reception. Each measured signal is added to the point cloud according to its determined location and provides information about objects in the field of view, such as the distance to various portions of detected objects as well as a direction relative to the LIDAR field of view. The LIDAR system may generate a point cloud model of the environment surrounding vehicle 110 by generating a plurality of point cloud entries from the detected reflections of multiple scanning cycles of the field of view.

At step 706, the at least one processor may receive or cause acquisition or generation of an image representative of at least a portion of the field of view of the LIDAR system based on output signals generated by the at least one light-sensitive detector in response to non-laser light incident upon the at least one-light sensitive detector. For example, using non-laser light (e.g., sunlight) incident upon the at least one light-sensitive detector, the processor may be configured to receive or generate an ambient light image (e.g., a noise image) or a sequence of consecutive ambient light images (i.e., a video) of at least a portion of the field of view of the LIDAR system. FIG. 8B illustrates an exemplary image of a scene determined from the output of LIDAR system 100, wherein the scene is the same as that of FIG. 8A. It should be noted that in some cases, at least one dedicated imaging sensor (e.g., near-infrared (nIR) sensor, single-wavelength sensor, etc.) may be included and aligned with sensing unit 106 of the LIDAR system to provide images such as that shown in FIG. 8B. In this case, sensing unit 106 may include a wavelength sensitive beam splitter or an appropriate filter on each sensor to filter out unwanted radiation (i.e., noise) and direct the unwanted radiation to the at least one dedicated imaging sensor. Using the output(s) of the sensing unit of the LIDAR system to both generate a point cloud representation of the environment as well as an ambient light image representative of the environment may reduce cost and complexity associated with the LIDAR system as few to no additional parts would be needed.

In still other cases, a host vehicle or an environment of the host vehicle may include cameras from which captured images may be acquired and compared to point clouds generated by the LIDAR system. Such systems, however, can increase complexity and cost. For example, adding components, such as a camera, may increase the cost of the LIDAR system. Moreover, there may be added complexity in synching in time of images acquired from camera devices with the point clouds generated by the LIDAR system.

In the event that the signals acquired to generate both the ambient light images and the point cloud data are acquired from the same sensor, the point cloud data and ambient light images are registered, and do not require transformations or synchronization between multiple sensors.

The ambient light image may be generated or acquired at any suitable time relative to the generation of point clouds by the LIDAR system and/or relative to capture of LIDAR light reflections. In some embodiments, the at least one processor of the LIDAR system may be configured to generate the ambient light image after a predetermined number of laser light scans of the field of view. For example, in some cases, the at least one processor may acquire the ambient light image based on the output of sensor 116 generated after each laser light scan of the LIDAR system field of view. That is, the at least one processor may be configured to cause generation of the ambient light image between laser light frame captures of the field of view (e.g., a full scan of the LIDAR field of view).

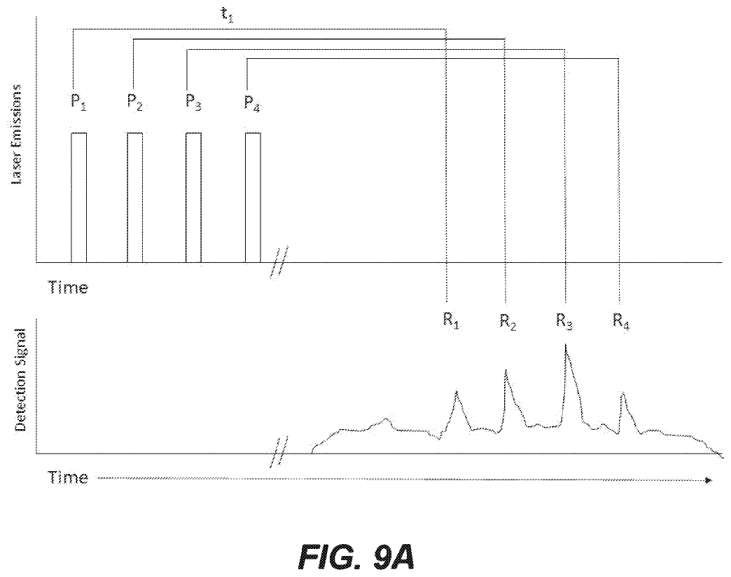

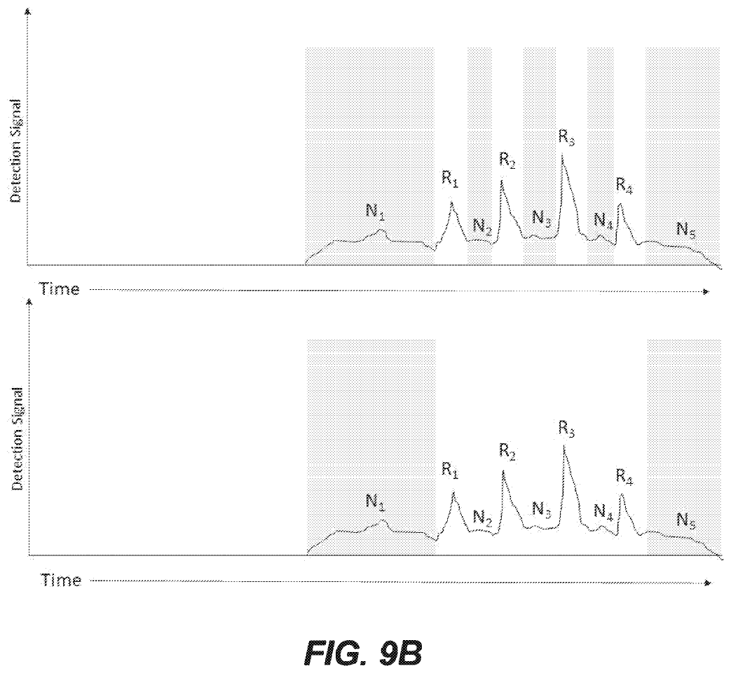

In other cases, however, the ambient light image can be received or generated based on sensed radiation received at any time other than during time intervals when reflected LIDAR laser light is being received by the LIDAR sensor. For example, FIGS. 9A and 9B show graphs illustrating the detection of trace signals including laser light reflections and ambient light readings (i.e., noise), for example, as sensed by a light sensor. The light sensor may include a SiPM detector. As depicted in FIG. 9A, a sequence of light pulses P₁, P₂, P₃, and P₄ may be emitted from at least one laser light source, and laser light reflections R₁, R₂, R₃, and R₄ may be detected by at least one sensor of the LIDAR system at various times (e.g., time t₁) depending on the distances to surfaces from which pulses P₁, P₂, P₃, and P₄ reflect. Although a sequence of four light pulses is illustrated, LIDAR operation may involve a trace exhibiting many thousands of reflected laser light pulses. During any period of time that a LIDAR laser light reflection is not being detected by the at least one sensor, ambient light readings (i.e., noise signals), such as N₁, N₂, N₃, N₄, and N₅, as shown in FIG. 9B, may be acquired and processed (e.g., by sampling the output of the at least one sensor). For example, a processor may process the trace signal to remove reflection signals R₁, R₂, R₃, and R₄ (e.g., based on signal thresholds, pulse width determinations, determination of reflections patterns, etc.). Non-reflection light signals (e.g., N₁, N₂, N₃, N₄, and N₅) may be summed or integrated to generate ambient/noise signal images. For example, each ambient/noise signal acquisition (e.g., N₁, N₂, N₃, etc.) may represent a single ambient light field of view pixel. Sampling and processing of multiple ambient/noise signals can be used to generate an ambient light image. In some cases, ambient light/noise images (or portions of such images) may be generated on a running basis as LIDAR point clouds representative of field of view captures (e.g., full scans of the LIDAR field of view) are generated. As a result, generated ambient light/noise images may correspond in time to generated, corresponding point clouds, which may eliminate the need for a separate time correlation task, which may be required when using a dedicated ambient light sensor, separate from the LIDAR laser light detector, to generate the ambient light/noise images.

In some cases, noise capture time periods N1, N2, N3, etc. may be established based on emission times of pulses P1, P2, P3, etc. and based on expected times of flight associated with those pulses and their associated reflections. For example, during any periods of time or time windows when laser pulse reflections are not expected at the detector, the detector collects ambient light signals representative of the environment of the LIDAR system. In another example, a single continuous time period before or after a laser pulse reflection is expected to be received, such as N1, may be the noise capture time period. Since the ambient light readings are captured during the pixel time for a TOF reading, and not in a dedicated time period, there is no time penalty on the detector availability. Over the course of a scan of a FOV, the ambient light pixel value may be saved. The collection of ambient light pixels may be saved to an ambient light image in an array format (e.g., a two-dimensional array), or an image format. For example, the position of the ambient light pixels in the collection may be determined by the scan position when the ambient light pixel was generated.

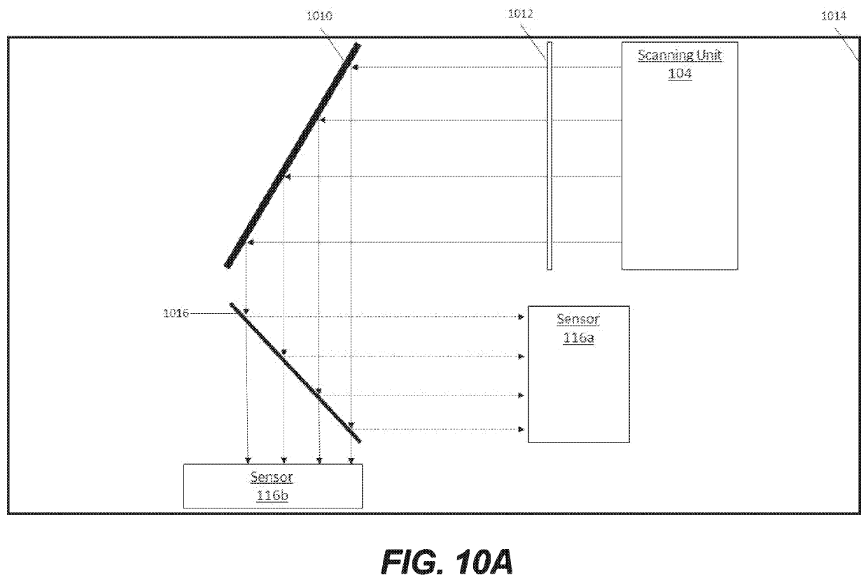

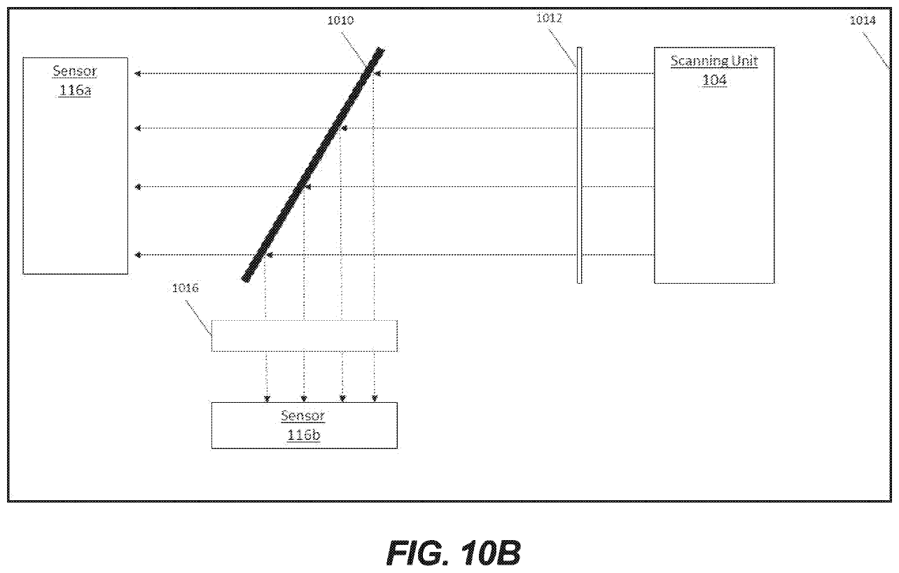

In some embodiments, the LIDAR system may include at least two light-sensitive detectors sharing at least one optical path segment. FIGS. 10A and 10B are exemplary diagrams illustrating optical paths of received light signals. As depicted in FIG. 10A and 10B, the LIDAR system may include sensor 116a, sensor 116b, filter 1010, filter 1012, window 1014, and filter 1016. Sensor 116a may include a silicon photomultiplier (SiPM) infrared sensor configured to detect light of a certain wavelength (e.g., 905 nm (infrared)), and sensor 116b may be complementary metal-oxide semiconductor (CMOS) sensor or a single wavelength sensor configured to detect light of a wavelength different from the SiPM wavelength (e.g., 690 nm (red)), or vice versa. In some embodiments, when sensor 116a is configured to be a time-of-flight (ToF) sensor, filter 1010 may be configured to filter out all wavelengths from the received reflected laser light signals with the exception of signals within a target wavelength range (e.g., 905 +/−20 nm). Additionally or alternatively, when sensor 116b is configured to be an ambient light sensor, rays deflected by filter 1010 toward sensor 116b, such as red light (e.g., 690 +/−20 nm) may be further filtered by filter 1016 to only pass light of a wavelength that sensor 116b is configured to detect. Additionally or alternatively, window 1014, which may be a LIDAR window, and filter 1012 may be configured to filter light entering the system and through scanning unit 104 to selectively remove light of certain wavelengths and thus minimize stray light in the LIDAR system. By implementing detectors positioned on a same optical path within the LIDAR system, the sensors may detect light of different wavelengths separately but simultaneously. These distinct sensors do not require complex synchronizations or transformations thereby decreasing the complexity of having to make spatial and time alignments that may be necessary to synchronize with a sensor external to the LIDAR system.

Using sensors 116a and 116b each sensitive to a different wavelength or wavelength range can offer several potential advantages. For example, as noted above, sensor 116a may be configured as a time of flight sensor sensitive to the laser wavelength emitted by the LIDAR light source (e.g., 905 nm). Thus, output from sensor 116a may be used to generate LIDAR point clouds including distance information relative to objects at various locations within the LIDAR field of view. Sensor 116b may be sensitive to another wavelength (e.g., a red wavelength of 690 nm, another wavelength in the visible light spectrum, etc.). The output of sensor 116b may be used to identify various types of objects in the LIDAR field of view. For example, output from sensor 116b may indicate whether an emitter or reflector of red visible light is present within or overlapping with a certain field of view location/pixel. This information may be used to identify certain objects of interest (e.g., traffic lights, traffic signs, vehicle brake lights, etc.) that are associated with the emission or reflection of red light.

This information may be layered with the point cloud information generated by the LIDAR system. For example, for each pixel of the LIDAR field of view (e.g., based on the output of sensor 116a), the LIDAR system may generate a point cloud point indicative of a distance to an object or portion of an object located at the FOV pixel location. Similarly, for each pixel of the LIDAR field of view (e.g., based on the output of sensor 116b), the LIDAR system may generate an indicator of whether the LIDAR FOV pixel is associated with emission or reflection of red light. The ambient light image may also be generated using measurements from sensor 116b.

The processor 118 may also be configured to control various aspects of the image acquired based on output signals generated by sensor 116. For example, in some embodiments, the at least one processor may be configured to cause the image to be generated using an exposure time that is determined per field of view pixel or that varies per field of view pixel. The exposure time should be less than the total pixel time defined by the correlation between scanner speed and the instantaneous field of view. In some embodiments, the processor may be configured to cause individual control over light integration times associated with each field of view pixel. This may enable the system, for example, to devote imaging and processing resources to certain regions of interest in the field of view. Such areas of interest may include the regions in which certain detected objects are located, especially those detected objects for which inconsistencies, distortions, etc. are detected relative to their point cloud representations, or objects that were detected with low certainty. In this manner, the exposure time of a first pixel among a plurality of field of view pixels may be greater than the exposure time of a second field of view pixel among the plurality of FOV pixels. For example, the exposure time of the first pixel may be 1.25 times, 1.5 times, 2 times, 5 times, or more than 10 times greater than the exposure time associated with a second pixel different from the first pixel. In such cases, the processor may be configured to normalize the output signals generated for each pixel based on the exposure time. The exposure time may be adaptive, depending on the pixel ambient light level. For example, in low ambient light conditions, a longer exposure time may be advantageous. The exposure time may be varied from pixel to pixel, depending on the measured ambient light level of a region of the FOV.

Other aspects associated with acquisition of the ambient light image may also be controlled. For example, in some embodiments, the at least one processor may be further configured to selectively generate the ambient light image (representative of at least a portion of the field of view of the LIDAR system) based on one or more sensed environmental conditions. Environmental conditions, such as rain, fog, bright light, snow etc. can hinder the ability of a LIDAR system to accurately detect objects in the field of view. For example, these conditions can cause scattering of the projected laser light and/or the reflected laser light beams, which can interfere with the LIDAR system's ability to detect objects or certain object features. Such conditions may also contribute to distortion of point cloud representations of detected objects. Thus, in situations where such environmental conditions are detected, the processor 118 may acquire one or more ambient light images for use in reconciling point cloud representations of at least certain detected objects. When such environmental conditions are not detected, the processor may forego generation of ambient light/noise images.

Other environmental conditions may also be used as control inputs for capturing ambient light images. For example, the at least one processor may be configured to switch to a certain mode, such as night mode, depending on the ambient light conditions. This may include widening the wavelength band of a tunable filter to let in more light into the sensing unit, or triggering a threshold light level below which ambient light images are not captured. In some embodiments, night mode may involve adjusting the exposure time for collecting the ambient light signal per pixel. In particular, in low ambient light scenarios, the exposure time may be increased, whereas in high ambient light scenarios, the exposure time may be decreased. In some embodiments, the at least one processor may be configured to forgo generation of an ambient light image when a sensed ambient light level is lower than a predetermined threshold. A typical lux illuminance of ambient daylight is 10.000 to 25,000. However, a typical lux illuminance of light at night with moonlight is 1 and with no moonlight is less than 0.01. Therefore, the at least one processor may forego generation of an ambient light image when a sensed ambient light level is less than a predetermined threshold. Of course, sensor 116 may be sensitive to light outside the visible range. For example, sensor 116 may be sensitive to IR ambient light and may produce output signals in response to incident IR ambient light sufficient to generate an IR ambient light image. Like the response to visible light, however, if IR ambient light levels fall below a predetermined threshold, processor 118 may forego generation of an ambient light image.

The generated ambient light image(s) may be compared to one or more generated point clouds, and based on the comparison, detected inconsistencies between ambient light images and point clouds may be rectified. As described in the example process of FIG. 7, at step 708, the at least one processor may compare the point cloud to the image to determine whether inconsistencies exist between representations in the point cloud and corresponding representations in the image of objects from the field of view.

In some embodiments utilizing two separate sensors for generating a point cloud and an ambient light image, corresponding representations of detected objects in a point cloud and an acquired image, while being associated with a common object in the environment of the LIDAR system, may not correspond in time. That is, a point cloud representing a certain detected object (or the data used to generate the point cloud) may be generated before or after acquisition of an image including a representation of the same detected object. In view of time stamp differences between a generated point cloud and acquired image and potential relative motion between the detected object and the LIDAR system, a detected object may occupy a larger or smaller portion of the generated point cloud, as compared to the acquired image.

In order to implement two separate sensors, synchronization is required to compare the generated point cloud and ambient light images. Because the time stamps associated with point cloud generation and image acquisition are known, and because the ego motion of the LIDAR system (e.g., the ego motion of a vehicle on which the LIDAR system is deployed) can also be determined, processor 118 may take into account the LIDAR system ego motion when comparing a generated point cloud and an acquired image. For example, processor 118 or any other processor associated with the LIDAR system or a host vehicle may determine the ego motion of the host vehicle/LIDAR system based on outputs from one or more sensors, such as a GPS system, speedometer, inertial sensor, etc. Based on such sensor outputs, the ego motion of the host vehicle/LIDAR system may be determined between a time when a frame of point cloud data was collected and a time when an ambient light image was created. The effects of the determined ego motion can be subtracted from the point cloud or ambient light image (whichever is later) in order to transform the ambient light image and the point cloud to a common timestamp. Such a transformation may facilitate comparison of representations of a detected object in a point cloud and an ambient light image.

Various types of comparisons may be performed relative to a representation of a detected object in a point cloud and a representation of the detected object in an ambient light image. As an initial comparison, in some embodiments, the comparison of the point cloud and the image may include correlating at least one object representation in the point cloud with a corresponding at least one object representation in the image. For example, in the method utilizing two separate sensors, point clouds and images that have been transformed to a common time stamp may include representations of a detected object in the same or similar spatial location relative to world coordinates. Or, in some cases, such as where a LIDAR sensor is used both to generate the point cloud and the ambient light image, representations of a detected object in the point cloud and the ambient light image may be in the same or similar spatial position relative to the LIDAR FOV, and thus do not require a transformation as required when using two separate sensors. In either case, knowing where a representation of a detected object should appear in corresponding point clouds and ambient images can facilitate comparisons of the detected object representations in each.

Correlation of detected object representations in point clouds and ambient light images may be further implemented using one or more image recognition techniques. For example, in some cases, processor 118 may be configured to access object related classification information stored in one or more memories and, based on the stored information as well as point cloud information, identify and classify a particular object in the field of view of LIDAR system 100 (e.g., vehicle, pedestrian, building, traffic light, traffic sign, etc.). Similar steps may be implemented to identify and classify objects represented by a plurality of pixels in one or more ambient light images. Similar identifications and/or classifications resulting from analysis of point clouds and corresponding ambient light images, especially where those identifications/classifications are developed relative to areas of the point clouds/images that are expected to represent a common detected object can further increase a confidence level in an accurate object identification/classification.

Once the processor 118 has correlated representations of a detected object in both a point cloud and at least one ambient light image, those correlated representations can be analyzed for detecting potential inconsistencies. For example, the comparison of the point cloud and the image may include a comparison of a size of a detected object representation in the point cloud with a size of a corresponding representation of the detected object in the ambient light image. In an example, where the point cloud and the ambient light image have been transformed to a common time stamp, and where separate sensors are used in generating the point cloud and the ambient light image, the detected object representation in the point cloud and the ambient light image would be expected to have the same or similar size. Disparities in sizes of the detected object representations may indicate the presence of blooming effects etc. which can lead to artificially enlarged object representations in generated point clouds. Additionally or alternatively, the comparison of the point cloud and the image may further include a comparison of a shape of a detected object representation in the point cloud with a shape of a corresponding representation of the detected object in the image. For example, the processor may be configured to perform edge detection techniques to find edges of objects and compare the edges and shapes to object related information stored in one or more memories. The processor may also be configured to perform feature-based methods to find matches between object features and image features. If disparities in size and/or shape are detected between detected object representations in point clouds and ambient light images, information relating to the detected disparities can be used in making corrections to one or more generated point clouds, as discussed below.

Point cloud data may be influenced by the angle of incidence of the illuminated light beam with an object on which the light beam impinges. The ambient light image is a summation of all light reflected from an object towards the sensor. A contour of an edge of a 3D object in the point cloud data may be obtained (e.g., from obtaining a projection of a 3D object detected in a point cloud to a plane and using edge detection algorithms, such as contrast based edge detection algorithms). A contour in the image may be obtained (e.g., using edge detection algorithms). The contour of an object representation obtained from the point cloud and from the image may be compared. In certain light conditions, or for certain angles of illumination, or for certain objects (e.g., objects with high reflectivity, such as retroreflectors, the noise image may have better quality than a point cloud for shape determination, or vice versa. If disparities in size and/or shape are detected between detected contours of object representations in point clouds and ambient light images, information relating to the detected disparities can be used in making corrections to one or more generated point clouds, as discussed below.

Still other comparisons may be employed. In some embodiments, the comparison of the point cloud and the ambient light image may include a comparison of a reflectivity of the detected object representation in the point cloud with a reflectivity of a corresponding representation of the detected object in the image. For example, LIDAR system 100 may determine reflectivity of portions of a field of view, including a region of a generated point cloud occupied by the detected object. The intensity, or other properties of reflected laser pulses in that region can be determined and normalized based on determined distances in order to determine reflectivity values associated with the detected object (or portions of the detected object). Similarly, LIDAR system 100 may determine reflectivity values of the detected object based on an ambient light image including a representation of the detected object. For example, the ambient light image may be analyzed to determine a brightness associated with the detected object in the image. The brightness may be normalized based on the exposure time over which the ambient light image was captured, or the ambient light levels. Combined with range information, for example, the brightness can be used to estimate surface reflectivity of the object, or specific portions of the object. The surface reflectivity information derived from the ambient light image can then be used to assist in detecting the presence of artifacts (e.g., reflectivity based artifacts) associated with a generated point cloud.

Various techniques may be used to compare detected object representations in an ambient light image and a generated point cloud. For example, in some cases, pixel by pixel analysis relative to the ambient image or relative to field of view pixels associated with the point cloud to identify detected object candidates, classify the detected object candidates based on size, shape, etc., and segment the image/point cloud based on detected objects of interest, etc. Various other image processing/computer vision techniques may also be used depending on the requirements of a particular application. In some embodiments, the comparison of the point cloud and the image may be performed by a trained neural network. For example, the trained neural network may include a convolutional neural network designed to perform tasks related to image analysis. FIG. 11 illustrates a block diagram 1100 depicting one example embodiment comprising a trained neural network 1110 included in processing unit 108. Such a trained neural network, however, may be implemented using one or more processors external to processing unit 108 (e.g., a dedicated AI processor). Once sensing unit 106 receives return signals, the laser light return signals and non-laser light return signals are used by processing unit 108 to generate a point cloud and an ambient light image, respectively. The generated images are input into trained neural network 1110 which may be trained, for example, based on a dataset of images to identify a plurality of categories of objects. The network may be trained to correlate detected objects represented in a generated point cloud with corresponding detected objects represented in an ambient light image. Further, the network may also be trained to identify discrepancies in size, shape, reflectivity, etc. among the correlated detected object representations in a point cloud and an ambient image. Thus, the training data may include generated point clouds and one or more acquired ambient images supplied as inputs to the trained neural network. The images may further include annotations to facilitate training, including data in the images or the point clouds related to inconsistencies with the associated point clouds. Based on these inputs, the network can generate an output including one or more of: an identification of a detected object in the point cloud and/or the ambient light image, a classification of the detected object in the point cloud and/or the ambient light image, an identification or classification of individual pixels or points in a point cloud, information correlating detected object representations or individual points in the point cloud with corresponding detected object representations in the ambient light image, and information indicating whether inconsistencies exist between the detected object representations in the point cloud and ambient light image. The inconsistencies may be identified relative to at least one parameter (size, shape, reflectivity, etc.) associated with the detected object representations.

For example, in some embodiments, training data may include sets of point clouds and images. The disclosed system may use analyze one or more of the images to identify a shape of a representation of an object the image. The disclosed system may further use a result of this analysis (e.g., a comparison of the identified shape) to a distorted shape of the object included in the point cloud. Accordingly, using such a technique, the disclosed system may identify one or more inconsistencies between point clouds and images. For example, a point cloud may not include data for a particular object (e.g., a black car), however, an image may include an identifiable representation of the particular object.

Returning to FIG. 7, at step 710, the at least one processor of the LIDAR system, may adjust one or more aspects of a generated point cloud to provide an updated point cloud. In the example of FIG. 7, the adjustment is based on the detection of one or more inconsistencies between representations in the point cloud and corresponding representations in the ambient light image of detected objects from the field of view. In some embodiments, the adjustment of one or more aspects of the point cloud may include a reconstruction of the point cloud information to account for detected inconsistencies between the representations in the point cloud and corresponding representations in the image of objects from the field of view. Various adjustments to a point cloud (or portion of a point cloud) may be made based on detected inconsistencies relative to an ambient light image. For example, adjustment to one or more aspects of the generated point cloud may include removal or addition of points from the generated point cloud. Additionally or alternatively, adjustment to one or more aspects of the generated point cloud may include a reduction in size of at least one object representation in the generated point cloud. Additionally or alternatively, the adjustment to one or more aspects of the generated point cloud may include a change in shape of at least one object representation in the generated point cloud. Such adjustments may be made, for example, in response to analysis of a detected object representation in an ambient light image indicating that a detected object representation in a generated point cloud is distorted, too large, too small, etc. In such cases, the detected object representation in the point cloud may be adjusted so that it agrees with a corresponding detected object representation in at least one ambient light image.

In another example, the adjustment to one or more aspects of the generated point cloud includes updating a confidence level of points from the generated point cloud. The processor may be configured to determine at least one confidence level during a scanning cycle in which point cloud information is collected. The processor may be configured to output a point cloud which includes confidence level values for the points of the generated point cloud. The confidence level assigned to each of one or more points of the point cloud may be indicative of a likelihood that the point cloud model corresponds to a real-world object located at the respective location identified by the point cloud data point, and is not an erroneous detection. The determined confidence level may be used for detection of objects in the scene, for classification of objects in the scene, for scene understanding, for estimating a state of LIDAR system 100, for estimating an environmental condition for the LIDAR system, and so on. The confidence level may be provided in various formats, e.g., high/low; high/medium/low, percent, integer, fraction, and so on. For example, the initial confidence level of a point of the generated point cloud could be assigned as “low” due to various conditions, such as fog, rain, etc. affecting the performance of the LIDAR system. However, based on a comparison of the collected point cloud data (and a detected object representation therein, for example) with a detected object representation in an ambient light image, the confidence level for points in the generated point cloud may be updated. Specifically, if based on analysis of the ambient light image, the processor determines that a point cloud data point, initially classified as having a low confidence level, is associated with a detected object represented in the ambient light image, the confidence level for that data point may be increased.

The comparison between generated point clouds and ambient light images can also be used in the classification of detected objects. For example, in some embodiments, the adjustment to one or more aspects of the generated point cloud may include changing a classification of at least one object representation in the generated point cloud. Classifying an object may include identifying an object as a type of object, such as a car, plant, tree, road, pedestrian, traffic sign, road surface hazard, building, road, etc. The type of object classification may be determined based on the shape of the object, a determined spatial relationship, and/or a determined reflectivity, as represented by the generated point cloud data. However, analysis of one or more corresponding ambient light images may indicate that an initial object classification determined based on point cloud data requires updating. FIG. 12 shows tables illustrating an object classification process. As shown in table 1210 of FIG. 12, objects 1202a, 1202b, 1202c, 1202d and 1202e may be identified in a field of view of the LIDAR system and assigned an initial classification based on generated point cloud data. For example, object 1202a may be initially classified as a tree, objects 1202b, 1202c and 1202e classified as cars, and 1202d classified as a traffic sign. The initial classifications stored in table 1210 may be stored in a database in one or more memories. After comparing the point cloud data to an acquired ambient light image (step 708), the comparison may reveal that object 1202a is actually a person. In response, the processor may change the classification of the object 1202a from a tree to a person, as depicted in table 1220. The adjusted classifications stored in table 1220 may also be stored in a database in one or more memories.

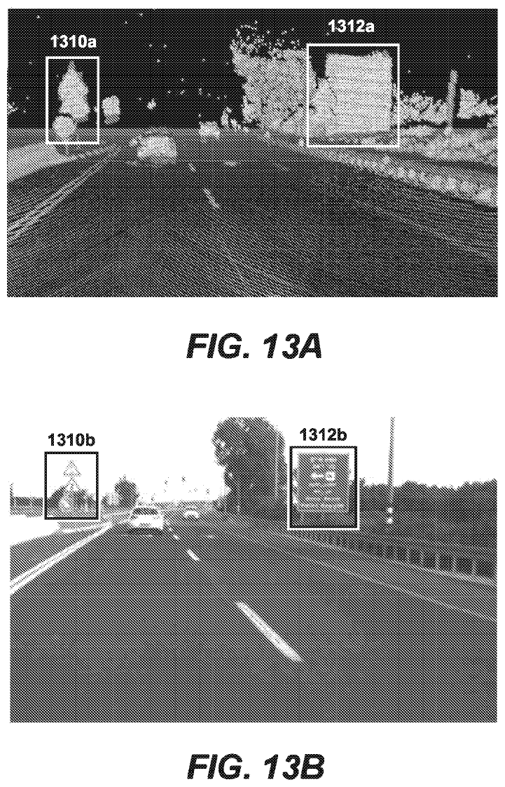

In some embodiments, the inconsistencies between detected object representations in a point cloud and corresponding detected object representations in an ambient light image may be caused when the LIDAR system registers light associated with a first pixel among the plurality of pixels of a light-sensitive detector at a second pixel (or a plurality of pixels) of the light-sensitive detector. For example, the electric charge from the first pixel is generated in response at least one laser light return signal reflected from one or more objects in the field of view and incident upon the first pixel. In one example, receipt of the at least one laser light return signal causes the first pixel to saturate. By way of example, FIG. 13A conceptually represents a point cloud generated based on a pixel saturation condition at the sensor. When highly reflective objects reflect high-intensity signals towards the LIDAR system, such reflections can produce an effect such as blooming, wherein the highly reflective object appears distorted or stretched, and appears to expand into its surroundings, as depicted by areas 1310a and 1312a in FIG. 13A. Blooming occurs when the charge in a detector pixel exceeds a saturation level and excess charge may transfer to one or more adjacent detector pixels. In some embodiments, the second pixel (and potentially other pixels) neighbor the first pixel in the at least one light-sensitive detector. That is, those pixels neighboring a saturated first pixel may be those most likely to experience charge transfer associated with blooming. In such cases, the size of object representations may be adjusted according to a corresponding ambient light image (e.g., noise image). For example, the LIDAR system may adjust the size of one or more object representations in the point cloud according to the size of the one or more object representations the ambient light image. In the case of FIG. 13A and FIG. 13B, object representations 1310b and 1312b correspond to 1310a and 1312a. The LIDAR system may determine that the size of object representations 1310b and 1312b in the ambient light image of FIG. 13B are smaller than the corresponding object representations in the point cloud of FIG. 13A. and thus reduce the size of object representations 1310a and 1312a.

### Missing Objects (e.g., Black Vehicles)

In some embodiments, an object representation may be at least partially missing or obscured from a point cloud, but visible in an ambient image. For example, certain materials of objects may absorb the light emitted by the LIDAR system. Black or dark colored objects, such as black vehicles, may absorb light at wavelengths such as 905 nm, 940 nm, etc. When such objects are in a FOV of the LIDAR system, there may be “holes” or missing objects in the point cloud where the black or dark object is located. This may be especially difficult to detect if the background of the dark object is the sky (i.e., no background objects are partially detected but partially obscured by the object, indicating its presence). In contrast, the black or dark colored object may be easily discernable in an ambient light image due to the difference in ambient light levels of highly absorbing objects and other objects, or surroundings, creating high contrast in the ambient light image. Representations of highly absorbing objects in the ambient light image will have low ambient light levels. The LIDAR system may determine the presence of an object, and other object parameters such as shape based on a presence of the object in the image and an absence of the corresponding object in the point cloud. For example, at step 708 of method 700, when the at least one processor compares the point cloud to the image to determine inconsistencies, missing objects (e.g., black vehicles, etc.) may be recognized in the ambient light image that are not recognized in the point cloud. At step 710, the at least one process may adjust one or more aspects of a generated point cloud based on detection of the missing object to provide an updated point cloud.

### Ghosts

Embodiments described herein include the recognition that when using repetitive light emissions or pulses to illuminate a FOV portion 122, reflections of different light emissions may be indiscernible from one another. Therefore, a reflection of a first emission from an object beyond the detection range of the LIDAR system 100 might return to the sensing unit 106 in a TOF associated with a second emission subsequent to the first emission (e.g., within a predefined time window in which reflections of the second emission are expected to return to the sensing unit), and hence appear like a valid target at a closer distance than actual distance. Representations of such long-distance targets are also referred to hereinbelow as ghosts, and may be caused, by way of example, by highly reflective targets such as a street signs, mirrors and retroreflectors positioned beyond the maximum detection range of the LIDAR system. The maximum detection range of the LIDAR system may be defined by the maximal time window which the LIDAR system can wait for returning pulses and may depend on various factors, such as frame rate, computational power, illumination modulation (if any), and so on. Furthermore, and in an example, in a scanning LIDAR system, a sensor can only linger on each pixel for a very short time before moving on to inspect another pixel. Therefore, the time that is waited for each emitted pulse to return as a reflection (if at all) is limited. For example, reflections of an emitted pulse from targets in the field of view which are distanced up to about 300 m distance from the LIDAR system may be detected within a 2 μs time window starting with the emission (considering the speed of light going to and from the object). Depending on the light emission intensity, light reflected from most target beyond the preset maximal detection range may diminish by the time the reflections reach the LIDAR system. However, very reflective targets, e.g., street sign, license plate etc., reflect light pulses even in much greater distances. Reflections from farther targets which are detected in the detection time-slots which correspond to another pixel (or another pulse of the same train of pulses), and may result in false positive object detection (a “ghost”).

When such an object is not identified as a ghost, but handled like a real target, such ghost might result in false detection by the LIDAR system, which may in turn cause an error by a client and/or a carrying platform of the LIDAR system. For example, a misidentified ghost might cause the vehicle 110 carrying the LIDAR system 100 to make a wrong decision on the road.

In the event that a ghost is suspected (i.e., an object may be detected and an incorrect distance assigned to the detection, resulting in the object representation being positioned in the point cloud incorrectly), there may be mechanisms to determine, from the point cloud, that the object is a suspected ghost. The suspicion may be confirmed by correlating the object representation position in the point cloud with the object representation position in the ambient light image. If conflicting information about position is derived from the comparison, the object (or portion of an object, or single point) position may be marked with low confidence. In response, the processor may change the position of certain points in a point cloud (suspected as ghost points) to coincide with the correct physical position of the object in a FOV. The position may be determined using the ambient light image. The position may further be determined by using a more distance position determined by the maximum detection range, and the time difference resulting in the redundancy of TOF measurements that causes the false “ghost” detection. Furthermore, following detection of an object (i.e., a group of points in a point cloud is detected as an object), the object representation position may be changed to coincide with the physical position of the object in the FOV.

In addition, a LIDAR system or processor may determine a suspected “ghost” detection by comparing the point cloud data and the ambient light image, and finding inconsistencies in the position information therebetween. The LIDAR system may determine a corrected position of an object, and other object parameters such as shape, size, or reflectivity based on an inconsistency of a position of an object in the point cloud, and a position of the object in the image.

Correct identification of “ghost” objects or detections may increase the range of the LIDAR system by enabling recognition of long-range objects located beyond the maximum range (defined by the TOF to the maximum range) by confirming the position of the object using its identified position in the ambient light image.

Of course, while adjustment to a point cloud is possible in response to analysis of one or more corresponding ambient light images, such an adjustment need not always be made upon detection of inconsistencies between detected object representations in a point cloud and detected object representations in an ambient light image. For example, in some cases, the ambient light image may not have sufficient quality (e.g., due to low light, glare, bright ambient sources, etc.) to warrant such an adjustment. Thus, in some embodiments, the at least one processor is further configured to forgo the adjustment of one or more aspects of the generated point cloud comparison based on a sensed quality of the image. For example, the point cloud may only be adjusted when the image quality exceeds a predetermined threshold. In one example, represented in FIGS. 14A and 14B, a first ambient light image represented by FIG. 14A has a lower noise level than a second ambient light image represented by FIG. 14B. While FIG. 14A may have sufficient image quality to determine an inconsistency and adjust a point cloud representation of an object, such as sign 1410, the image of FIG. 14B may have insufficient quality to detect such objects, and therefore may not provide the information necessary to determine an inconsistency and make adjustments to a point cloud. In order to account for noise, in some embodiments, a noise removal filter may be applied to an ambient light image prior to comparing the image to a point cloud.

It should be noted that while the described embodiments above relate to adjusting a point cloud representing objects in a FOV of a LIDAR system, in a similar manner objects identified within a point cloud or any data derived from the point cloud may be adjusted. Objects may be detected within a point cloud using any available technique. Detecting an object in a point cloud involves identifying a group of points in a point cloud that belong to the same discrete object in the FOV. Objects may be identified and classified. For example, an object may be classified as a car, truck, human, or traffic sign. As such, an object map of all relevant objects in the point cloud may be generated. Inconsistencies between objects in a point cloud and data from an ambient light image, at least one parameter of an object may be adjusted to compensate for the inconsistency. For example, the position, size, shape, reflectivity, or presence of the object may be adjusted to compensate for these inconsistencies.

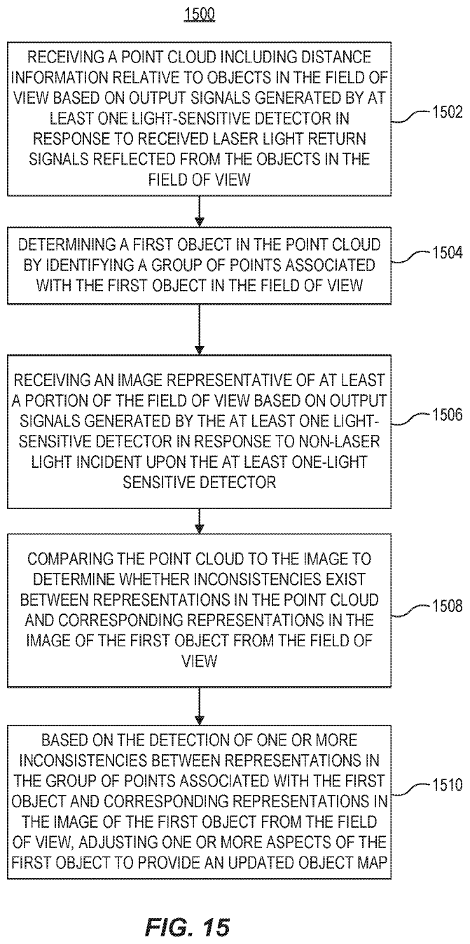

FIG. 15 depicts another example method 1500 for resolving object detection ambiguity or defects/artifacts consistent with this disclosure. Similar to method 700, method 1400 may be executed by at least one processor, such as a processor of LIDAR system 100 (e.g., at least one processor 118 of processing unit 108 in the example of FIG. 1A, two processors 118 of processing unit 108 of FIG. 2A, or the like). It is noted that method 1400 may be implemented by any type of LIDAR system, and not necessarily by LIDAR system 100. In a similar manner as steps 702 and 704, above, at step 1502, the at least one processor may receive or generate a point cloud including distance information relative to objects in the field of view of the LIDAR system based on output signals generated by at least one light-sensitive detector in response to received laser light return signals reflected from the objects in the field of view. The point-cloud may be associated with a plurality of data points, and each data point may include a spatial location relative to the LIDAR field of view along with a distance or range value to a surface at that spatial location from which at least one reflection signal was received.

At step 1504, the at least one processor may determine a first object in the point cloud by identifying a group of points associated with the first object in the field of view. For example, as described above, a feature extraction module may process the point cloud information to identify and classify a plurality of features representative of the first object in the environment (e.g., a car, tree, person, or road). The feature may be stored in any kind of data structure (e.g., raster, vector, 2D array, 1D array).

At step 1506, as described with respect to step 706, the at least one processor may receive or generate an image representative of at least a portion of the field of view based on output signals generated by the at least one light-sensitive detector in response to non-laser light incident upon the at least one light sensitive detector. The at least one light sensitive detector may comprise a single light-sensitive detector, for example that is sensitive to infrared laser light and ambient infrared light). The single light-sensitive detector may comprise a multi-channel detector or a SiPM detector. Alternatively, the at least one light sensitive detector may comprise a dedicated sensor for ambient light measurement that is sensitive to infrared wavelengths or visible light, (e.g., sensor 116b). Using non-laser light (e.g., sunlight) incident upon the at least one light-sensitive detector, the processor may further be configured to receive or generate an ambient light image (e.g., a noise image) or a sequence of consecutive ambient light images (i.e., a video) of at least a portion of the field of view of the LIDAR system.

At step 1508, like step 708, the at least one processor may compare the point cloud to the image to determine whether inconsistencies exist between representations in the point cloud and corresponding representations in the image of the first object from the field of view. As described above, various types of comparisons may be performed relative to a representation of a detected object in a point cloud and a representation of the detected object in an ambient light image. As an initial comparison, in some embodiments, the comparison of the point cloud and the image may include correlating at least one object representation in the point cloud with a corresponding at least one object representation in the image. For example, in the method utilizing two separate sensors, point clouds and images may include representations of a detected object in the same or similar spatial location relative to world coordinates. Or, in some cases, such as where a LIDAR sensor is used both to generate the point cloud and the ambient light image, representations of a detected object in the point cloud and the ambient light image may be in the same or similar spatial position relative to the LIDAR FOV, and thus do not require a transformation as required when using two separate sensors. In either case, knowing where a representation of a detected object should appear in corresponding point clouds and ambient images can facilitate comparisons of the detected object representations in each. In certain instances, the at least one processor may identify missing objects (e.g., black vehicles, etc.) in the ambient light image that are not recognized in the point cloud.

At step 1510, the at least one processor may, based on the detection of one or more inconsistencies between representations in the group of points associated with the first object and corresponding representations in the image of the first object from the field of view, adjust one or more aspects of the first object to provide an updated object map. As described above, for example, an object may be classified as a car, truck, human, or traffic sign. As such, an object map of all relevant objects in the point cloud may be generated and then adjusted based on detection of one or more inconsistencies between representations in the group of points associated with objects and corresponding representations in the image of the same objects from the field of view. For example, the position, size, shape, reflectivity, or presence of the object may be adjusted to compensate for these inconsistencies. As another example, if a missing object (e.g., black vehicle, etc.) is detected in the ambient light image but not recognized in the point cloud, the at least one processor may provide an updated object map that includes a representation of the missing object.

The foregoing description has been presented for purposes of illustration. It is not exhaustive and is not limited to the precise forms or embodiments disclosed. Modifications and adaptations will be apparent to those skilled in the art from consideration of the specification and practice of the disclosed embodiments. Additionally, although aspects of the disclosed embodiments are described as being stored in memory, one skilled in the art will appreciate that these aspects can also be stored on other types of computer-readable media, such as secondary storage devices, for example, hard disks or CD ROM, or other forms of RAM or ROM, USB media, DVD, Blu-ray, or other optical drive media.

Computer programs based on the written description and disclosed methods are within the skill of an experienced developer. The various programs or program modules can be created using any of the techniques known to one skilled in the art or can be designed in connection with existing software. For example, program sections or program modules can be designed in or by means of .Net Framework, .Net Compact Framework (and related languages, such as Visual Basic, C, etc.), Java, C++, Objective-C, HTML, HTML/AJAX combinations, XML, or HTML with included Java applets.

Moreover, while illustrative embodiments have been described herein, the scope of any and all embodiments having equivalent elements, modifications, omissions, combinations (e.g., of aspects across various embodiments), adaptations and/or alterations as would be appreciated by those skilled in the art based on the present disclosure. The limitations in the claims are to be interpreted broadly based on the language employed in the claims and not limited to examples described in the present specification or during the prosecution of the application. The examples are to be construed as non-exclusive. Furthermore, the steps of the disclosed methods may be modified in any manner, including by reordering steps and/or inserting or deleting steps. It is intended, therefore, that the specification and examples be considered as illustrative only, with a true scope and spirit being indicated by the following claims and their full scope of equivalents.

1. A LIDAR system, comprising:
at least one laser light source;
at least one LIDAR sensor; and
at least one processor configured to:
cause the at least one laser light source to project laser light toward a field of view of the LIDAR system;
receive first signals from the at least one LIDAR sensor indicative of times of flight of the laser light that is reflected from objects in the field of view and is incident on the at least one LIDAR sensor;
receive second signals from the at least one LIDAR sensor in response to non-laser light that is reflected from objects in the field of view and is incident on the at least one LIDAR sensor;
generate a point cloud including distance information relative to the objects in the field of view of the LIDAR system based on the first signals;
generate an image representative of at least a portion of the field of view of the LIDAR system based on the second signals;
detect an object in the image;
identify an area of the point cloud containing the detected object;
compare the identified area of the point cloud to the image to select points in the point cloud corresponding to the detected object while adjusting the point cloud to correct inconsistencies with the image in the identified area; and
reconstruct a three-dimensional representation of the object using the adjusted point cloud.

2. The LIDAR system of claim 1, wherein adjusting the point cloud includes removal or addition of points from the generated point cloud.

3. The LIDAR system of claim 1, wherein adjusting the point cloud includes updating a confidence level of points from the generated point cloud.

4. The LIDAR system of claim 1, wherein adjusting the point cloud includes changing a classification of at least one object representation in the generated point cloud.

5. The LIDAR system of claim 1, wherein adjusting the point cloud includes a reduction in size of at least one object representation in the generated point cloud.

6. The LIDAR system of claim 1, wherein adjusting the point cloud includes a change in shape of at least one object representation in the generated point cloud.

7. (canceled)

8. The LIDAR system of claim 1, wherein identifying the area of the point cloud containing the detected object includes a comparison of a size of an object representation in the point cloud with a size of the object in the image.

9. The LIDAR system of claim 1, wherein identifying the area of the point cloud containing the detected object includes a comparison of a reflectivity of an object representation in the point cloud with a reflectivity of the object in the image.

10. The LIDAR system of claim 1, wherein identifying the area of the point cloud containing the detected object includes a comparison of a shape of the an object representation in the point cloud with a shape of the object in the image.

11. The LIDAR system of claim 1, wherein comparing the identified area of the point cloud and the image identifies an object in the image that is not recognized in the point cloud.

12. The LIDAR system of claim 1, wherein the at least one processor comprises a trained neural network for performing a comparison of the point cloud and the image.

13. The LIDAR system of claim 12, wherein the neural network is trained based on a dataset of captured images and associated point clouds.

14-18. (canceled)

19. The LIDAR system of claim 1, wherein the at least one laser light source includes an array of laser sources.

20. The LIDAR system of claim 1, wherein the at least one processor is configured to cause generation of the image between laser light frame captures of the field of view.

21. The LIDAR system of claim 1, further including at least one deflector configured to scan the field of view with the projected laser light and wherein the at least one processor is configured to generate the image after a predetermined number of scans of the field of view.

22. The LIDAR system of claim 1, wherein the at least one processor is configured to generate the image using an exposure time that is determined per pixel of the field of view.

23. (canceled)

24. The LIDAR system of claim 1, wherein the at least one processor is further configured to selectively generate the image representative of the at least a portion of the field of view of the LIDAR system based on one or more sensed environmental conditions.

25. The LIDAR system of claim 1, wherein the at least one processor is further configured to forgo generation of the image when a sensed ambient light level is less than a predetermined threshold.

26. The LIDAR system of claim 1, wherein the at least one processor is further configured to forgo the adjustment of one or more aspects of the generated point cloud comparison based on a sensed quality of the image.

27-31. (canceled)

32. A method for detecting objects using a LIDAR system, the method comprising:
receiving a point cloud including distance information relative to objects in a field of view of the LIDAR system based on first signals generated by at least one LIDAR sensor in the LIDAR system in response to received laser light return signals reflected from the objects in the field of view;
receiving an image representative of at least a portion of the field of view of the LIDAR system based on second signals generated by the at least one LIDAR sensor in the LIDAR system in response to non-laser light incident upon the at least one LIDAR sensor;
detecting an object in the image;
identifying an area of the point cloud containing the detected object;
comparing the identified area of the point cloud to the image to select points in the point cloud corresponding to the detected object while adjusting the point cloud to correct inconsistencies with the image in the identified area; and
reconstructing a three-dimensional representation of the object using the adjusted point cloud.

33. A non-transitory computer-readable storage medium including stored instructions that, when executed by at least one processor, cause the at least one processor to perform a method for detecting objects using a LIDAR system, the method comprising:
receiving a point cloud including distance information relative to objects in a field of view of the LIDAR system based on first signals generated by at least one LIDAR sensor in the LIDAR system in response to received laser light return signals reflected from the objects in the field of view;
receiving an image representative of at least a portion of the field of view of the LIDAR system based on second signals generated by the at least one LIDAR sensor in the LIDAR system in response to non-laser light incident upon the at least one LIDAR sensor;
detecting an object in the image;
identifying an area of the point cloud containing the detected object;
comparing the identified area of the point cloud to the image to select points in the point cloud corresponding to the detected object while adjusting the point cloud to correct inconsistencies with the image in the identified area; and
reconstructing a three-dimensional representation of the object using the adjusted point cloud.

34-36. (canceled)

37. The method of claim 32, further comprising classifying the object as one of a car, truck, human, or traffic sign.

38. The method of claim 32, wherein identifying the area of the point cloud containing the detected object includes a comparison of a size of the object in the point cloud with a size of a corresponding representation of the object in the image.

39. The method of claim 32, wherein identifying the area of the point cloud containing the detected object includes a comparison of a reflectivity of the object in the point cloud with a reflectivity of a corresponding representation of the object in the image.

40. The method of claim 32, wherein identifying the area of the point cloud containing the detected object includes a comparison of a shape of the object in the point cloud with a shape of a corresponding representation of the object in the image.

41. The method of claim 32, wherein comparing the identified area of the point cloud to the image is performed by a trained neural network.

42. The method of claim 41, wherein the neural network is trained based on a dataset of annotated images to identify various categories of objects.

43. (canceled)

44. The method of claim 32, wherein adjusting the point cloud includes removal or addition of points in the received point cloud.

45. The method of claim 32, wherein adjusting the point cloud includes updating a confidence level of points in the generated point cloud.

46. The method of claim 32, wherein adjusting the point cloud includes changing a classification of at least one object representation in the received point cloud.

47. The method of claim 32, wherein adjusting the point cloud includes a reduction in size of at least one object representation in the received point cloud.

48. The method of claim 32, wherein adjusting the point cloud includes a change in shape of at least one object representation in the received point cloud.

49. The method of claim 32, wherein adjusting the point cloud includes a change in a position of at least one object representation in the received point cloud.

50. The method of claim 32, wherein comparing the identified area identifies an object in the image that was not recognized in the point cloud.

51. The method of claim 50, wherein adjusting the point cloud includes adjusting the received point cloud to include a representation of the identified object.
